(19) United States
(12) Patent Application Publication
(10) Pub. No.: US 2026/0334529 A1
(43) Pub. Date: Oct. 29, 2026

(54) AEROSOL-FORMING SUBSTRATE, AEROSOL-GENERATING ARTICLE, DEVICE, AND SYSTEM

(71) Applicant: Philip Morris Products S.A., Neuchatel (CH)

(72) Inventors: Matteo BOLOGNA, Lausanne (CH); Marc Antonius Friedrich VAN DEN BOOGAART, Giez (CH)

(73) Assignee: Philip Morris Products S.A., Neuchatel (CH)

(21) Appl. No.: 19/135,097

(22) PCT Filed: Dec. 21, 2023
(86) PCT No.: PCT/EP2023/087288

§ 371 Date: Jun. 3, 2025

(30) Foreign Application Priority Data
Dec. 23, 2022 (EP) 22216422

(51) Int. Cl. A24D 1/20; A24B 15/167; A24D 1/02; A24F 40/20

(52) U.S. Cl. CPC A24D 1/20; A24B 15/167; A24D 1/02; A24F 40/20

(57) ABSTRACT

A substantially planar aerosol-forming substrate is provided, including: an upper layer and a lower layer, the upper layer and the lower layer being arranged as substantially parallel planes spaced apart by a separation layer located between the upper layer and the lower layer, the separation layer including one or more separation members extending between an upper surface of the lower layer and a lower surface of the upper layer, the lower layer including a first aerosol-forming material and the upper layer including a second aerosol-forming material, and the first and the second aerosol-forming material including at least 5 weight percent aerosol-former.

The present disclosure relates to aerosol-forming substrates and aerosol-generating articles comprising the aerosol-forming substrates. The present disclosure also relates to aerosol-generating devices and aerosol-generating systems comprising aerosol-generating articles and aerosol-generating devices.

A typical aerosol-generating system may comprise an aerosol-generating device and an aerosol-generating article. The aerosol-generating device may comprise heating means, for example a heating element, and the aerosol-generating article may comprise an aerosol-forming substrate. In use, the heating element of the aerosol-generating device may heat the aerosol-forming substrate of the aerosol-generating article so as to release an aerosol from the aerosol-forming substrate. A user may inhale that aerosol.

A typical aerosol-generating article may appear similar to a conventional cigarette. For example, such an aerosol-generating article may be a substantially cylindrical article comprising an aerosol-forming substrate and other components such as mouthpiece filter element, all wrapped in a cigarette paper. Dimensions of typical aerosol-generating articles are often similar to the dimensions of conventional cigarettes.

Research has shown that, in such a typical aerosol-generating article, a significant portion of the plug of aerosol-forming substrate may not be sufficiently heated to form an aerosol during use. This is undesirable since this portion of the plug of aerosol-forming substrate contributes to the cost of manufacture and transport of the aerosol-generating article but does not contribute to the aerosol delivered to an end user. This may be the case regardless of the way in which the aerosol-forming substrate is heated, for example regardless of whether a resistive or inductive heater is used and regardless of whether the plug of aerosol-forming substrate is heated from the inside or the outside.

It is an aim of the present invention to provide an aerosol-forming substrate and an aerosol-generating article comprising the substrate, in which a greater portion of the aerosol-forming substrate of the aerosol-generating article is sufficiently heated to form an aerosol during use.

According to the present disclosure, there may be provided an aerosol-forming substrate comprising an aerosol-forming material for producing an aerosol. The aerosol-forming substrate may have a base defined by an x dimension extending in an x direction and a y dimension extending in a y direction, and a height defined by a z dimension extending in a z direction.

According to the present disclosure, there may be provided an aerosol-forming substrate comprising an aerosol-forming material for producing an aerosol, the aerosol-forming substrate being a planar aerosol-forming substrate having a base defined by a length extending in an x direction, a width extending in a y direction, and a height extending in a z direction.

According to the present disclosure, there may be provided an aerosol-forming substrate comprising an aerosol-forming material for producing an aerosol, the aerosol-forming substrate having a base defined by an x dimension and a y dimension, and a height defined by a z dimension, in which an air-flow path is defined through the aerosol-forming substrate in an x/y plane from one side of the aerosol-forming substrate to the other side of the aerosol-forming substrate, in which a resistance to draw (RTD) of the substrate, along the air-flow path, is less than 20 millimetre H₂O.

According to the present disclosure, there may be provided an aerosol-forming substrate comprising an aerosol-forming material for producing an aerosol, the aerosol-forming substrate comprising a substantially planar upper surface defined by a length extending in an x direction and a width extending in a y direction, and a substantially planar lower surface defined by a length extending in an x direction and a width extending in a y direction. The substantially planar upper surface and the substantially planar lower surface may be vertically spaced from each other by a height defined in a z direction.

According to the present disclosure, there may be provided an aerosol-forming substrate comprising a first planar layer, and a corrugated layer arranged on a surface of the first planar layer, at least one of the first planar layer and the corrugated layer comprising or consisting of an aerosol-forming material.

According to the present disclosure, there may be provided an aerosol-forming substrate comprising a first planar layer, a second planar layer, and a corrugated layer arranged between the first planar layer and the second planar layer, at least one of the first planar layer, the second planar layer and the corrugated layer comprising or consisting of an aerosol-forming material.

According to the present disclosure, there may be provided an aerosol-forming substrate comprising a first layer, and a corrugated layer attached to a surface of the first layer by an adhesive, in which an adhesive comprises or consists of an aerosol-forming material.

According to the present disclosure, there may be provided an aerosol-forming substrate comprising a first layer, a second layer, and an intermediate or separation layer disposed between the first layer and the second layer, in which the intermediate layer is attached to the first layer and/or the second layer by an adhesive, in which an adhesive comprises or consists of an aerosol-forming material.

According to the present disclosure, there may be provided an aerosol-forming substrate comprising a first layer, and a corrugated layer attached to a surface of the first layer, a plurality of longitudinally extending channels being defined between the first layer and the second layer by corrugations, in which a porous element is located in at least one of the longitudinally extending channels.

According to the present disclosure, there may be provided an aerosol-forming substrate comprising a first layer, and a corrugated layer attached to a surface of the first layer, a plurality of longitudinally extending channels being defined between the first layer and the corrugated layer by corrugations, in which the longitudinally extending channels are filled with a porous material, for example a porous aerosol forming material.

According to the present disclosure, there may be provided an aerosol-forming substrate comprising a first layer, a second layer, and a corrugated layer disposed between the first layer and the second layer, a plurality of longitudinally extending channels being defined by corrugations between the first layer and the corrugated layer, and between the corrugated layer and the second layer, in which a porous element is located in at least one of the longitudinally extending channels.

According to the present disclosure, there may be provided an aerosol-forming substrate comprising a first layer, and a corrugated layer attached to a surface of the first layer, a plurality of longitudinally extending channels being defined between the first layer and the corrugated layer by corrugations, in which one or more flavour releasing component, for example a component such as a thread or capsule that is impregnated with or contains a flavour component, is located within at least one of the longitudinally extending channels.

According to the present disclosure, there may be provided an aerosol-forming substrate comprising a first layer, a second layer, and a corrugated layer disposed between the first layer and the second layer, a plurality of longitudinally extending channels being defined by corrugations between the first layer and the corrugated layer, and between the corrugated layer and the second layer, in which one or more flavour releasing component, for example a component such as a thread or capsule that is impregnated with or contains a flavour component, is located within at least one of the longitudinally extending channels.

According to the present disclosure, there may be provided an aerosol-forming substrate comprising a first planar layer, and a corrugated layer arranged on a surface of the first planar layer, at least one of the first planar layer and the corrugated layer comprising perforations or holes to allow air to flow through the first planar layer or the corrugated layer.

According to the present disclosure, there may be provided an aerosol-forming substrate comprising a first planar layer, a second planar layer, and a corrugated layer arranged between the first planar layer and the second planar layer, at least one of the first planar layer, the second planar layer and the corrugated layer comprising perforations or holes to allow air to flow through the first planar layer, the second planar layer, or the corrugated layer.

According to the present disclosure, there may be provided an aerosol-forming substrate comprising a first planar layer, a second planar layer, and a third planar layer arranged between the first planar layer and the second planar layer, the aerosol-forming substrate further comprising a first corrugated layer disposed between the first planar layer and the third planar layer, and a second corrugated layer disposed between the third planar layer and the second planar layer.

According to the present disclosure, there may be provided an aerosol-generating article for use with an aerosol-generating device to generate an inhalable aerosol. The aerosol-generating article may comprise an aerosol-forming substrate, for example an aerosol-forming substrate as described in one or more of the above paragraphs. Alternatively, or in addition, the aerosol-generating article may be as described in one of the paragraphs below.

According to the present disclosure, there may be provided an aerosol-generating article for use with an aerosol-generating device to generate an inhalable aerosol, the aerosol-generating article comprising: an article upstream end and an article downstream end, wherein an article air flow path and an article length extend from the article upstream end to the article downstream end; and a corrugated element, wherein a cross direction of at least a first portion of the corrugated element is non-parallel to one or both of the article length and at least a first portion of the article air flow path.

According to the present disclosure, there may be provided an aerosol-generating article for use with an aerosol-generating device to generate an inhalable aerosol, the aerosol-generating article comprising: an article upstream end and an article downstream end, an article length extending from the article upstream end to the article downstream end; and one or more corrugated elements, wherein the one or more corrugated elements together extend at least 50% of the article length.

According to the present disclosure, there may be provided a planar aerosol-generating article for use with an aerosol-generating device to generate an inhalable aerosol, the aerosol-generating article comprising: an article upstream end and an article downstream end, the article length extending from the article upstream end to the article downstream end; and one or more sheets of aerosol-forming material, each of the one or more sheets of aerosol-forming material having a thickness of less than 1 mm, wherein the one or more sheets of aerosol-forming material together extend along at least 50% of the article length.

According to the present disclosure, there may be provided a substantially planar aerosol-forming substrate comprising an upper layer, a lower layer, the upper layer and the lower layer being arranged as substantially parallel planes spaced apart by a separation layer located between the upper layer and the lower layer, the separation layer comprising or consisting of a corrugated element formed from a corrugated sheet having a triangular corrugation profile.

According to the present disclosure, there may be provided a substantially planar aerosol-forming substrate comprising an upper layer, a lower layer, the upper layer and the lower layer being arranged as substantially parallel planes spaced apart by a separation layer located between the upper layer and the lower layer, the separation layer comprising or consisting of one or more separation members extending between an upper surface of the lower layer and a lower surface of the upper layer.

The separation layer may also be described as an intermediate layer, that is a layer disposed between the upper layer and the lower layer. The terms “separation layer” and “intermediate layer” may be used interchangeably herein.

As used herein, the terms “upper layer” and “lower layer” describe relative positions of layers of the substrate when the substrate is arranged with its x/y plane disposed horizontally.

Aerosol-forming substrates according to the present disclosure are preferably substantially flat substrates or substantially planar substrates. Such substrates have a large base area relative to the volume of the substrate. Advantageously, a larger base area may provide greater surface area for heating by a planar heater of an aerosol-generating device.

Advantageously, a smaller height may allow a smaller temperature gradient or difference across the height of the substrate during heating. For example, where the base of the substrate is in contact with, and heated by, a planar heater, there may be a smaller temperature difference between the base and an upper surface opposing the base if the spacing, or height, between the base and the upper surface is smaller. Advantageously, this may allow heating of a greater proportion of the substrate to a temperature at which an aerosol is released whilst minimising the risk of burning the hottest portion of the substrate closest to the heater. Alternatively, or in addition, this may reduce a time required to heat the substrate sufficiently to release an aerosol. In other words, the aerosol-forming substrate may be heated quickly and efficiently.

An aerosol-forming substrate according to any disclosure herein may have an air-flow path defined through the aerosol-forming substrate in an x/y plane from one side of the aerosol-forming substrate to the other side of the aerosol-forming substrate. The aerosol-forming substrate preferably has a resistance to draw (RTD) of less than 20 millimetre H₂O, for example less than 10 millimetre H₂O, in the direction of the airflow path. Preferably, the aerosol-forming substrate has a RTD of less than 20 millimetre H₂O, for example less than 10 millimetre H₂O, in at least one direction in an x/y plane of the aerosol-forming substrate. An aerosol-forming substrate with a low resistance air-flow path may allow for superior air-flow management and allow aerosol to be extracted more efficiently from the aerosol-forming substrate and guided to a user. Efficient extraction may allow a substrate to have lower weight while still producing the same aerosol experience. Lower weight of substrate can mean lower costs of production because less aerosol-forming substrate is required, and lower costs of shipment because the overall of articles containing the substrate is lower.

The aerosol-forming substrate may have a RTD in a direction perpendicular to the z direction, the resistance to draw being less than 20 millimetre H₂O, for example less than 10 millimetre H₂O. An air-flow path may be defined through the aerosol-forming substrate along the x direction from one side of the aerosol-forming substrate to the other side of the aerosol-forming substrate, such that the aerosol-forming substrate has a RTD of less than 20 millimetre H₂O, for example less than 10 millimetre H₂O, in the x direction. An air-flow path may be defined through the aerosol-forming substrate along the y direction from one side of the aerosol-forming substrate to the other side of the aerosol-forming substrate, such that the aerosol-forming substrate has a RTD of less than 20 millimetre H₂O, for example less than 10 millimetre H₂O, in Particularly preferably, the RTD is less than 8 millimetre H₂O, for example less than 6 millimetre H₂O, for example less than 4 millimetre H₂O, for example less than 2 millimetre H₂O. Preferably the RTD on an air-flow path through the substrate is close to zero millimetre H₂O.

The RTD may be between 9.9 millimetre H₂O and 0 millimetre H₂O, for example between 8 millimetre H₂O and 1 millimetre H₂O, or between 6 millimetre H₂O and 2 millimetre H₂O, or between 5 millimetre H₂O and 3 millimetre H₂O.

Unless otherwise specified, the resistance to draw (RTD) is measured in accordance with ISO 6565-2015. The RTD refers to the pressure required to force air through the full length of a component, such as the aerosol-forming substrate. The terms “pressure drop” or “draw resistance” of a component or article may also refer to the “resistance to draw”. Such terms generally refer to the measurements in accordance with ISO 6565-2015 are normally carried out at under test at a volumetric flow rate of about 17.5 millilitres per second at the output or downstream end of the measured component at a temperature of about 22 degrees Celsius, a pressure of about 101 kPa (about 760 Torr) and a relative humidity of about 60%.

An air-flow path through the substrate may be defined in terms of porosity, for example a percentage of the substrate that is free of aerosol-forming material. The porosity in this case is open porosity, allowing an air-flow path through the substrate. Thus, an aerosol-forming substrate may have an air-flow path defined through the aerosol-forming substrate in an x/y plane from one side of the aerosol-forming substrate to the other side of the aerosol-forming substrate, and the aerosol-forming substrate may have a porosity of greater than 60 %, for example greater than 80%, in the direction of the airflow path. The porosity may be greater than 60%, for example greater than 80%, in at least one direction in an x/y plane of the aerosol-forming substrate. The aerosol-forming substrate may have a porosity in a direction perpendicular to the z direction, the porosity of greater than 60%, for example greater than 80 %. For example, an air-flow path may be defined through the aerosol-forming substrate along the x direction from one side of the aerosol-forming substrate to the other side of the aerosol-forming substrate, such that the aerosol-forming substrate has a porosity of greater than 60%, for example greater than 80%, in the x direction. The aerosol-forming substrate may have an air-flow path defined through the aerosol-forming substrate along the y direction from one side of the aerosol-forming substrate to the other side of the aerosol-forming substrate, such that the aerosol-forming substrate has a porosity of greater than 60%, for example greater than 80%, in the y direction. The porosity of the air-flow path may be defined by a ratio of the cross-sectional area of material within the air-flow path and an internal cross-sectional area of the air-flow path.

Preferably, the porosity is between 81% and 99%, for example a porosity of between 85% and 95%, for example between 88% and 92%, for example about 90%, in the direction of the air-flow path.

The substrate may comprise an upper layer defining an upper surface and a lower layer defining a lower surface, in which an air flow path is defined through the aerosol-forming substrate between the upper layer and the lower layer. For example, the substrate may comprise an upper layer defining an upper surface and a lower layer defining a lower surface, in which an air flow path is defined through the aerosol-forming substrate from one side to an opposite side between the upper layer and the lower layer. For example, the substrate may comprise an upper layer defining an upper surface and a lower layer defining a lower surface, in which an air flow path is defined in an x/y plane through the aerosol-forming substrate from one side to an opposite side between the upper layer and the lower layer. Preferably, a plurality of channels are defined through the aerosol-forming substrate between the upper surface and the lower surface. The channels preferably provide a low RTD air-flow path through the substrate, The aerosol-forming substrate may comprise a separation layer located between the upper layer and the lower layer. For example, a separation layer may comprise one or more ribs or struts separating the upper layer from the lower layer, preferably in which the ribs or struts extend in the direction of an air flow path defined through the aerosol-forming substrate. The separation layer may, therefore, define a distance between the upper layer and the lower layer. Preferably, the aerosol-forming substrate comprises a corrugated portion, for example one or more corrugate elements. For example, the separation layer may comprise, or consists of, a corrugated element, for example a corrugated sheet of material. The aerosol-forming substrate may comprise an upper layer, a lower layer, and a separation layer located between the upper layer and the lower layer, in which the separation layer comprises one or more corrugated elements. The one or more corrugated elements preferably define a plurality of air flow channels extending through the aerosol-forming substrate. In some examples a corrugated structure may be combined with a single planar layer.

The use of a corrugated structure in the aerosol-forming substrate may advantageously allow the production of an aerosol-forming substrate that has extremely low RTD while still being sufficiently rigid to for a user to handle. Further, use of a corrugated structure may allow a low density, low RTD, aerosol-forming substrate to be produced using high speed production methods similar to those used for production of corrugated cardboard.

The aerosol-forming substrate may comprise a plurality of corrugated elements. For example, two or more corrugated elements may be arranged in vertical relationship to each, for example between an upper layer and a lower layer. The plurality of corrugated elements may be described as vertically stacked. For example, the aerosol-forming substrate may comprise an upper corrugated element arranged in contact with the upper layer, and a lower corrugated element arranged in contact with the lower layer. There may be more than two corrugated elements. For example, the substrate may comprise at least one additional corrugated element disposed between the upper corrugated element and the lower corrugated element.

The aerosol-forming substrate may comprise a plurality of corrugated elements, in which two or more of the plurality of corrugated elements are arranged in a lateral side by side relationship to each other between the upper layer and the lower layer. Air following an air-flow path through the substrate may flow through either a first side by side spaced corrugated element or a second side by side spaced corrugated element.

The aerosol-forming substrate may comprise a plurality of corrugated elements, in which two or more of the plurality of corrugated elements are arranged in a lateral end to end relationship to each other between the upper layer and the lower layer. Air following an air-flow path through the substrate may flow through both a first end to end spaced corrugated element or a second end to end spaced corrugated element.

The aerosol-forming substrate may be defined as having a proximal end and a distal end. An air-flow path may be defined through the substrate between the proximal end and the distal end. Advantageously, the air flow path may be defined by at least one corrugated element. For example, ridges and troughs of the at least one corrugated element may be aligned substantially parallel to the air flow direction thereby forming an air-flow path in that direction.

An aerosol-forming substrate may comprise a first corrugated element located at or towards the proximal end of the substrate and a second corrugated element located at or towards the distal end of the substrate. For example, the first corrugated element and the second corrugated element may be arranged in a lateral end to end relationship to each other between an upper layer and a lower layer, each corrugated element being aligned substantially parallel to the air flow direction. In this example, the air-flow path would extend through both the first corrugated element and the second corrugated element.

The aerosol-forming substrate comprises an aerosol-forming material. Preferably the aerosol-forming material forms at least part of a corrugated structure or corrugated element.

The aerosol-forming material may be in the form of a sheet used as one or more of the components of a corrugated structure or corrugated element. This may allow great flexibility in selection of different combinations of aerosol-forming materials. This may also allow selection of suitable non-aerosol-forming materials to be used for other purposes, for example to improve the structure of the substrate. In some examples, the entire aerosol-forming substrate is formed from aerosol-forming materials.

Thus, the aerosol-forming substrate may comprise an upper layer, a lower layer, and an intermediate layer disposed between the upper layer and the lower layer, in which the upper layer comprises, or consists of, an aerosol-forming material, for example in which the upper layer comprises, or consists of, an aerosol-forming material and the lower layer and the intermediate layer do not comprise an aerosol-forming material.

Alternatively, the aerosol-forming substrate may comprise an upper layer, a lower layer, and an intermediate layer disposed between the upper layer and the lower layer, in which the lower layer comprises, or consists of, an aerosol-forming material, for example in which the lower layer comprises, or consists of, an aerosol-forming material and the upper layer and the intermediate layer do not comprise an aerosol-forming material.

Alternatively, the aerosol-forming substrate may comprise an upper layer, a lower layer, and an intermediate layer disposed between the upper layer and the lower layer, in which the intermediate layer comprises, or consists of, an aerosol-forming material, for example in which the intermediate layer comprises, or consists of, an aerosol-forming material and the upper layer and the lower layer do not comprise an aerosol-forming material.

Alternatively, the aerosol-forming substrate may comprise an upper layer, a lower layer, and an intermediate layer disposed between the upper layer and the lower layer, in which the lower layer comprises, or consists of, a first aerosol-forming material and the upper layer comprises, or consists of, a second aerosol-forming material, and the intermediate layer does not comprise an aerosol-forming material.

Alternatively, the aerosol-forming substrate may comprise an upper layer, a lower layer, and an intermediate layer disposed between the upper layer and the lower layer, in which the lower layer comprises, or consists of, a first aerosol-forming material and the intermediate layer comprises, or consists of, a second aerosol-forming material, and the lower layer does not comprise an aerosol-forming material.

Alternatively, the aerosol-forming substrate may comprise an upper layer, a lower layer, and an intermediate layer disposed between the upper layer and the lower layer, in which the upper layer comprises, or consists of, a first aerosol-forming material and the intermediate layer comprises, or consists of, a second aerosol-forming material, and the upper layer does not comprise an aerosol-forming material.

Alternatively, the aerosol-forming substrate may comprise an upper layer, a lower layer, and an intermediate layer disposed between the upper layer and the lower layer, in which the upper layer comprises, or consists of, a first aerosol-forming material and the intermediate layer comprises, or consists of, a second aerosol-forming material, and the lower layer comprises, or consists of, a third aerosol-forming material.

The aerosol-forming substrate is preferably formed from sheets of material. For example, each of the upper layer, lower layer, and intermediate layer are preferably formed from sheets of material. The sheets may be sheets of an aerosol-forming material, for example sheets of homogenised tobacco material. The sheets may be sheets of a non-aerosol-forming material, for example sheets of paper. The thickness of any sheet forming part of the aerosol-forming substrate may be between 0.02 mm to 2 mm. For example, any sheet forming part of the aerosol-forming substrate may have a thickness of between 0.05 mm to 1.5 mm, for example between 0.1 mm and 1 mm, for example between 0.2 mm and 0.8 mm, for example between 0.3 mm and 0.6 mm, for example between 0.4 mm and 0.5 mm.

In certain embodiments, sheets of homogenised tobacco material for use in aerosol-forming substrates as described herein may have a thickness of between 10 μm and about 300 μm. In certain embodiments, sheets of homogenised tobacco material for use in aerosol-forming substrates as described herein may have a grammage of between 100 g/m² and about 300 g/m².

Preferably, the upper layer comprises, or is formed from, a planar sheet of material, the lower layer comprises or is formed from a planar sheet of material, and the intermediate layer comprises or is formed from a corrugated sheet of material. In this case, at least some of the air-flow channels formed by the corrugations are at least partially bounded by aerosol-forming material. This allows for an aerosol generated from the aerosol-forming material to be easily entrained in the air-flow path.

The aerosol-forming substrate may comprise a first aerosol-forming material and a second aerosol-forming material. The aerosol-forming substrate may comprise a third aerosol-forming material.

The first aerosol-forming material may be the same material as the second aerosol-forming material. The first aerosol-forming material may be the same material as the third aerosol-forming material, for example the first, second, and third aerosol-forming materials may all be the same aerosol-forming material.

The first aerosol-forming material may be different to the second aerosol-forming material, for example of different composition to the second aerosol-forming material, for example with different aerosol-former content, or different flavour content, or different nicotine content. The first aerosol-forming material may be different to the third aerosol-forming material, for example of different composition to the third aerosol-forming material, for example with different aerosol-former content, or different flavour content, for example in which first, second, and third aerosol-forming materials are all different materials.

The aerosol-forming material may be a homogenised tobacco material. For example, any of the first, second, or third aerosol-forming materials may be a homogenised tobacco material.

The aerosol-forming substrate may comprise an upper layer, a lower layer, and an intermediate layer disposed between the upper layer and the lower layer, in which the intermediate layer is fixed relative to at least one of the upper layer and lower layer by an adhesive, for example an adhesive comprising a gum, for example guar gum. Optionally, the adhesive may be an aerosol forming material. For example, the adhesive may be a homogenised tobacco slurry. The adhesive may be, or may comprise, a flavourant and/or an aerosol-former. It is thus possible to form an aerosol-forming substrate in which all component parts, including the adhesive, are formed from aerosol-forming material.

In examples in which the substrate comprises an intermediate layer, the intermediate Preferably, an air-flow path is defined through the aerosol-forming substrate by channels formed or defined by longitudinally extending corrugations of a corrugated element. Optionally, a porous material may be located within the channels formed by the longitudinally extending corrugations. The porous material may comprise, or consist of, an aerosol-forming material. The porous material may comprise a flavourant or an aerosol-former. For example, the porous material may be soaked in a liquid flavourant or liquid aerosol-former.

A flavourant may be located within the channels formed by the longitudinally extending corrugations to release flavour on heating. For example a flavour thread and/or one or more flavour capsules may be located within the channels. A flavour capsule may be a capsule containing a liquid or gel flavourant, for example a capsule configured to release its contents on heating, or a frangible capsule designed to be broken by a user prior to use.

Preferably an airflow path, or the airflow path, is defined through the aerosol-forming substrate in an x/y plane from one side of the aerosol-forming substrate to the other side of the aerosol-forming substrate. The airflow path may pass through a filter or mesh or porous material such as porous paper, for example tea-bag material, incorporated in the aerosol-forming substrate. The filter or mesh or porous material, may be disposed transverse to the airflow path, for example across a proximal or downstream end of the aerosol-forming substrate. Such a filter or mesh or porous material may advantageously act as a filter to prevent solid particulates from being inhaled by a user while not increasing the RTD to a great extent.

In this context, the term “porous” is used to mean sufficiently porous so as to allow aerosol formed by the aerosol-forming substrate to escape through the porous layer in use.

Advantageously, the porous layer may protect the aerosol-forming substrate from one or both of physical damage and chemical contamination. Advantageously, the porous layer may also help to prevent transfer of aerosol-forming material from the aerosol-forming substrate onto a user handling the aerosol-forming substrate.

The aerosol-forming substrate may comprise a substantially planar layer and a corrugated layer fixed to a surface of the substantially planar layer such that longitudinal channels formed by longitudinally extending corrugations of the corrugated layer extend in a planar direction of the substantially planar layer.

Any planar layer described herein, for example any one or more of the first planar layer, the second planar layer, the upper planar layer and the lower planar layer, may be a single, unitary, planar component, for example a planar sheet.

The aerosol-forming substrate may comprise an upper layer, a lower layer, and an intermediate layer, in which at least one of the upper layer and the lower layer comprises perforations or holes such that at least a portion of air can flow through the upper and/or lower layer. Preferably, the aerosol-forming substrate comprises a proximal or mouth end and a distal end. The perforations or holes may be located in a central portion of the aerosol-forming substrate, for example approximately midway between the proximal or mouth end and the distal end. The intermediate layer may comprise, or consist of, a corrugated element or layer arranged between the upper layer and the lower layer such that longitudinal channels formed by longitudinally extending corrugations of the corrugated element or layer extend in a planar direction of the upper layer and lower layer. The intermediate layer may comprise perforations or holes such that at least a portion of air can flow through the intermediate layer in a direction perpendicular to the longitudinally extending channels. At least one of the upper layer, the lower layer, and the intermediate layer may be, or comprise, a mesh.

The aerosol-forming substrate may comprise an upper layer, a lower layer, and an intermediate layer, and the intermediate layer may comprise, or consist of, a corrugated element or layer arranged between the upper layer and the lower layer such that longitudinal channels formed by longitudinally extending corrugations of the corrugated element or layer extend in a planar direction of the upper layer and lower layer, and in which the intermediate layer comprises perforations or holes such that at least a portion of air can flow through the intermediate layer in a direction perpendicular to the longitudinally extending channels.

The aerosol-forming substrate may comprise a proximal end and a distal end. The proximal end may be termed the mouth end. Longitudinal channels formed by longitudinally extending corrugations of the corrugated element or layer may extend in a direction perpendicular to a direction defined between the proximal or mouth end and the distal end. In this case, it may be particularly advantageous for corrugated portion of the corrugated element to comprise perforations or holes such that at least a portion of air can flow through the corrugated element in a direction perpendicular to its longitudinally extending channels.

The aerosol-generating substrate may comprise one or more sheets of aerosol-forming material, in which a plurality of holes or notches are defined in a surface, for example an upper surface or a lower surface of aerosol-forming material. Where aerosol-forming material is heated, aerosol is generated by gases and vapours which may be released at a surface of the aerosol-forming material. Gases and vapours may also be released between the heated surface of an aerosol-forming material and a heater. Gases released between an aerosol-forming material and a heater may form bubbles which reduce the efficiency of thermal transfer between the heater and the material. A plurality of holes or notches defined in a surface of the aerosol-forming material may advantageously facilitate release of volatilised components of the aerosol-forming material into an air stream passing over a surface of the aerosol-forming material. For example, such holes or notches may provide a low resistance path for gasses and vapours formed by heating the aerosol-forming material to escape from the volume of the material to the surface of the material. By increasing the number of low resistance pathways from the volume of the material to a surface of the material, aerosol deliveries may be improved and substrate utilisation efficiency may be improved.

The aerosol-forming substrate may comprise a lower layer of aerosol-forming material and a corrugated layer attached to the lower layer, for example a corrugated layer of aerosol-forming material, in which a plurality of holes or notches are defined in at least one of the lower layer of aerosol-forming material and the corrugated layer. A plurality of holes or notches may be defined in an upper surface of the aerosol-forming substrate.

In some examples, at least a portion of the plurality of holes are blind holes that do not extend through the thickness of the aerosol-forming material they are defined in. In some examples, at least a portion of the plurality of holes are through-holes that extend through the thickness of the aerosol-forming material they are defined in.

The aerosol-forming substrate may comprise a corrugated element or layer, and corrugations of the corrugated element or layer may be defined by a corrugation wavelength and a corrugation peak-to-trough amplitude. The corrugation wavelength may be between 1 mm and 10 mm, for example between 1.5 mm and 8 mm, for example between 2 mm and 6 mm, for example between 2.5 mm and 5 mm, for example between 3 mm and 4 mm. The corrugation peak-to-trough amplitude may be between 1 mm and 10 mm, for example between 1.5 mm and 8 mm, for example between 2 mm and 6 mm, for example between 2.5 mm and 5 mm, for example between 3 mm and 4 mm. The corrugation peak-to-trough amplitude is the same as the thickness, for example in the z dimension, of the corrugated element or layer. Thus, for a regular wave-like structure, the peak-to-trough amplitude will be double what would commonly be referred to simply as the amplitude (or the wave amplitude, or the peak-to-midpoint amplitude, or the midpoint-to-trough amplitude).

Corrugations may be formed in a number of different corrugation profiles. For example, the corrugations may be further defined by a corrugation profile, in which the corrugation profile is sinusoidal, or triangular, or rectangular, or trapezoidal, or toroidal, or parabolic.

In some examples, the aerosol-forming substrate may be formed as an extrusion of an aerosol-forming material, the extrusion having an upper surface, a lower surface, and a plurality of air flow channels defined through the aerosol-forming substrate between the upper surface and the lower surface.

It may be advantageous for the contact region between the upper and/or lower layer and the intermediate/separation layer to be minimised. The intermediate layer may predominantly provide structure to the substrate, whereas the upper and/or lower layers may predominantly provide aerosol-forming material. Where there is significant contact between the upper/lower layer and the intermediate layer there may be undesirable thermal conduction between the upper/lower layer and the intermediate layer. Thermal conduction may result in portions of the aerosol-forming substrate not reaching an ideal aerosol-generating temperature, or not reaching such a temperature swiftly enough. Cool spots in the aerosol-forming material may result in inefficient delivery of aerosol. Cool spots in the aerosol-forming material may also result in incomplete utilisation of portions of aerosol-forming material. Contact between an upper or lower layer and an intermediate layer may be minimised by selecting appropriate structures for the intermediate layer. For example, where the intermediate layer is corrugated, a triangular profile corrugation may lower the contact area compared with, for example a sinusoidal or trapezoidal profile corrugation.

As a further example, the intermediate layer may comprise ribs arranged to form walls that extend perpendicularly with respect to the upper and lower layers. Such ribs would form lines of contact between the intermediate layer and upper and lower layers, thereby minimising thermal contact. Ribs may be formed from strips of material arranged such that a width of the strip defines the thickness of the intermediate layer. To facilitate assembly, a plurality of strips may be linked to form an array of ribs that may be positioned to form the intermediate layer.

Alternatively, or additionally, strips may be laterally kinked to provide an ability for the strips to stand on their edge and facilitate the assembly process. Advantageously, the strips may be sufficiently kinked to be “self standing” on their edges, which may facilitate assembly.

As a further example, the intermediate layer may form points of contact with the upper and lower layers. For example, the intermediate layer may comprise a plurality of pillars, each pillar providing a point of contact between the intermediate layer and at least one of the upper layer and the lower layer. The pillars may be separate discrete pillars. Advantageously, such pillars are linked together to facilitate assembly. For example, the intermediate layer may comprise a sheet of material having upwardly and downwardly depending projections that act as pillars to separate the upper and lower layers, while minimizing contact between the intermediate layer and the upper and lower layers. Such a structure also allows for a low RTD airflow path to be defined between the upper layer and the lower layers. Advantageously, such a layer may be provided by forming or embossing a sheet of material such as a sheet of paper. Such a layer may be formed by depositing a pulp onto a shaped surface, for example a shaped mesh surface. The pulp may then be dried and removed from the mesh to form the profiled intermediate layer. In some embodiments the pulp may not be removed from the mesh, in which case the mesh may form part of the profiled intermediate layer. For example, the mesh may form a susceptor of a substrate comprising the profiled intermediate layer.

The pillars of an intermediate layer may be formed from a plurality of upwardly and downwardly depending structures such as cones formed in the sheet forming the intermediate layer. The profile may resemble and egg box. Such a structure may advantageously provide an overall rigidity to the substrate that allows very thin layers of substrate to be formed.

Additionally, airflow through the airflow channels defined between 3-dimensional peaks and troughs of the intermediate layer may undergo sequential accelerations and decelerations on passing through a series of restrictions and expansions, as well as undergoing turbulence. As a result, the airflow may advantageously deliver a highly homogenised mixture of air and aerosol to a user.

Preferred examples of intermediate layers may have a profile that may be described as egg-box like. The structure of such a layer is one of a regular arrangement of upwardly depending peaks and downwardly depending troughs. The structure of an egg-box like intermediate layer may be described mathematically as a surface or profile obtained by translating perpendicularly a first periodic curve along a second periodic curve, for example by translating perpendicularly a first continuous periodic curve along a second continuous periodic curve, for example by translating perpendicularly a first sinusoid along a second sinusoid. The shape, amplitude, and period of the first periodic curve may be similar or identical to the shape, amplitude and period of the second periodic curve. For example, one or both of the first periodic curve and the second periodic curve may be a sinusoidal curve, for example in which both the first and second periodic curve are sinusoidal curves having the same period and amplitude.

The periodic curves may have other profiles, for example one or both of the periodic curves may be a square wave curve, or a triangular wave curve, or a trapezoidal wave curve. The shape of the resulting peaks and troughs will depend on the shape of the curves. The shape of the intermediate layer may be described as a sinusoidal surface.

A general equation defining the shape of an egg-box like intermediate layer can be defined. Thus, for a sinusoid function defined by s(x)=Asin(s/b), for a horizontal plan x, y, a vertical axis z, a total vertical height (distance from the top of a peak to the bottom of a valley) of 2A and a periodicity of the peaks and valleys so that there is a peak and a valley every 2πb unit long, the general equation defining the shape may be written as:

z=A(sin (x/b)+sin (y/b))

In the resulting intermediate layer structure, each peak (other than peaks at the edges of the structure) are surrounded by four troughs, and each trough (other than troughs at the edge of the structure) are at the centre of four peaks. The precise shape of the peaks and troughs will depend on the shape of the periodic curves forming the x and y profiles of the surface. For example, the peaks and troughs may have a substantially circular profile in plan view, or a substantially rectangular profile on plan view, for example the peaks and troughs may present a square or diamond shaped profile in plan view.

The configuration of peaks and troughs may influence air flow through the aerosol-forming substrate. For example, the intermediate layer may be arranged and/or oriented to enhance turbulence in an air flow path through the article. Advantageously, an enhanced turbulence may result in more homogeneous mixing of air and vapour within the article, which may result in a more homogeneous aerosol.

The aerosol-forming substrate may have a length (x dimension) that is approximately the same magnitude as its width (y dimension). Alternatively, the length (x dimension) may be greater in magnitude than the width (y dimension). For example, the length may be about 1.5 times the magnitude of the width, or about 2 times the magnitude of the width, or about 2.5 times the magnitude of the width, or about 3 times the magnitude of the width. The length (x dimension) may be greater than 3 the magnitude of the width, for example greater than 4 times the magnitude of the width, for example greater than 5 times the magnitude of the width.

The aerosol-forming substrate may have a base. The base is preferably substantially planar. The base may define a substantially planar lower surface of the aerosol-forming substrate.

The aerosol-forming substrate may be in the form of a 3-dimensional shape that may be described as cuboid, or rectangular prismatic.

The aerosol-forming substrate may have one, or both, of the length (x dimension) and the width (y dimension) having a magnitude equal to or greater than 2 times the magnitude of the height (z dimension), for example 3 times, or 4 times, or 5 times the height, optionally equal to or greater than 6 times the height, for example 10 times the height, or 15 times the height, or 20 times the height.

The aerosol-forming substrate may have a base defined by a rectangular shape having a length and a width forming a lower surface of the aerosol-forming substrate. An upper surface of the aerosol-forming substrate may be defined by a substantially identical rectangular shape spaced from the base by the height, for example in which both the lower surface and the upper surface are defined as planar surfaces located on parallel planes spaced by the height.

The aerosol-forming substrate may have a ratio of the largest in magnitude of its length (x dimension) and its width (y dimension) to its height (z dimension) of between 3:1 and 25:1, for example between 4:1 and 20:1, for example between 4.2:1 and 10:1, for example between 4.5:1 and 8:1, for example in which the ratio of length to width is between 4:1 and 20:1, for example between 4.2:1 and 10:1, for example between 4.5:1 and 8:1. Advantageously, these ratios above may provide a compromise between at least the following four factors:
a base surface area for heating, which may increase with the x and y dimensions;
a temperature difference across the height of the substrate when heated at one or both of the base and the upper surface, which may increase with the z dimension;
a structural rigidity of the substrate or article, which, for substrates having x and y dimensions greater than 4 times the z dimension, may decrease with the x and y dimensions for a given z dimension, and increase with the z dimension for given x and y dimensions; and
a capability of the substrate to generate a sufficient quantity of aerosol to satisfy a user, which may increase with the x, y and z dimensions.

The aerosol-forming substrate may have a length (x dimension) of between 10 mm and 50 mm, for example between 12 mm and 30 mm, for example between 14 mm and 26 mm, for example between 16 mm and 24 mm, for example between 18 mm and 22 mm, for example about 18 mm, or about 19 mm, or about 20 mm, or about 21 mm, or about 22 mm.

The aerosol-forming substrate may have a width (y dimension) of between 5 mm and 20 mm, for example between 8 mm and 18 mm, for example between 10 mm and 16 mm, for example between 11 mm and 15 mm, for example between 12 mm and 14 mm, for example about 13 mm.

The aerosol-forming substrate may have a height (z dimension) of between 1 mm and 10 mm, for example between 1.2 mm and 8 mm, for example between 1.4 mm and 7 mm, for example between 1.6 mm and 6 mm, for example between 1.7 mm and 5 mm, for example about 1.7 mm, or about 4.5 mm, or about 2 mm, or about 3 mm, or about 4 mm.

The aerosol-forming substrate may consist entirely of aerosol-forming material.

The aerosol-forming substrate may further comprise a porous layer covering at least one surface of the aerosol-forming substrate, for example at least an upper surface, or at least a lower surface, or at least upper and lower surfaces. The porous layer may cover at least an end surface of the aerosol-forming substrate, for example at least covering at least one airflow inlet or outlet of the aerosol-forming substrate. The porous layer may completely encapsulate the aerosol-forming substrate. The porous layer may be a porous paper or a porous mesh, for example a layer of tea-bag material. A porous layer may protect a surface of the aerosol-forming substrate, or protect a user handling the aerosol-forming substrate, while allowing passage of gaseous components released from the aerosol-forming substrate.

The aerosol-forming substrate may comprise nicotine. Nicotine may be present in the form of a tobacco material or may be in the form of a nicotine extract.

Preferably, the aerosol-forming substrate comprises, or consists of, homogenised tobacco material, for example a reconstituted tobacco material or a cast leaf tobacco material. The aerosol-forming substrate may comprise, or consist of, a solid aerosol-forming material. The aerosol-forming substrate may comprise a liquid aerosol-forming material, for example a liquid aerosol-forming material retained within a porous matrix. The aerosol-forming substrate may comprise a gel aerosol-forming material.

A first portion of the aerosol-forming substrate may comprise a first aerosol-forming material, and a second portion of the aerosol-forming substrate may comprise a second aerosol-forming material different to the first aerosol-forming material. For example, the first aerosol-forming material may be a first homogenised tobacco material, and the second aerosol-forming material may be a second homogenised tobacco material having a different composition to the first homogenised tobacco material. The first homogenised tobacco material composition may differ from the second tobacco composition by virtue of having at least one difference selected from the list consisting of: different aerosol-former content, different tobacco content, different flavourant content, different water content, and different nicotine content.

The first aerosol-forming material may be a first homogenised tobacco material, and the second aerosol-forming material may be a non-tobacco aerosol forming material comprising an aerosol-former, such as glycerine or propylene glycol, preferably including a flavour component and or an active component such as nicotine or a cannabinol.

Advantageously, substrates comprising two or more different aerosol-forming materials may allow combinations of aerosol-forming materials which may not otherwise be available.

This could allow, for example, combinations of flavours which enhance the user experience.

The aerosol-forming material, for example any one, two, or all of the aerosol-forming material in the aerosol-forming substrate, may comprise one or more organic materials such as tobacco. The aerosol-forming material, for example any one, two, or all of the aerosol-forming material in the aerosol-forming substrate, may comprise one or more of herb leaf, tobacco leaf, fragments of tobacco ribs, reconstituted tobacco, homogenised tobacco, extruded tobacco and expanded tobacco.

The aerosol-forming material, for example any one, two, or all of the aerosol-forming material in the aerosol-forming substrate, may comprise one or more aerosol-formers. Suitable aerosol-formers are well known in the art and include, but are not limited to, one or more aerosol-formers selected from: polyhydric alcohols, such as propylene glycol, polyethylene glycol, triethylene glycol, 1, 3-butanediol and glycerine; esters of polyhydric alcohols, such as glycerol mono-, di-or triacetate; and aliphatic esters of mono-, di- or polycarboxylic acids, such as dimethyl dodecanedioate and dimethyl tetradecanedioate. It may be particularly preferable for the aerosol-former to be or comprise glycerine.

The aerosol-forming material, for example any one, two, or all of the aerosol-forming material in the aerosol-forming substrate, may comprise at least 1, 2, 5, 10, or 15 weight percent aerosol-former. The aerosol-forming material may comprise greater than 15 weight percent aerosol-former, for example greater than 20 weight percent, or greater than 25 weight percent, or greater than 30 weight percent, or greater than 40 weight percent, or greater than 50 weight percent aerosol-former.

The aerosol-forming material may comprise less than or equal to 30 percent by weight of aerosol former, less than or equal to 25 percent by weight of aerosol former, or less than or equal to 20 percent by weight of aerosol former. That is, the aerosol-forming material may have an aerosol former content of less than or equal to 30 percent by weight, less than or equal to 25 percent by weight, or less than or equal to 20 percent by weight.

The aerosol-forming material may comprise between 1 percent and 30 percent by weight of aerosol former, between 1 percent and 25 percent by weight of aerosol former, or between 1 percent and 20 percent by weight of aerosol former.

The aerosol-forming material may comprise between 5 percent and 30 percent by weight of aerosol former, between 5 percent and 25 percent by weight of aerosol former, or between 5 percent and 20 percent by weight of aerosol former.

The aerosol-forming material may comprise between 10 percent and 30 percent by weight of aerosol former, between 10 percent and 25 percent by weight of aerosol former, or between 10 percent and 20 percent by weight of aerosol former.

The aerosol-forming material may comprise between 15 percent and 30 percent by weight of aerosol former, between 15 percent and 25 percent by weight of aerosol former, or between 15 percent and 20 percent by weight of aerosol former.

The aerosol-forming material may comprise at least 50 percent by weight of aerosol former, at least 60 percent by weight of aerosol former, or at least 70 percent by weight of aerosol former.

The aerosol-forming material may comprise less than or equal to 85 percent by weight of aerosol former, less than or equal to 80 percent by weight of aerosol former, or less than or equal to 75 percent by weight of aerosol former.

The aerosol-forming material may comprise between 50 percent and 85 percent by weight of aerosol former, between 50 percent and 80 percent by weight of aerosol former, or between 50 percent and 75 percent by weight of aerosol former.

The aerosol-forming material may comprise between 60 percent and 85 percent by weight of aerosol former, between 60 percent and 80 percent by weight of aerosol former, or between 60 percent and 75 percent by weight of aerosol former.

The aerosol-forming material may comprise between 70 percent and 85 percent by weight of aerosol former, between 70 percent and 80 percent by weight of aerosol former, or between 70 percent and 75 percent by weight of aerosol former.

The aerosol-forming material, for example any one, two, or all of the aerosol-forming material in the aerosol-forming substrate, may comprise nicotine. The aerosol-forming material may comprise natural nicotine, or synthetic nicotine, or a combination of natural nicotine and synthetic nicotine.

The aerosol-forming material may comprise at least 0.5 percent by weight of nicotine, at least 1 percent by weight of nicotine, at least 1.5 percent by weight of nicotine, or at least 2 percent by weight of nicotine. That is, the aerosol-forming material may have a nicotine content of at least 0.5 percent by weight, at least 1 percent by weight, at least 1.5 percent by weight, or at least 2 percent by weight.

The aerosol-forming material, for example any one, two, or all of the aerosol-forming material in the aerosol-forming substrate, may comprise one or more cannabinoid compounds such as one or more of: tetrahydrocannabinol (THC), tetrahydrocannabinolic acid (THCA), cannabidiol (CBD), cannabidiolic acid (CBDA), cannabinol (CBN), cannabigerol (CBG), cannabigerol monomethyl ether (CBGM), cannabivarin (CBV), cannabidivarin (CBDV), tetrahydrocannabivarin (THCV), cannabichromene (CBC), cannabicyclol (CBL), cannabichromevarin (CBCV), cannabigerovarin (CBGV), cannabielsoin (CBE), cannabicitran (CBT). It may be preferable that the cannabinoid compound is CBD or THC. It may be particularly preferable that the cannabinoid compound is CBD.

The aerosol-forming material, for example any one, two, or all of the aerosol-forming material in the aerosol-forming substrate, may comprise one or more flavourants. The one or more flavourants may comprise one or more of: one or more essential oils such as eugenol, peppermint oil and spearmint oil; one or both of menthol and eugenol; one or both of anethole and linalool; and a herbaceous material. Suitable herbaceous material includes herb leaf or other herbaceous material from herbaceous plants including, but not limited to, mints, such as peppermint and spearmint, lemon balm, basil, cinnamon, lemon basil, chive, coriander, lavender, sage, tea, thyme, and caraway. The one or more flavourants may comprise a tobacco material. The aerosol-forming material may have a moisture content of about 5 to 25%, preferably of about 7 to 15%, at final product state. For example, the aerosol-forming substrate may be a homogenised tobacco material with a moisture of about 5 to 25%, preferably of about 7 to 15%, at final product state.

The aerosol-forming material may comprise tobacco leaf; for example about 15 to 45%, preferably of about 20 to 35% of a blend of tobacco leaf, incorporating at least one of the following tobacco types: bright tobacco; dark tobacco; aromatic tobacco. Tobacco material such as tobacco leaf is preferably ground and graded to a particle size of about 100 to 380 mesh, preferably of about 170 to 320 mesh.

“Tobacco type” means one of the different varieties of tobacco, for example based on the distinct curing process that the tobacco undergoes before it is further processed in a tobacco product.

Examples of bright tobaccos are Flue-Cured Brazil, Indian Flue-Cured, Chinese Flue-Cured, US Flue-Cured such as Virginia tobacco, and Flue-Cured from Tanzania.

Examples of aromatic tobaccos are Oriental Turkey, Greek Oriental, semi-oriental tobacco but also Fire Cured, US Burley, such as Perique, and Rustica.

Examples of dark tobacco are Dark Cured Brazil Galpao, Burley Malawi or other African Burley, Sun Cured or Air Cured Indonesian Kasturi.

The aerosol-forming material may comprise Cellulose fibres. For example the aerosol-forming material may comprise about 1 to 15% of cellulose fibres, preferably of about 3 to 7% of cellulose fibres. Preferably, cellulose fibres may have a length of about 10 to 250 μm, preferably of about 10 to 120 μm.

The aerosol-forming material may comprise organic fibres such as non-tobacco fibres, or tobacco fibres. For example the aerosol-forming material may comprise about 5 to 20%, preferably about 7 to 15% of tobacco fibres. Tobacco fibres are preferably derived from stems and/or or stalks, graded to fibres of a length of about 10 to 350 μm, preferably of about 10 to 180 μm. The aerosol-forming material may comprise about 10 to 30%, preferably of about 15 to 25%, of a non-tobacco organic fibre. For example, organic fibres may derive from cellulose, cotton, wood, tea botanical varieties as sub-products, and sub-processed waste, the tea industry. Organic fibres are preferably of a length of about 10 to 400 μm, preferably of about 10 to 200 μm. The aerosol-forming material may comprise a binder. For example, the aerosol-forming material may comprise about 1 to 10%, preferably of about 1 to 5%, of a binder such as any of common gums or pectins used in food and beverage (F&B) industries. Preferred binders may be natural pectins, such as fruit, for example citrus, or tobacco pectins; guar gums, land locust bean gums, such as hydroxyethyl and/or hydroxypropyl of those; starches, such as modified or derivatized starches; alginate; methyl, ethyl, ethylhydroxymethyl and carboxymethyl, celluloses; dextran; and xanthan gum. A preferable binder is guar.

The aerosol-forming material may comprise an organic botanical glycerite. For example, the aerosol-forming material may comprise about 15 to 55%, preferably of about 20 to 35%, of botanicals such as Clove, Echinacea sp., Fennel, Ginger, Hawthorn berry, Elderberry, Monarda, Mullein leaves, Nettle, Plantain, Turmeric, Yarrow, and compounds of those.

The aerosol-forming material may comprise organic botanical extracts. For example, the aerosol-forming material may comprise about 1 to 15%, preferably of about 2 to 7%, of any of the previously referred botanicals, as well as menthol (dl-Menthol, C10H20O, 2-Isopropyl-5-methylcyclohexanol) such as obtained from Chaerophyllum macrospermum, Mesosphaerum sidifolium, or other related botanic varieties, as well as P-menthan-3-ol, as any secondary alcohol as diastereoisomers of 5-methyl-2-(propan-2-yl)cyclohexan-1-ol.

The aerosol-forming material may comprise botanical essential oils, for example about 0.5 to 5%, preferably of about 1 to 3%, of a botanical essential oil, for example a botanical essential oil such as of palm, coconut, and wooden-based essential oils.

The aerosol-forming material preferably comprises an aerosol-former, for example about 5 to 35%, preferably of about 10 to 25%, of an aerosol former. Suitable aerosol-formers known in the art include: glycerine; monohydric alcohols like menthol, polyhydric alcohols, such as triethylene glycol; esters of polyhydric alcohols, such as glycerol mono-, di- or triacetate; and aliphatic esters of mono-, di- or polycarboxylic acids, such as dimethyls of those.

The aerosol-forming material may comprise particles of a functional material, for example particles of carbon, graphite, activated carbon, or expanded graphite. Such materials may, for example, increase the thermal conductivity of the aerosol-forming material and improve efficiency of aerosol generation.

The aerosol-forming substrate may further comprise a thermally conductive layer, for example an aluminium layer, covering at least a portion of at least one surface of the aerosol-forming substrate. For example, at least a portion of an upper surface, or at least a portion of a lower surface may comprise such a thermally conductive layer. A thermally conductive layer may facilitate thermal transfer between a heat source and the aerosol-forming material of the aerosol-forming substrate.

The aerosol-forming substrate may further comprise a paper layer, for example a tipping paper layer, covering at least a portion of at least one surface of the aerosol-forming substrate, for example at least a portion of an upper surface, or at least a portion of a lower surface. A paper layer may protect a user's hand when handling the substrate. A paper layer may be used to allow a user to insert a portion of the aerosol-forming substrate into their mouth.

The aerosol-forming substrate may comprise conductive materials. For example, the aerosol-forming material may comprising conductive particles. Conductive particles may be, for example, conductive carbon or graphite particles, or conductive metallic particles, for example particles of aluminium, or stainless steel, or nickel.

The aerosol-forming substrate may comprise one or more susceptor materials. The one or more susceptor materials may be incorporated within an aerosol-forming material of the aerosol-forming substrate, for example as particles of susceptor material distributed within the aerosol-forming material. The presence of susceptor materials may allow the aerosol-forming substrate to he heated by engagement with a fluctuating electromagnetic field formed by an inductor.

Optionally, one or more susceptor materials may be incorporated within the aerosol-forming substrate as one or more strips, threads, or wires of susceptor material, for example one or more strips, threads, or wires of susceptor material located within an airflow path of the aerosol-forming substrate.

Optionally, one or more susceptor materials may be incorporated within the aerosol-forming substrate as one or more sheets or layers of susceptor material, for example one or more sheets or layers of susceptor material covering an external portion of the aerosol-forming substrate, or forming a structural component of the aerosol-forming substrate.

The aerosol-forming substrate may comprise a first planar layer, and a corrugated layer arranged on a surface of the first planar layer, at least one of the first planar layer and the corrugated layer comprising or consisting of a sheet of susceptor material.

The aerosol-forming substrate may comprise a first planar layer, a second planar layer, and a corrugated layer arranged between the first planar layer and the second planar layer, at least one of the first planar layer, the second planar layer and the corrugated layer comprising or consisting of a sheet of susceptor material.

The one of more sheet of susceptor material may be in the form of a mesh of susceptor material.

The susceptor material, in whatever form, may comprise one or more materials selected from the list consisting of: aluminium, iron and iron alloys, nickel and nickel alloys, cobalt alloys, stainless steel alloys, copper alloys, carbon, expanded carbon, and graphite.

Aerosol-forming substrates as disclosed herein may be manufactured using any suitable method. For example, sheets of material, including aerosol-forming material may be formed using known methods and assembled together to form the aerosol-forming substrate. In some examples, an extrusion process may be used to form an aerosol-forming substrate.

Where the substrate comprises a corrugation layer or a corrugated element, it may be advantageous to manufacture the substrate using a process similar to that used to produced corrugated cardboard.

As disclosed herein, a method of making a planar corrugated aerosol-forming substrate may comprise steps of: providing a first continuous sheet, providing a second continuous sheet, at least one of the first sheet and the second sheet being a sheet comprising or consisting of aerosol-forming material, texturing the second continuous sheet using a fluting roller to form a continuous corrugated sheet, applying adhesive to at least one of the continuous corrugated sheet or the first continuous sheet, applying the continuous corrugated sheet to a surface of the first continuous sheet to form a continuous aerosol-forming substrate, and cutting the continuous aerosol-forming substrate to form the planar corrugated aerosol-forming substrate. A method of making a planar corrugated aerosol-forming substrate may comprise steps of: providing a first continuous sheet, providing a second continuous sheet, and providing a third continuous sheet, at least one of the first sheet, the second continuous sheet, and the second sheet being a sheet comprising or consisting of aerosol-forming material, texturing the second continuous sheet using a fluting roller to form a continuous corrugated sheet, applying adhesive to at least one of the continuous corrugated sheet or the first continuous sheet, applying a first side of the continuous corrugated sheet to a surface of the first continuous sheet, applying adhesive to at least one of the continuous corrugated sheet and the third continuous sheet, and applying a second side of the continuous corrugated sheet to a surface of the third continuous sheet, thereby forming a continuous aerosol-forming substrate, and cutting the continuous aerosol-forming substrate to form the planar corrugated aerosol-forming substrate.

At least one of the first second and third continuous sheets may be a sheet of homogenised tobacco.

The adhesive may comprise guar gum. The adhesive may comprise an aerosol-forming substrate, for example a homogenised tobacco slurry.

According to the present disclosure, an aerosol-generating article for use with an aerosol-generating article may be provided. The aerosol-generating article may be used to generate an inhalable aerosol. The article comprises an aerosol-forming substrate as disclosed herein. The article may consist entirely of an aerosol forming substrate as disclosed herein. Advantageously, this may provide one or more of the following benefits: a reduction in the cost to manufacture the article, a reduction in the weight and therefore cost to transport the article, and a reduction in waste from manufacturing or using the article.

The aerosol-generating article may comprise the aerosol-forming substrate located or assembled within an outer wrapper or outer casing. The outer wrapping or outer casing may be a cigarette wrapper. The outer wrapping or outer casing may be a polymeric sheet.

Optionally, the outer wrapping or outer casing may comprise a susceptor material, for example a portion of aluminium or stainless steel foil.

Optionally, one or more perforations may be defined through the outer wrapping or outer casing. Such perforations may allow air flow into or out of the article.

In some examples, the aerosol-generating article may comprise a plurality of components, and the plurality of components, including the aerosol-forming substrate, may be assembled within the outer wrapping or outer casing.

Optionally, the aerosol-generating article may comprise two or more aerosol-forming substrates as disclosed herein.

The aerosol-generating article may be defined by a length extending in an x direction, a width extending in a y direction, and a height extending in a z direction. A longitudinal airflow path may be defined through the aerosol-generating article between a distal end of the article and a proximal end of the article.

The aerosol-generating article may be defined by a length extending in an x direction between a distal end and a proximal end, a width extending in a y direction between a first edge and a second edge, and a height extending in a z direction between an upper surface and a lower surface. A distal portion of the aerosol-generating article may be defined between the distal end of the aerosol-generating article and a longitudinal mid-point of the aerosol-generating article. A proximal portion of the aerosol-generating article may be defined between the proximal end of the aerosol-generating article and the longitudinal mid-point of the aerosol-generating article.

The aerosol-generating article may comprise a single aerosol-forming substrate that extends between the proximal end and the distal end within the article.

Optionally, the aerosol-forming substrate may be located within the distal portion of the aerosol-generating article. In some examples, the aerosol-forming substrate may be located entirely within the distal portion of the aerosol-generating article. The proximal portion may be a portion of the article configured to be inserted into an aerosol-generating device.

The aerosol-generating article may further comprise a structural element located proximally relative to the aerosol-forming substrate. The structural element may comprise longitudinal channels or porosity allowing an airflow path through the structural element.

The aerosol-forming substrate may be defined by its transverse cross-section, and the structural element may have a similar or identical transverse cross-section to the aerosol-forming substrate, for example a similar rectangular transverse cross-section. The structural element may be a rectangular tube.

Optionally, the structural element may comprise a corrugated element, for example such that longitudinal channels within the aerosol-generating article are defined by the corrugated element. The longitudinal channels may be defined by corrugations of the corrugated element. The aerosol-generating article may comprise a first aerosol-forming substrate as disclosed herein located at least partially within the distal portion of the aerosol-generating article, and a second aerosol-forming substrate as disclosed herein located proximally relative to the first aerosol-forming substrate, for example at least partially within the proximal portion of the aerosol-generating article.

In some examples, the aerosol-generating article comprises a plurality of components, including at least one aerosol-forming substrate as disclosed herein, a substantially hollow structural element, for example a hollow tube, and a mouthpiece element, for example a mouthpiece filter. The plurality of components may be coaxially aligned and assembled within a wrapper or casing.

The aerosol-generating article has a length, a width, and a height. Optionally, the length may be greater in magnitude than the width. Optionally, the width may be greater in magnitude than the height.

The length of the article may be about 1.5 times the magnitude of the width, or about 2 times the magnitude of the width, or about 2.5 times the magnitude of the width, or about 3 times the magnitude width. The length may be greater than 3 the magnitude of the width, for example greater than 4 times the magnitude of the width, for example greater than 5 times the magnitude of the width.

Preferably, the aerosol-generating article comprises a substantially planar base. For example the base may be defined by a substantially planar lower surface of the aerosol-forming substrate. In preferred examples, the aerosol-generating article may be in the form of a 3-dimensional shape that may be described as cuboid, or rectangular prismatic.

The length of the article may have a magnitude equal to or greater than 2 times the magnitude of the height, for example 3 times, or 4 times, or 5 times the height, optionally equal to or greater than 6 times the height, for example 10 times the height, or 15 times the height, or 20 times the height.

The length of the article may be between 10 mm and 50 mm, for example between 12 mm and 30 mm, for example between 14 mm and 26 mm, for example between 16 mm and 24 mm, for example between 18 mm and 22 mm, for example about 18 mm, or about 19 mm, or about 20 mm, or about 21 mm, or about 22 mm.

The width of the article may be between 5 mm and 20 mm, for example between 8 mm and 18 mm, for example between 10 mm and 16 mm, for example between 11 mm and 15 mm, for example between 12 mm and 14 mm, for example about 13 mm.

The height of the article may be between 1 mm and 10 mm, for example between 1.2 mm and 8 mm, for example between 1.4 mm and 7 mm, for example between 1.6 mm and 6 mm, for example between 1.7 mm and 5 mm, for example about 1.7 mm, or about 4.5 mm, or about 2 mm, or about 3 mm, or about 4 mm.

The aerosol-generating article may comprise a first section and a second section removably couplable to the first section. The first section may comprise an aerosol-forming substrate as described herein, and the second section may be, or may comprise, a mouthpiece. The second section may be a reusable mouthpiece designed for use with multiple first sections. As mentioned previously, the aerosol-generating article may be an aerosol-generating article for use with an aerosol-generating device to generate an inhalable aerosol, the aerosol-generating article comprising: an article upstream end and an article downstream end, and an article length extending from the article upstream end to the article downstream end. The aerosol-generating article may comprise or consist of an aerosol-forming substrate, for example any aerosol-forming substrate as described herein.

The article or substrate may comprise a corrugated element. The corrugated element may comprise one or more perforations or holes for air to flow through the corrugated element. An article air flow path extending from the article upstream end to the article downstream end may extend through the one or more perforations or holes. The one or more perforations or holes may place adjacent channels formed by corrugations of the corrugated element in fluid communication. Advantageously, the perforations or holes may allow adjustment of the RTD of the article.

The article or substrate may comprise one or more corrugated elements, the one or more corrugated elements together extending at least 50, 60, 70, 80, 90, 95, 98, or 99%, or substantially all, of the article length. Advantageously, this may provide structural support to the article across a large proportion of the article.

Alternatively, or in addition, the article or substrate may comprise one or more sheets of aerosol-forming material. At least one, for example each, of the one or more sheets of aerosol-forming material may have a thickness of less than 1 mm. The one or more sheets of aerosol-forming material may together extend along at least 50, 60, 70, 80, 90, 95, 98, or 99%, or substantially all, of the article length. Advantageously, this may allow the aerosol-generating article to comprise more aerosol-forming material and therefore last longer in use. In addition, advantageously, the use of a long, thin sheet of aerosol-forming material may result in a smaller temperature gradient across the aerosol-forming material compared with a shorter, thicker plug of aerosol-forming material.

In the context of the above two paragraphs, and in analogous contexts, the term “together extend” and the like should not be interpreted to count overlapping lengths twice. Thus, as an example, for an article having two elements spaced apart in the thickness direction or in the width direction of the article, one element starting at the upstream end and extending along 60% of the article length, and another element starting at the downstream end and extending along 60% of the article length, the elements would together extend along 100% of the article length, not 120% of the article length. In addition, two elements spaced apart in a direction of the length of the article are not considered to together extend along the gap spanning between those two elements in the direction of the length of the article. Thus, as an example, for an article having only two elements spaced apart in the direction of the length of the article, one element starting at the upstream end and extending along 20% of the article length, and the other element starting at the downstream end and extending along 20% of the article length, the elements would together extend along 40% of the article length, not 100% of the article length.

At least one, for example each, of the one or more sheets of aerosol-forming material may have a thickness of less than 1, 0.8, or 0.5 mm.

Optionally, each of the one or more sheets has a thickness less than 1 mm and the one or more sheets together extend along at least 50% of the article length. Optionally, each of the one or more sheets has a thickness less than 1 mm and the one or more sheets together extend along at least 70% of the article length. Optionally, each of the one or more sheets has a thickness less than 1 mm and the one or more sheets together extend along at least 90% of the article length. Optionally, each of the one or more sheets has a thickness less than 1 mm and the one or more sheets together extend along at least 95% of the article length. Optionally, each of the one or more sheets has a thickness less than 1 mm and the one or more sheets together extend along substantially all of the article length.

Optionally, each of the one or more sheets has a thickness less than 0.8 mm and the one or more sheets together extend along at least 50% of the article length. Optionally, each of the one or more sheets has a thickness less than 0.8 mm and the one or more sheets together extend along at least 70% of the article length. Optionally, each of the one or more sheets has a thickness less than 0.8 mm and the one or more sheets together extend along at least 90% of the article length. Optionally, each of the one or more sheets has a thickness less than 0.8 mm and the one or more sheets together extend along at least 95% of the article length. Optionally, each of the one or more sheets has a thickness less than 0.8 mm and the one or more sheets together extend along substantially all of the article length.

Optionally, each of the one or more sheets has a thickness less than 0.5 mm and the one or more sheets together extend along at least 50% of the article length. Optionally, each of the one or more sheets has a thickness less than 0.5 mm and the one or more sheets together extend along at least 70% of the article length. Optionally, each of the one or more sheets has a thickness less than 0.5 mm and the one or more sheets together extend along at least 90% of the article length. Optionally, each of the one or more sheets has a thickness less than 0.5 mm and the one or more sheets together extend along at least 95% of the article length. Optionally, each of the one or more sheets has a thickness less than 0.5 mm and the one or more sheets together extend along substantially all of the article length.

It may be particularly preferable for each of the one or more sheets to have a thickness less than 0.8 mm and the one or more sheets together extend along at least 70% of the article length, and even more preferable for each of the one or more sheets to have a thickness less than 0.5 mm and the one or more sheets together extend along at least 80% of the article length, and most preferable for each of the one or more sheets to have a thickness less than 0.5 mm and the one or more sheets together extend along at least 90% or substantially all of the article length. The aerosol-generating article may have an article air flow path extending from the article upstream end to the article downstream end of the article. The article or substrate may comprise a corrugated element. The corrugated element may be one of the one or more corrugated elements discussed above. A cross direction of at least a first portion of the corrugated element may be non-parallel, preferably substantially perpendicular, to one or both of the article length and at least a first portion of the article air flow path. Advantageously, this may allow increasing, or tailoring, the RTD of the article.

The article air flow path may comprise the air flow path described above in relation to the aerosol-forming substrate. Thus, the article air flow path may extend through the aerosol-forming substrate.

The article may have a substantially planar upper surface defined by a length extending in an x direction and a width extending in a y direction. The article may have a substantially planar lower surface defined by a length extending in an x direction and a width extending in a y direction. The substantially planar upper surface and the substantially planar lower surface may be vertically spaced from each other by a height defined in a z direction. The cross direction of at least the first portion of the corrugated element may extend in, or be parallel with, the y direction or the z direction. An angle between the cross direction of at least the first portion of the corrugated element may be at least 15, 30, 45, 60, or 75 degrees to one or both of the article length and at least the first portion of the article air flow path. The cross direction of at least the first portion of the corrugated element is preferably perpendicular to one or both of the article length and at least the first portion of the article air flow path. The first portion of the article air flow path may be defined, at least in part, by the first portion of the corrugated element.

In technical fields in which corrugation is commonplace, for example in the field of corrugated paper or cardboard, there is standard nomenclature for the three mutually perpendicular directions for a standard corrugated element. A person skilled in the field of this invention would understand this nomenclature but, nonetheless, a brief explanation is set out below.

A standard corrugated element is formed from a sheet, usually a rectangular sheet, which is bent or folded to have parallel corrugations with constant amplitude and wavelength. A standard corrugated element extends in three mutually perpendicular directions. These directions are the machine direction, the cross direction, and the thickness direction.

Without wishing to be bound to any particular manufacturing method, the machine direction generally refers to the direction in which material to be corrugated to form the standard corrugated element would be unwound from a roller, or fed into a roller such as the corrugation rollers 511, 512 of FIG. 5, described in more detail later, to form the standard corrugated element. This means that, in the resulting, standard corrugated element, the machine direction refers to the direction extending from a point on a first corrugation peak, to the nearest point on an adjacent corrugation peak. This direction may also be referred to as the wavelength direction, since it is in the same direction as the wavelength of the corrugations would be measured.

For a standard corrugated element, the cross direction is perpendicular to the machine direction and extends in a direction along a corrugation peak without any change in amplitude. This direction may also be referred to as the longitudinal channel direction herein, since it is the same direction as the longitudinally extending channels formed between adjacent corrugations. For a standard corrugated element, the thickness direction is perpendicular to the machine direction and the cross direction and extends in a direction from a midpoint between two adjacent corrugation troughs, to the nearest (i.e., opposing) corrugation peak. This direction may also be referred to as the amplitude direction, since it is in the same direction in which the amplitude of the corrugations would be measured.

As the skilled person would understand after reading this disclosure, the above directions could also be applied to non-standard corrugated elements. At any point, a non-standard corrugated element may have a local machine direction, a local cross direction, and a local thickness direction.

Any corrugated element or elements described herein may each be formed from a sheet which is bent or folded to form corrugations. Any corrugated element or elements described herein may each be formed from a sheet forming corrugations through changes in direction of the sheet. The thickness of the sheet forming the corrugated element may differ by no more than 20 or 10 or 5% along one or both of its length and width. The thickness of the sheet forming the corrugated element may be substantially constant. The thickness of the sheet forming the corrugated element may be less than 1, 0.8 or 0.5 millimetres. The thickness of the corrugated element may be at least 2, 3, or 5 times a minimum thickness of the sheet. All peaks of corrugations of the corrugated element may have equal amplitude. All troughs of corrugations of the corrugated element may have equal amplitude. All peaks and all troughs of corrugations of the corrugated element may have equal amplitude. All corrugations of the corrugated element may have equal wavelength. The aerosol-generating article may be a planar aerosol-generating article. The aerosol-forming substrate may be a planar aerosol-forming substrate. As used herein, the term “planar” may refer to a component having two dimensions, for example a length and a width, each being at least 2, 2.5, 3, 5, or 10 times a third dimension, for example a thickness, each of those three dimensions being perpendicular to one another.

Thus, the aerosol-generating article may have an article width and an article thickness both perpendicular to the article length. The article width and the article length may each be at least 2, 2.5, 3, 5, or 10 times the article thickness. The aerosol-forming substrate may have a substrate width and a substrate thickness both perpendicular to the substrate length. The substrate width and the substrate length may each be at least 2, 2.5, 3, 5, or 10 times the substrate thickness.

The article thickness may be the smallest dimension of the article. The article thickness may be less than 7, 6, or 5 millimetres. The substrate thickness may be the smallest dimension of the substrate. The substrate thickness may be less than 7, 6, or 5 millimetres. Advantageously, planar or thin articles or substrates may reduce a maximum distance between a heater and the aerosol-forming material during use. This may advantageously lead to smaller temperature gradients across the aerosol-forming material, thus improving the proportion of aerosol-forming material that can be heated to a high enough temperature to form an aerosol for a given heater temperature, or without a significant risk of burning aerosol-forming material closest to the heater. The aerosol-forming substrate may comprise a first planar layer. The corrugated element or the one or more corrugated elements may be arranged on the first planar layer, for example on a first or upper surface of the first planar layer. Troughs of corrugations of the corrugated element or of the one or more corrugated elements may be adjacent to or in contact with the first planar layer, for example the first surface of the first planar layer.

Optionally in addition to the features of the above paragraph, the aerosol-forming substrate may further comprise a second planar layer. The corrugated element or the one or more corrugated elements may be referred to as a first corrugated layer and may be arranged between the first planar layer and the second planar layer. Peaks of corrugations of the corrugated element or the one or more corrugated elements may be adjacent to or in contact with the second planar layer, for example a second or lower surface of the second planar layer.

Optionally in addition to the features of the above paragraph, the aerosol-forming substrate may further comprise a second corrugated layer comprising one or both of: at least one corrugated element of the one or more corrugated elements; and one or more additional corrugated elements. The second corrugated layer may be arranged on the second planar layer, for example on a first or upper surface of the second planar layer. Troughs of corrugations of the corrugated element or of the one or more corrugated elements of the second corrugated layer may be adjacent to or in contact with the second planar layer, for example the first or upper surface of the second planar layer.

Optionally in addition to the features of the above paragraph, the aerosol-forming substrate may further comprise a third planar layer. The second planar layer may be arranged between the first planar layer and the third planar layer. Peaks of corrugations of the corrugated element or of the one or more corrugated elements of the second corrugated layer may be adjacent to or in contact with the second or lower surface of the third planar layer. Such an aerosol-forming substrate is shown in FIG. 22 and described later.

Features described in relation to planar layers herein may be applicable to the first, second and third planar layers of the above four paragraphs.

The one or more corrugated elements of the article or substrate may comprise at least two, three, four, or five corrugated elements. Advantageously, this may allow the provision of structural support to only the parts of the article or substrate where that support is needed, even where those parts are spaced apart. Also advantageously, the use of two or more corrugated elements may allow the use of different corrugated elements to provide different levels of structural support, or even serve different purposes, such as the provision of structural support and the provision of aerosol-forming material.

At least one of the at least two corrugated elements may be arranged partially or entirely downstream of another of the at least two corrugated elements. Where there are at least the corrugated element and second and third corrugated elements, the second corrugated element may be partially or entirely upstream of the corrugated element, and the third corrugated element may be partially or entirely downstream of the corrugated element. A cross direction of at least a portion of the second corrugated element may be non-parallel, for example perpendicular, to the cross direction of at least a portion of the corrugated element. A cross direction of at least a portion of the third corrugated element may be non-parallel, for example perpendicular, to the cross direction of at least a portion of the corrugated element. Similarly to before, this may advantageously allow the provision of different levels of structural support to different regions in the article or substrate. Also advantageously, this may allow easy tailoring of the air flow path, and particularly local RTD, in different regions of the article or substrate.

As an example, the at least two corrugated elements may comprise a first corrugated element, a second corrugated element, and a third corrugated element. A cross direction of at least a portion of the first corrugated element may be substantially parallel to one or both of the article air flow path and the article length. The first corrugated element may advantageously provide structural support at or near an upstream end of the article or substrate. The second corrugated element may be located partially or entirely downstream of the first corrugated element. A cross direction of at least a portion of the second corrugated element may be substantially perpendicular to one or both of the article air flow path and the article length. The second corrugated element may comprise holes or perforations to allow air to flow through the second corrugated element. The second corrugated element may advantageously increase, or allow tailoring of, the RTD of the article or substrate. The third corrugated element may be located partially or entirely downstream of the second corrugated element. A cross direction of at least a portion of the third corrugated element may be substantially parallel to one or both of the article air flow path and the article length. The third corrugated element may advantageously allow cooling of aerosol at or near the downstream end of the article or substrate, and may advantageously provide structural support at or near the downstream end of the article or substrate.

Alternatively, or in addition, at least one of the at least two corrugated elements may be arranged neither upstream nor downstream of another of the at least two corrugated elements. For example, the two corrugated elements may be in different air flow paths through the article or substrate, or at least one of the two corrugated elements may be not located in an air flow path through the article or substrate.

The corrugated element, or at least one, for example all, of the one or more corrugated elements, may comprise one or more perforations or holes. Said perforations or holes may be for air to flow through the corrugated element or elements.

Any corrugated element described herein may comprise corrugations along at least 50, 60, 70, 80 or 90%, or along substantially all of, a dimension in the cross direction of the corrugated element. Any corrugated element described herein may comprise corrugations along at least 50, 60, 70, 80 or 90%, or along substantially all of, a dimension in the machine direction of the corrugated element. Any corrugated element described herein may comprise at least 3, 5 or 10 corrugation peaks. Any corrugated element described herein may comprise at least 3, 5 or 10 corrugation troughs.

As the skilled person would understand after reading this disclosure, features described earlier in relation to the aerosol-forming substrate may be applicable to the aerosol-generating article. And features described in relation to a particular component of the substrate may be applicable to the same particular component of the article. Thus, merely as examples, features described in relation to corrugated elements or aerosol-forming material of the substrate may be applicable to corrugated elements or aerosol-forming material of the article respectively.

According to the present disclosure, an aerosol-generating device for receiving an aerosol-forming article as disclosed herein, or an aerosol-forming substrate as disclosed herein, may comprise a cavity dimensioned to receive at least a portion of the aerosol-generating article or aerosol-forming substrate, a heater or heating means, a power source for supplying power to the heater or heating means, and a controller to control supply of power to the heater or heating means. The aerosol-generating device is configured to heat an aerosol-forming substrate, for example an aerosol-forming substrate that is a component part of an aerosol-generating article, to form an aerosol, for example an inhalable aerosol.

The cavity may comprise an opening into which a distal end of the aerosol-generating article can be inserted. The cavity may have any suitable cross-sectional shape. For example, the cavity may have a rectangular transverse cross-section, for example a rectangular cross-section having opposing top and bottom sides that are greater in length than left and right sides. Preferably, at least one internal surface of the cavity is a heating surface configured to heat an aerosol-generating article. The heating surface may comprise a heater, for example a resistance heater, or an infra-red heater, or a susceptor configured to be heated by engagement with an inductor. The heating surface may comprise an inductor, for example the surface may comprise a coil arranged to generate a fluctuating electromagnetic field within a space of the cavity. The heating surface may be a surface that is permeable to a fluctuating electromagnetic field, such that an inductor arranged outside the cavity can project a fluctuating electromagnetic field through the heating surface to engage with a susceptor arranged within the cavity.

Preferably, at least a lower surface of the cavity is a heating surface configured to heat an aerosol-generating article. Optionally, both the lower and an upper surface of the cavity are heating surfaces configured to heat an aerosol-generating article.

Preferably, at least a lower internal surface of the cavity is a substantially planar surface, preferably in which both lower and upper internal surfaces of the cavity are substantially planar. Preferably, upper and lower internal surfaces of the cavity are arranged in parallel relationship to one another.

Optionally, upper and lower internal surfaces may converge along a length of the cavity such that they are slightly closer spaced at a distal end of the cavity than at a proximal end of the cavity. This may allow the cavity to grip an aerosol-generating article inserted therein. Side internals surfaces may converge in a similar manner to achieve the result of gripping an aerosol-generating article. The upper and lower internal surfaces of the cavity, and/or opposing side surfaces of the cavity, may converge by between 1 degree and 10 degrees between the proximal end of the cavity and the distal end of the cavity, for example between 2 and 8 degrees, for example between 3 and 6 degree, for example between 4 and 5 degrees.

In some example, the lower internal surface and the upper internal surface may be movable relative to each other. For example, the lower internal surface and the upper internal surface may be configured to pivot relative to one another, or to move upward and downward relative to one another. This may allow an aerosol-forming substrate, or an aerosol-generating article to be easily inserted into the cavity, while allowing the cavity walls to move to retain the substrate or article in position to be heated. For example, relative movement of upper and lower internal surfaces may result in an aerosol-generating article being gripped between the two surfaces to facilitate heating of the article and to help position the article appropriately within the device.

The cavity may be defined by a longitudinal dimension or length, a transverse dimension or width, and a depth dimension or height. The length and width are preferably greater in magnitude than the height, for example at least twice the magnitude of the height.

The device may comprise a heating surface comprising a plurality of separately operable heating zones, for example two separately operable heating zones, or three separately operable heating zones, or four separately operable heating zones, or five separately operable heating zones, or six separately operable heating zones. The plurality of separably operable heating zones may be configured to be operated individually, or in any combination of two or more zones at once. In some examples, the plurality of separably operable heating zones may be longitudinally spaced within the cavity. In some example, the plurality of separably operable heating zones may be transversely spaced within the cavity. Different heating zones may be both transversely and longitudinally spaced from one another. Different heating zones may be arranged concentrically relative to one another.

The device may comprise one or more resistance heaters, for example one or more resistance heaters integrated into walls of the cavity.

The device may comprises one or more inductors, for example one or more inductors integrated into walls of the cavity, or arranged to generate a fluctuating electromagnetic field in walls of the cavity, or within the cavity. One or more walls of the cavity comprise or consist of susceptor material, such that the one or more walls of the cavity heat up on engagement with a fluctuating electromagnetic field, thereby heating an aerosol-generating article inserted within the The device may comprise one or more insertable heating elements arranged to project into the cavity for insertion into an aerosol-generating article. The insertable heating elements may be arranged to be inserted into channels defined within the aerosol generating article, for example into channels formed by a corrugated structure of an aerosol-generating article.

The insertable heating elements may be resistance heaters. The insertable heating elements may be susceptors.

The aerosol-generating device may comprise a device body. The device body may comprise the heater. The aerosol-generating device may comprise a mouthpiece element. The device body may comprise a device body housing. The device body housing may define the cavity for receiving at least a portion of the aerosol-generating article. The device body and the mouthpiece element may be releasably connectable. The mouthpiece element may be releasably connectable with the device body, for example the device body housing.

The mouthpiece element may be releasably connectable with the device body, for example the device body housing, between a connected position and a disconnected position. In the connected position, the cavity may be at least partially covered, for example by the mouthpiece element. In the disconnected position, the cavity may be at least partially exposed, for example so as to allow insertion of the article into the cavity. The mouthpiece element may be moveable, for example pivotable about a hinge, relative to the device body, for example between a first position and a second position. In the first position, the cavity may be at least partially covered, for example by the mouthpiece element. In the second position, the cavity may be at least partially exposed, for example so as to allow insertion of the article into the cavity. Advantageously, covering the cavity, or the article in the cavity, may ensure most aerosol from the article travels along the desired flow path to the user, rather than escaping to the external environment.

The device, for example the device body, may comprise a power source such as a battery. In use, the power source may provide power to the heater. The device, for example the device body, may comprise a controller. The controller may be configured to control power from the power supply to the heater.

The device body may comprise a distal end and a proximal end. The cavity may be defined at the proximal end of the device body. The mouthpiece element may comprise a distal end and a proximal end. The distal end of the mouthpiece element may be configured to releasably connect to the proximal end of the device body.

The mouthpiece element, or at least a portion of the mouthpiece element, may be configured to be inserted into a mouth of a user. The proximal end of the mouthpiece element may be configured to be inserted into a mouth of a user.

The device, for example one or both of the device body and the mouthpiece element, may comprise an air inlet. The device, for example the mouthpiece element, may comprise an air outlet. The device may comprise an air flow path fluidly connecting the air inlet to the air outlet. The air flow path may extend one or both of through and past the cavity. As such, in use, the device may be configured such that, when a negative pressure is applied to the air outlet, for example by a user drawing on the air outlet, air is drawn in through the air inlet, then past an aerosol-generating article received in the cavity, thereby entraining aerosol released from the aerosol-forming substrate of the article, then out through the air outlet.

According to the present disclosure, an aerosol-generating system comprises an aerosol-generating device as disclosed herein and an aerosol-generating article as disclosed herein. The system may comprise a plurality of such articles for use with the aerosol-generating device.

As used herein, the term “aerosol-generating article” may refer to an article able to generate, or release, an aerosol.

As used herein, the term “aerosol-forming substrate” may refer to a substrate capable of releasing an aerosol or volatile compounds that can form an aerosol. Such volatile compounds may be released by heating the aerosol-forming substrate. An aerosol-forming substrate may comprise an aerosol-forming material. An aerosol-forming substrate may be adsorbed, coated, impregnated, or otherwise loaded onto a carrier or support. An aerosol-forming substrate may conveniently be part of an aerosol-generating article or smoking article.

As used herein, the term “aerosol-generating device” may refer to a device for use with an aerosol-generating article to enable the generation, or release, of an aerosol.

As used herein, the term ‘aerosol generating system’ refers to a combination of an aerosol-generating device and one or more aerosol-forming articles for use with the device. An aerosol-generating system may include additional components, such as a charging unit for recharging an on-board electric power supply in an electrically operated or electric aerosol-generating device. As used herein, the term “aerosol former” may refer to any suitable known compound or mixture of compounds that, in use, facilitates formation of an aerosol. The aerosol may be a dense and stable aerosol. The aerosol may be substantially resistant to thermal degradation at the operating temperature of the aerosol-forming substrate or aerosol-generating article.

As used herein with reference to the invention, the term “nicotine”, is used to describe nicotine, nicotine base or a nicotine salt.

As used herein with reference to the invention, the terms “proximal”, “distal”, “upstream” and “downstream” are used to describe the relative positions of components, or portions of components, of the cartridge and aerosol-generating system.

As used herein, the term “longitudinal”, when used with reference to a direction of the aerosol-generating article, refers to the direction corresponding to the main longitudinal axis of the aerosol-generating article, which may extend between the upstream and downstream ends of the aerosol-generating article. During use, air may be drawn through the aerosol-generating article in the longitudinal direction.

As used herein, the term “longitudinal”, when used with reference to a direction of a corrugated element, or a longitudinally extending component (such as a longitudinally extending channel) of a corrugated element, may refer to a cross direction of the corrugated element.

As used herein, the term ‘sheet’ denotes a laminar element having a width and length substantially greater than the thickness thereof. The width of a sheet may be greater than 10 mm, preferably greater than 20 mm or 30 mm. In certain embodiments, sheets of material for use in forming aerosol-forming substrates as described herein may have a thickness of between 10 μm and about 1000 μm, for example between 10 μm and about 800, 500 or 300 μm.

As used herein, a “susceptor” means a conductive element that heats up when subjected to a changing magnetic field. This may be the result of eddy currents induced in the susceptor element and/or hysteresis losses.

As used herein, the term “homogenised tobacco material” encompasses any tobacco material formed by the agglomeration of particles of tobacco material. Sheets or webs of homogenised tobacco material are formed by agglomerating particulate tobacco obtained by grinding or otherwise powdering of one or both of tobacco leaf lamina and tobacco leaf stems. In addition, homogenised tobacco material may comprise a minor quantity of one or more of tobacco dust, tobacco fines, and other particulate tobacco by-products formed during the treating, handling and shipping of tobacco. The sheets of homogenised tobacco material may be produced by casting, extrusion, paper making processes or other any other suitable processes known in the art.

The term “cast leaf” is used herein to refer to a product made by a casting process that is based on casting a slurry comprising plant particles (for example, clove particles or tobacco particles and clove particles in a mixture) and a binder (for example, guar gum) onto a supportive surface, such as a belt conveyor, drying the slurry and removing the dried sheet from the supportive surface. An example of the casting or cast leaf process is described in, for example, U.S. Pat. No. 5,724,998 for making cast leaf tobacco. In a cast leaf process, particulate plant materials are produced by pulverizing, grinding, or comminuting parts of the plant. The particles produced from one or more plants are mixed with a liquid component, typically water, to form a slurry. Other components in the slurry may include fibres, a binder and an aerosol former. The particulate plant materials may be agglomerated in the presence of the binder. The slurry is cast onto a supportive surface and dried into a sheet of homogenized plant material. Preferably, the homogenized plant material used in articles according to the present invention may be produced by casting. Such homogenized plant material may comprise agglomerated particulate plant material.

As used herein, resistance to draw is expressed with the units of pressure “mm H₂O” or ‘mm WG’ or ‘mm of water gauge’ and may be measured in accordance with ISO 6565:2002.

The invention is defined in the claims. However, below there is provided a non-exhaustive list of non-limiting examples. Any one or more of the features of these examples may be combined with any one or more features of another example, embodiment, or aspect described herein.

Ex1. An aerosol-forming substrate comprising an aerosol-forming material for producing an aerosol, the aerosol-forming substrate having a base defined by an x dimension extending in an x direction and a y dimension extending in a y direction, and a height defined by a z dimension extending in a z direction.

Ex1A. A substantially planar aerosol-forming substrate, for example a substrate according to Ex1, comprising an upper layer, a lower layer, the upper layer and the lower layer being arranged as substantially parallel planes spaced apart by an intermediate layer, or separation layer, located between the upper layer and the lower layer, the intermediate layer or separation layer comprising or consisting of one or more separation members extending between an upper surface of the lower layer and a lower surface of the upper layer.

Ex1B. A substrate according to Ex1A in which the one or more separation members comprise or consist of pillars separating the upper layer from the lower layer.

Ex1C. A substrate according to Ex1A or Ex1B in which the intermediate layer or separation layer comprises a plurality of discrete separation members.

Ex1D. A substrate according to any of examples Ex1A or Ex1B in which the intermediate layer or separation layer comprises a single separation member.

Ex1E. A substrate according to any of Ex1A to Ex1D in which the intermediate layer or separation layer comprises a separation member having a plurality of upwardly extending portions supporting the lower surface of the upper layer, and a plurality of downwardly depending portions supporting the upper surface of the lower layer.

Ex1F. A substrate according to any of Ex1A to Ex1E in which the intermediate layer or separation layer comprises a mesh or foam.

Ex1G. A substrate according to any of Ex1A to Ex1F in which one or more separation member is formed as a textured or embossed sheet having upwardly depending protrusions and downwardly depending protrusions.

Ex1H. A substrate according to any of Ex1A to Ex1G in which an air-flow path is defined through the substrate between the upper layer and the lower layer.

Ex1l. A substrate according to any of Ex1A to Ex1H in which the intermediate layer or separation layer is a sinusoidal surface, for example in which the intermediate layer or separation layer has a surface or profile obtained by translating perpendicularly a first periodic curve along a second periodic curve, for example by translating perpendicularly a first continuous periodic curve along a second continuous periodic curve, for example by translating perpendicularly a first sinusoid along a second sinusoid.

Ex1J. A substrate according to Ex11 in which the intermediate layer or separation layer is shaped like an egg box.

Ex1K. A substrate according to any of examples Ex1E to Ex1J in which the upwardly extending portions and or downwardly depending portions have a substantially circular plan view profile or a substantially rectangular plan view profile.

Ex2. An aerosol-forming substrate comprising an aerosol-forming material for producing an aerosol, the aerosol-forming substrate being a planar aerosol-forming substrate having a base defined by a length extending in an x direction, a width extending in a y direction, and a height extending in a z direction.

Ex2A. A substantially planar aerosol-forming substrate, for example an aerosol-forming substrate according to any preceding example, comprising an upper layer, a lower layer, the upper layer and the lower layer being arranged as substantially parallel planes spaced apart by an intermediate or separation layer located between the upper layer and the lower layer, the separation layer comprising or consisting of one or more separation members extending between an upper surface of the lower layer and a lower surface of the upper layer.

Ex2B. A substrate according to Ex2A in which the separation members are ribs or struts separating the upper layer from the lower layer.

Ex2C. A substrate according to any of Ex2A or Ex2B in which the separation members are longitudinally extending separation members.

Ex2D. A substrate according to any of Ex2A to Ex2C in which each of the separation members forms a line of contact between the separation member and one, or both, of the upper layer and the lower layer.

Ex2E. A substrate according to any of Ex2A to Ex2D in which each separation member has a length that is a greater dimension than a width, and a width that is of greater dimension than a thickness.

Ex2F. A substrate according to any of Ex2A to Ex2E in which the upper layer and the lower layer are spaced by a width dimension of the separation members.

Ex2G. A substrate according to any of Ex2A to Ex2F in which at least one separation member is laterally kinked, for example laterally kinked such that the at least one separation member is capable of standing freely upon an edge, for example laterally kinked such that the at least one separation member is capable of self standing upon an edge, for example such that a width dimension of the separation member extends perpendicularly from a surface upon which the separation member is standing.

Ex2H. A substrate according to any of Ex2A to Ex2G, the substrate having a base defined by an x dimension extending in an x direction and a y dimension extending in a y direction, and a height defined by a z dimension extending in a z direction.

Ex21. A substrate according to Ex2H in which a width of the extension member extends in the z direction of the substrate.

Ex2J. A substrate according to Ex2H or Ex21 in which a length of the extension member extends in the x direction or the y direction.

Ex3. An aerosol-forming substrate comprising an aerosol-forming material for producing an aerosol, the aerosol-forming substrate comprising a substantially planar upper surface defined by a length extending in an x direction and a width extending in a y direction, and a substantially planar lower surface defined by a length extending in an x direction and a width extending in a y direction, the substantially planar upper surface and the substantially planar lower surface being vertically spaced from each other by a height defined in a z direction.

Ex3A. An aerosol-forming substrate comprising an aerosol-forming material for producing an aerosol, the aerosol-forming substrate having a base defined by an x dimension and a y dimension, and a height defined by a z dimension, in which an air-flow path is defined through the aerosol-forming substrate in an x/y plane from one side of the aerosol-forming substrate to the other side of the aerosol-forming substrate, in which a resistance to draw (RTD) of the substrate, along the air-flow path, is less than 20 millimetre H₂O.

Ex3B. An aerosol-forming substrate, for example an aerosol-forming substrate according to any preceding example, the aerosol-forming substrate being a substantially planar aerosol-forming substrate comprising an upper layer, a lower layer, the upper layer and the lower layer being arranged as substantially parallel planes spaced apart by an intermediate or separation layer located between the upper layer and the lower layer, the separation layer comprising or consisting of a corrugated element formed from a corrugated sheet having a triangular corrugation profile. Ex3C. A substrate according to Ex3B in which an air flow path is defined through the aerosol-forming substrate between the upper layer and the lower layer.

Ex3D. A substrate according to Ex3A or Ex3B in which peaks of corrugations of the corrugated element form lines of contact between the separation layer and the upper layer.

Ex 3E. A substrate according to Ex3D in which less than 5% of the area of the lower surface of the upper layer is in physical contact with the separation layer, for example less than 4% or less than 3% or less than 2%.

Ex3F. A substrate according to any of Ex3B to Ex3E in which troughs of corrugations of the corrugated element form lines of contact between the separation layer and the upper layer.

Ex3G. A substrate according to Ex3F in which less than 5% of the area of the upper surface of the lower layer is in physical contact with the separation layer, for example less than 4% or less than 3% or less than 2%.

Ex3H. A substrate according to any Ex3B to Ex3G in which the separation layer comprises or consists of a corrugated sheet of paper.

Ex4. An aerosol-forming substrate according to any preceding example in which an air-flow path is defined through the aerosol-forming substrate in an x/y plane from one side of the aerosol-forming substrate to the other side of the aerosol-forming substrate, in which the aerosol-forming substrate has a resistance to draw of less than 20 millimetre H₂O, for example less than 10 millimetre H₂O, in the direction of the airflow path, for example less than 8 millimetre H₂O, for example less than 6 millimetre H₂O, for example less than 4 millimetre H₂O, or preferably less than 2 millimetre H₂O.

Ex4A. An aerosol-forming substrate according to any preceding example, in which the aerosol-forming substrate has a resistance to draw of less than 20 millimetre H₂O, for example less than 10 millimetre H₂O, in at least one direction in an x/y plane of the aerosol-forming substrate.

Ex5. An aerosol-forming substrate according to any preceding example in which the aerosol-forming substrate has a resistance to draw in a direction perpendicular to the z direction, the resistance to draw being less than 20 millimetre H₂O, for example less than 10 millimetre H₂O.

Ex6. An aerosol-forming substrate according to any preceding example in which an air-flow path is defined through the aerosol-forming substrate along the x direction from one side of the aerosol-forming substrate to the other side of the aerosol-forming substrate, such that the aerosol-forming substrate has a resistance to draw of less than 20 millimetre H₂O, for example less than 10 millimetre H₂O, in the x direction.

Ex7. An aerosol-forming substrate according to any of examples Ex1 to Ex5 in which an air-flow path is defined through the aerosol-forming substrate along the y direction from one side of the aerosol-forming substrate to the other side of the aerosol-forming substrate, such that the aerosol-forming substrate has a resistance to draw of less than 20 millimetre H₂O, for example less than 10 millimetre H₂O, in the y direction.

Ex8. An aerosol-forming substrate according to any of examples Ex4 to Ex7 in which the resistance to draw is between 9.9 millimetre H₂O and 0 millimetre H₂O, for example between 8 millimetre H₂O and 1 millimetre H₂O, or between 6 millimetre H₂O and 2 millimetre H₂O, or between 5 millimetre H₂O and 3 millimetre H₂O.

Ex9. An aerosol-forming substrate according to any preceding example in which an air-flow path is defined through the aerosol-forming substrate in an x/y plane from one side of the aerosol-forming substrate to the other side of the aerosol-forming substrate, in which the aerosol-forming substrate has a porosity of greater than 60%, for example greater than 80%, in the direction of the airflow path.

Ex9i. An aerosol-forming substrate according to any preceding example, in which the aerosol-forming substrate has a porosity of greater than 60%, for example greater than 80%, in at least one direction in an x/y plane of the aerosol-forming substrate.

Ex10. An aerosol-forming substrate according to any preceding example in which the aerosol-forming substrate has a porosity in a direction perpendicular to the z direction, the porosity of greater than 60%, for example greater than 80%.

Ex11. An aerosol-forming substrate according to any preceding example, except for example Ex7, in which an air-flow path is defined through the aerosol-forming substrate along the x direction from one side of the aerosol-forming substrate to the other side of the aerosol-forming substrate, such that the aerosol-forming substrate has a porosity of greater than 60%, for example greater than 80%, in the x direction.

Ex12. An aerosol-forming substrate according to any preceding example, except for examples Ex6 and Ex11, in which an air-flow path is defined through the aerosol-forming substrate along the y direction from one side of the aerosol-forming substrate to the other side of the aerosol-forming substrate, such that the aerosol-forming substrate has a porosity of greater than 60%, for example greater than 80%, in the y direction.

Ex13. An aerosol-forming substrate according to any of examples Ex9 to Ex12 in which the porosity is between 81% and 99%, for example a porosity of between 85% and 95%, for example between 88% and 92%, for example about 90%.

Ex14. An aerosol-forming substrate according to any preceding example in which the substrate comprises an upper layer defining an upper surface and a lower layer defining a lower surface, in which an air flow path is defined through the aerosol-forming substrate between the upper layer and the lower layer.

Ex15. An aerosol-forming substrate according to any preceding example in which the substrate comprises an upper layer defining an upper surface and a lower layer defining a lower surface, in which an air flow path is defined through the aerosol-forming substrate from one side to an opposite side between the upper layer and the lower layer.

Ex16. An aerosol-forming substrate according to any preceding example in which the substrate comprises an upper layer defining an upper surface and a lower layer defining a lower surface, in which an air flow path is defined in an x/y plane through the aerosol-forming substrate from one side to an opposite side between the upper layer and the lower layer.

Ex17. An aerosol-forming substrate according to example Ex16 in which a plurality of channels are defined through the aerosol-forming substrate between the upper surface and the lower surface.

Ex18. An aerosol-forming substrate according to any of examples Ex16 to Ex17, in which the aerosol-forming substrate comprises an intermediate or separation layer located between the upper layer and the lower layer.

Ex19. An aerosol-forming substrate according to example Ex18, in which the intermediate or separation layer comprises one or more ribs or struts separating the upper layer from the lower layer, preferably in which the ribs or struts extend in the direction of an air flow path defined through the aerosol-forming substrate.

Ex20. An aerosol-forming substrate according to any preceding example comprising a corrugated element, for example a corrugated sheet of material.

Ex21. An aerosol-forming substrate according to example Ex18 in which the intermediate or separation layer comprises or consists of a corrugated element, for example a corrugated sheet of material.

Ex22. An aerosol-forming substrate according to any preceding example in which the aerosol-forming substrate comprises an upper layer, a lower layer, and an intermediate or separation layer located between the upper layer and the lower layer, in which the separation layer comprises one or more corrugated elements.

Ex23. An aerosol-forming substrate according to example Ex22 in which the one or more corrugated elements define a plurality of air flow channels extending through the aerosol-forming substrate.

Ex24. An aerosol-forming substrate according to example Ex22 or Ex23 in which the aerosol-forming substrate comprises a plurality of corrugated elements, in which two or more of the plurality of corrugated elements are arranged in vertical relationship to each other between the upper layer and the lower layer.

Ex25. An aerosol-forming substrate according to example Ex24 in which the aerosol-forming substrate comprises an upper corrugated element arranged in contact with the upper layer, and a lower corrugated element arranged in contact with the lower layer.

Ex26. An aerosol-forming substrate according to example Ex25 further comprising at least one additional corrugated element disposed between the upper corrugated element and the lower corrugated element.

Ex27. An aerosol-forming substrate according to any of examples Ex22 to Ex26 in which the aerosol-forming substrate comprises a plurality of corrugated elements, in which two or more of the plurality of corrugated elements are arranged in a lateral side by side relationship to each other between the upper layer and the lower layer.

Ex28. An aerosol-forming substrate according to any of examples Ex22 to Ex26 in which the aerosol-forming substrate comprises a plurality of corrugated elements, in which two or more of the plurality of corrugated elements are arranged in a lateral end to end relationship to each other between the upper layer and the lower layer.

Ex29. An aerosol-forming substrate according to any preceding example in which the aerosol-forming substrate has a proximal end and a distal end, an air flow path being defined between the proximal end and the distal end.

Ex30. An aerosol-forming substrate according to example Ex29 in which an air flow direction extends between the proximal end and the distal end and in which the air flow path is defined by at least one corrugated element, ridges and troughs of the at least one corrugated element being aligned substantially parallel to the air flow direction.

Ex31. An aerosol-forming substrate according to example Ex30 in which the aerosol-forming substrate comprises a first corrugated element located at or towards the proximal end and a second corrugated element located at or towards the distal end, for example in which the first corrugated element and the second corrugated element are arranged in a lateral end to end relationship to each other between the upper layer and the lower layer, each corrugated element being aligned substantially parallel to the air flow direction.

Ex32. An aerosol-forming substrate according to any of examples Ex1 to Ex31 comprising an upper layer, a lower layer, and an intermediate layer disposed between the upper layer and the lower layer, in which the upper layer comprises, or consists of, an aerosol-forming material and the lower layer and the intermediate layer do not comprise an aerosol-forming material.

Ex33. An aerosol-forming substrate according to any of examples Ex1 to Ex31 comprising an upper layer, a lower layer, and an intermediate layer disposed between the upper layer and the lower layer, in which the lower layer comprises, or consists of, an aerosol-forming material and the upper layer and the intermediate layer do not comprise an aerosol-forming material.

Ex34. An aerosol-forming substrate according to any of examples Ex1 to Ex31 comprising an upper layer, a lower layer, and an intermediate layer disposed between the upper layer and the lower layer, in which the intermediate layer comprises, or consists of, an aerosol-forming material and the upper layer and the lower layer do not comprise an aerosol-forming material.

Ex35. An aerosol-forming substrate according to any of examples Ex1 to Ex31 comprising an upper layer, a lower layer, and an intermediate layer disposed between the upper layer and the lower layer, in which the lower layer comprises, or consists of, a first aerosol-forming material and the upper layer comprises, or consists of, a second aerosol-forming material, and the intermediate layer does not comprise an aerosol-forming material.

Ex36. An aerosol-forming substrate according to any of examples Ex1 to Ex31 comprising an upper layer, a lower layer, and an intermediate layer disposed between the upper layer and the lower layer, in which the lower layer comprises, or consists of, a first aerosol-forming material and the intermediate layer comprises, or consists of, a second aerosol-forming material, and the lower layer does not comprise an aerosol-forming material.

Ex37. An aerosol-forming substrate according to any of examples Ex1 to Ex31 comprising an upper layer, a lower layer, and an intermediate layer disposed between the upper layer and the lower layer, in which the upper layer comprises, or consists of, a first aerosol-forming material and the intermediate layer comprises, or consists of, a second aerosol-forming material, and the upper layer does not comprise an aerosol-forming material.

Ex38. An aerosol-forming substrate according to any of examples Ex1 to Ex31 comprising an upper layer, a lower layer, and an intermediate layer disposed between the upper layer and the lower layer, in which the upper layer comprises, or consists of, a first aerosol-forming material and the intermediate layer comprises, or consists of, a second aerosol-forming material, and the lower layer comprises, or consists of, a third aerosol-forming material.

Ex39. An aerosol-forming substrate according to any of examples Ex32 to Ex38 in which the upper layer comprises or is formed from a planar sheet of material, the lower layer comprises or is formed from a planar sheet of material, and the intermediate layer comprises or is formed from a corrugated sheet of material.

Ex40. An aerosol-forming substrate according to any preceding example comprising a first aerosol-forming material and a second aerosol-forming material.

Ex41. An aerosol-forming substrate according to example Ex40 further comprising a third aerosol-forming material.

Ex42. An aerosol-forming substrate according to any of example Ex40 in which the first aerosol-forming material is the same material as the second aerosol-forming material.

Ex43. An aerosol-forming substrate according to Ex41 in which the first aerosol-forming material is the same material as the third aerosol-forming material, for example in which the first, second, and third aerosol-forming materials are all the same aerosol-forming material.

Ex44. An aerosol-forming substrate according to example Ex40 in which the first aerosol-forming material is different to the second aerosol-forming material, for example of different composition to the second aerosol-forming material, for example with different aerosol-former content, or different flavour content.

Ex45. An aerosol-forming substrate according to Example Ex41 in which the first aerosol-forming material is different to the third aerosol-forming material, for example of different composition to the second aerosol-forming material, for example with different aerosol-former content, or different flavour content, for example in which first, second, and third aerosol-forming materials are all different materials.

Ex46. An aerosol-forming substrate according to any preceding example in which the aerosol-forming material is a homogenised tobacco material, for example in which any of the first, second, or third aerosol-forming materials is a homogenised tobacco material.

Ex47. An aerosol-forming substrate according to any preceding example comprising an upper layer, a lower layer, and an intermediate or separation layer disposed between the upper layer and the lower layer, in which the intermediate layer is fixed relative to at least one of the upper layer and lower layer by an adhesive.

Ex48. An aerosol-forming substrate according to example Ex47 in which the adhesive is an aerosol forming material, for example in which the adhesive is a homogenised tobacco slurry or in which the adhesive is, or comprises, a flavourant and/or an aerosol-former.

Ex49. An aerosol-forming substrate according to example Ex47 or Ex48 in which the intermediate layer comprises or consists of a corrugated element.

Ex50. An aerosol-forming substrate according to any preceding example in which an airflow path is defined through the substrate by channels formed by longitudinally extending corrugations of a corrugated element.

Ex51. An aerosol-forming substrate according to example Ex50 in which a porous material is located within the channels formed by the longitudinally extending corrugations.

Ex52. An aerosol-forming substrate according to example Ex51 in which the porous material comprises or consists of an aerosol-forming material.

Ex53. An aerosol-forming substrate according to example Ex51 or Ex52 in which the porous material comprises a flavourant.

Ex54. An aerosol-forming substrate according to any of examples Ex50 to Ex53 in which a flavourant is located within the channels formed by the longitudinally extending corrugations to release flavour on heating, for example a flavour thread and/or one or more flavour capsules.

Ex55. An aerosol-forming substrate according to any preceding example in which an airflow path, or the airflow path, is defined through the aerosol-forming substrate in an x/y plane from one side of the aerosol-forming substrate to the other side of the aerosol-forming substrate.

Ex56. An aerosol-forming substrate according example Ex55 in which the airflow path passes through a filter or mesh or porous material such as porous paper, for example tea-bag material, incorporated in the aerosol-forming substrate.

Ex57. An aerosol-forming substrate according to example Ex56 in which the filter or mesh or porous material such as porous paper, for example tea-bag material is disposed transverse to the airflow path, for example across a proximal or downstream end of the aerosol-forming substrate.

Ex58. An aerosol-forming substrate according to any preceding example comprising a substantially planar layer and a corrugated layer fixed to a surface of the substantially planar layer such that longitudinal channels formed by longitudinally extending corrugations of the corrugated layer extend in a planar direction of the substantially planar layer.

Ex59. An aerosol-forming substrate according to any preceding example comprising an upper layer, a lower layer, and an intermediate layer, in which at least one of the upper layer and the lower layer comprises perforations or holes such that at least a portion of air can flow through the upper and/or lower layer.

Ex60. An aerosol-forming substrate according to example Ex59, in which the aerosol-forming substrate comprises a proximal or mouth end and a distal end, and in which the perforations or holes are located in a central portion of the aerosol-forming substrate, for example approximately midway between the proximal or mouth end and the distal end.

Ex61. An aerosol-forming substrate according to example Ex59 or Ex60 in which the intermediate layer comprises or consists of a corrugated element or layer arranged between the upper layer and the lower layer such that longitudinal channels formed by longitudinally extending corrugations of the corrugated element or layer extend in a planar direction of the upper layer and lower layer.

Ex62. An aerosol-forming substrate according to example Ex61 in which the intermediate layer comprises perforations or holes such that at least a portion of air can flow through the intermediate layer in a direction perpendicular to the longitudinally extending channels.

Ex63. An aerosol-forming substrate according to any preceding example comprising an upper layer, a lower layer, and an intermediate layer, in which the intermediate layer comprises or consists of a corrugated element or layer arranged between the upper layer and the lower layer such that longitudinal channels formed by longitudinally extending corrugations of the corrugated element or layer extend in a planar direction of the upper layer and lower layer, and in which the intermediate layer comprises perforations or holes such that at least a portion of air can flow through the intermediate layer in a direction perpendicular to the longitudinally extending channels.

Ex64. An aerosol-forming substrate according to example Ex63 in which the intermediate layer is a mesh.

Ex65. An aerosol-forming substrate according to example Ex63 or Ex64 in which the aerosol-forming substrate comprises a proximal or mouth end and a distal end, and in which the longitudinal channels formed by longitudinally extending corrugations of the corrugated element or layer extend in a direction perpendicular to a direction defined between the proximal or mouth end and the distal end.

Ex65A. An aerosol-generating substrate according to any preceding example, comprising one or more sheets of aerosol-forming material, in which a plurality of holes or notches are defined in a surface, for example an upper surface or lower surface of aerosol-forming material.

Ex65B. An aerosol-generating substrate according to any preceding example, in which the aerosol-forming substrate comprises a lower layer of aerosol-forming material and a corrugated layer attached to the lower layer, for example a corrugated layer of aerosol-forming material, in which a plurality of holes or notches are defined in at least one of the lower layer of aerosol-forming material and the corrugated layer.

Ex65C. An aerosol-forming substrate according to any preceding example in which a plurality of holes or notches are defined in an upper surface of the aerosol-forming substrate.

Ex65D. An aerosol-generating article according to examples Ex65A to Ex65C, in which at least a portion of the plurality of holes are blind holes that do not extend through the thickness of the aerosol-forming material they are defined in.

Ex65E. An aerosol-generating article according to any of examples Ex65A to Ex65D, in which at least a portion of the plurality of holes are through-holes that extend through the thickness of the aerosol-forming material they are defined in.

Ex66. An aerosol-forming substrate comprising a first planar layer, and a corrugated layer arranged on a surface of the first planar layer, at least one of the first planar layer and the corrugated layer comprising or consisting of an aerosol-forming material.

Ex67. An aerosol-forming substrate comprising a first planar layer, a second planar layer, and a corrugated layer arranged between the first planar layer and the second planar layer, at least one of the first planar layer, the second planar layer and the corrugated layer comprising or consisting of an aerosol-forming material.

Ex68. An aerosol-forming substrate comprising a first layer, and a corrugated layer attached to a surface of the first layer by an adhesive, in which an adhesive comprises or consists of an aerosol-forming material.

Ex69. An aerosol-forming substrate comprising a first layer, a second layer, and an intermediate layer disposed between the first layer and the second layer, in which the intermediate layer is attached to the first layer and/or the second layer by an adhesive, in which an adhesive comprises or consists of an aerosol-forming material.

Ex70. An aerosol-forming substrate comprising a first layer, and a corrugated layer attached to a surface of the first layer, a plurality of longitudinally extending channels being defined between the first layer and the second layer by corrugations, in which a porous element is located in at least one of the longitudinally extending channels.

Ex71. An aerosol-forming substrate comprising a first layer, and a corrugated layer attached to a surface of the first layer, a plurality of longitudinally extending channels being defined between the first layer and the corrugated layer by corrugations, in which the longitudinally extending channels are filled with a porous material, for example a porous aerosol forming material.

Ex72. An aerosol-forming substrate comprising a first layer, a second layer, and a corrugated layer disposed between the first layer and the second layer, a plurality of longitudinally extending channels being defined by corrugations between the first layer and the corrugated layer, and between the corrugated layer and the second layer, in which a porous element is located in at least one of the longitudinally extending channels.

Ex73. An aerosol-forming substrate comprising a first layer, and a corrugated layer attached to a surface of the first layer, a plurality of longitudinally extending channels being defined between the first layer and the corrugated layer by corrugations, in which one or more flavour releasing component, for example a component such as a thread or capsule that is impregnated with or contains a flavour component, is located within at least one of the longitudinally extending channels.

Ex74. An aerosol-forming substrate comprising a first layer, a second layer, and a corrugated layer disposed between the first layer and the second layer, a plurality of longitudinally extending channels being defined by corrugations between the first layer and the corrugated layer, and between the corrugated layer and the second layer, in which one or more flavour releasing component, for example a component such as a thread or capsule that is impregnated with or contains a flavour component, is located within at least one of the longitudinally extending channels.

Ex75. An aerosol-forming substrate comprising a first planar layer, and a corrugated layer arranged on a surface of the first planar layer, at least one of the first planar layer and the corrugated layer comprising perforations or holes to allow air to flow through the first planar layer or the corrugated layer.

Ex76. An aerosol-forming substrate comprising a first planar layer, a second planar layer, and a corrugated layer arranged between the first planar layer and the second planar layer, at least one of the first planar layer, the second planar layer and the corrugated layer comprising perforations or holes to allow air to flow through the first planar layer, the second planar layer, or the corrugated layer.

Ex77. An aerosol-forming substrate comprising a first planar layer, a second planar layer, and a third planar layer arranged between the first planar layer and the second planar layer, the aerosol-forming substrate further comprising a first corrugated layer disposed between the first planar layer and the third planar layer, and a second corrugated layer disposed between the third planar layer and the second planar layer.

Ex78. An aerosol-forming substrate according to any preceding example comprising a corrugated element or layer, in which corrugations of the corrugated element or layer are defined by a corrugation wavelength and a corrugation amplitude.

Ex79. An aerosol-forming substrate according to example Ex78 in which the corrugation wavelength is between 1 mm and 10 mm, for example between 1.5 mm and 8 mm, for example between 2 mm and 6 mm, for example between 2.5 mm and 5 mm, for example between 3 mm and 4 mm.

Ex80. An aerosol-forming substrate according to example Ex78 or Ex79 in which the corrugation amplitude, or z axis thickness of the corrugated element or layer, is between 1 mm and 10 mm, for example between 1.5 mm and 8 mm, for example between 2 mm and 6 mm, for example between 2.5 mm and 5 mm, for example between 3 mm and 4 mm.

Ex80A. An aerosol-forming substrate according to any of examples comprising at least one planar layer and at least one corrugated layer, in which the thickness of the at least one planar layer is between 0.02 mm to 2 mm, for example between 0.05 mm to 1.5 mm, for example between 0.1 mm and 1 mm, for example between 0.2 mm and 0.8 mm, for example between 0.3 mm and 0.6 mm, for example between 0.4 mm and 0.5 mm.

Ex81. An aerosol-forming substrate according to any of examples Ex78 to Ex80 in which the corrugations may be further defined by a corrugation profile, in which the corrugation profile is sinusoidal, or triangular, or rectangular, or trapezoidal, or toroidal, or parabolic.

Ex82. An aerosol-forming substrate according to any preceding example in which the aerosol-forming substrate is formed as an extrusion of an aerosol-forming material having an upper surface, a lower surface, and a plurality of air flow channels defined through the aerosol-forming substrate between the upper surface and the lower surface.

Ex83. An aerosol-forming substrate according to any preceding example, in which the length (x dimension) is approximately the same magnitude as the width (y dimension).

Ex84. An aerosol-forming substrate according to any of examples Ex1 to Ex82, in which the length (x dimension) is greater in magnitude than the width (y dimension), for example in which the length is about 1.5 times the magnitude of the width, or about 2 times the magnitude of the width, or about 2.5 times the magnitude of the width, or about 3 times the magnitude width.

Ex85. An aerosol-forming substrate according to example Ex84, in which the length (x dimension) is greater than 3 the magnitude of the width, for example greater than 4 times the magnitude of the width, for example greater than 5 times the magnitude of the width.

Ex86. An aerosol-forming substrate according to any preceding example having a base, in which the base is substantially planar, for example in which the base defines a substantially planar lower surface of the aerosol-forming substrate.

Ex87. An aerosol-forming substrate according to any preceding example, in which the aerosol-forming substrate is in the form of a 3-dimensional shape that may be described as cuboid, or rectangular prismatic.

Ex88. An aerosol-forming substrate according to any preceding example, in which one or both of the length (x dimension) and the width (y dimension) have a magnitude equal to or greater than 2 times the magnitude of the height (z dimension), for example 3 times, or 4 times, or 5 times the height, optionally equal to or greater than 6 times the height, for example 10 times the height, or 15 times the height, or 20 times the height.

Ex89. An aerosol-forming substrate according to any preceding example having a base, in which the base is defined by a rectangular shape having a length and a width forming a lower surface of the aerosol-forming substrate, an upper surface of the aerosol-forming substrate being defined by defined by an substantially identical rectangular shape spaced from the base by the height, for example in which both the lower surface and the upper surface are defined as planar surfaces located on parallel planes spaced by the height.

Ex90. An aerosol-forming substrate according to any preceding example, in which a ratio of the largest in magnitude of its length (x dimension) and its width (y dimension) to its height (z dimension) is between 4:1 and 20:1, for example between 4.2:1 and 10:1, for example between 4.5:1 and 8:1, for example in which the ratio of length to width is between 4:1 and 20:1, for example between 4.2:1 and 10:1, for example between 4.5:1 and 8:1.

Ex91. An aerosol-forming substrate according to any preceding example, in which length of the substrate (x dimension) is between 10 mm and 50 mm, for example between 12 mm and 30 mm, for example between 14 mm and 26 mm, for example between 16 mm and 24 mm, for example between 18 mm and 22 mm, for example about 18 mm, or about 19 mm, or about 20 mm, or about 21 mm, or about 22 mm.

Ex92. An aerosol-forming substrate according to any preceding example, in which width of the substrate (y dimension) is between 5 mm and 20 mm, for example between 8 mm and 18 mm, for example between 10 mm and 16 mm, for example between 11 mm and 15 mm, for example between 12 mm and 14 mm, for example about 13 mm.

Ex93. An aerosol-forming substrate according to any preceding example, in which height of the substrate (z dimension) is between 1 mm and 10 mm, for example between 1.2 mm and 8 mm, for example between 1.4 mm and 7 mm, for example between 1.6 mm and 6 mm, for example between 1.7 mm and 5 mm, for example about 1.7 mm, or about 4.5 mm, or about 2 mm, or about 3 mm, or about 4 mm.

Ex94. An aerosol-forming substrate according to any preceding example, in which the aerosol-forming substrate consists entirely of aerosol-forming material.

Ex95. An aerosol-forming substrate according to any preceding example, further comprising a porous layer covering at least one surface of the aerosol-forming substrate, for example at least an upper surface, or at least a lower surface, or at least upper and lower surfaces.

Ex96. An aerosol-forming substrate according to any preceding example, further comprising a porous layer covering at least an end surface of the aerosol-forming substrate, for example at least covering at least one airflow inlet or outlet of the aerosol-forming substrate.

Ex97. An aerosol-forming substrate according to example Ex95 or Ex96, in which the porous layer completely encapsulates the aerosol-forming substrate.

Ex98. An aerosol-forming substrate according to example Ex95, Ex96, or Ex97, in which the porous layer is a porous paper or a porous mesh.

Ex99. An aerosol-forming substrate according to any preceding example, in which the aerosol-forming substrate comprises nicotine.

Ex100. An aerosol-forming substrate according to any preceding example, in which the aerosol-forming substrate comprises or consists of homogenised tobacco material.

Ex101. An aerosol-forming substrate according to any preceding example, in which the aerosol-forming substrate comprises or consists of a solid aerosol-forming material.

Ex102. An aerosol-forming substrate according to any preceding example, in which the aerosol-forming substrate comprises a liquid aerosol-forming material retained within a porous matrix. Ex103. An aerosol-forming substrate according to any preceding example, in which the aerosol-forming substrate comprises a gel aerosol-forming material.

Ex104. An aerosol-forming substrate according to any preceding example, in which a first portion of the aerosol-forming substrate comprises a first aerosol-forming material, and a second portion of the aerosol-forming substrate comprises a second aerosol-forming material different to the first aerosol-forming material.

Ex105. An aerosol-forming substrate according to example Ex104, in which the first aerosol-forming material is a first homogenised tobacco material, and the second aerosol-forming material is a second homogenised tobacco material having a different composition to the first homogenised tobacco material.

Ex106. An aerosol-forming substrate according to example Ex105, in which the first homogenised tobacco material differs from the second tobacco composition by virtue of having at least one difference selected from the list consisting of: different aerosol-former content, different tobacco content, different flavourant content, different water content, and different nicotine content.

Ex107. An aerosol-forming substrate according to example Ex104, in which the first aerosol-forming material is a first homogenised tobacco material, and the second aerosol-forming material is a non-tobacco aerosol forming material comprising an aerosol-former, such as glycerine or propylene glycol, preferably including a flavour component and or an active component such as nicotine or a cannabinol.

Ex108. An aerosol-forming substrate according to any preceding example, further comprising a thermally conductive layer, for example an aluminium layer, covering at least a portion of at least one surface of the aerosol-forming substrate, for example at least a portion of an upper surface, or at least a portion of a lower surface.

Ex109. An aerosol-forming substrate according to any preceding example, further comprising a paper layer, for example a tipping paper layer, covering at least a portion of at least one surface of the aerosol-forming substrate, for example at least a portion of an upper surface, or at least a portion of a lower surface.

Ex110. An aerosol-forming substrate according to any preceding example comprising at least one aerosol-forming material, the aerosol-forming material comprising one or more organic materials such as tobacco, for example in which the aerosol-forming material comprises one or more of herb leaf, tobacco leaf, fragments of tobacco ribs, reconstituted tobacco, homogenised tobacco, extruded tobacco and expanded tobacco.

Ex111. An aerosol-forming substrate according to any preceding example comprising at least one aerosol-forming material, the aerosol-forming material comprising one or more aerosol-formers for example one or more aerosol-formers selected from the list consisting of: polyhydric alcohols, such as propylene glycol, polyethylene glycol, triethylene glycol, 1, 3-butanediol and glycerine; esters of polyhydric alcohols, such as glycerol mono-, di-or triacetate; and aliphatic esters of mono-, di- or polycarboxylic acids, such as dimethyl dodecanedioate and dimethyl tetradecanedioate, preferably in which the aerosol-former is or comprises glycerine.

Ex112. An aerosol-forming substrate according to example Ex111 in which aerosol-forming material comprises at least 1 weight percent aerosol-former, for example at least 2, 5, 10, or 15 weight percent aerosol-former.

Ex112A. An aerosol-forming substrate according to example Ex112 in which the aerosol-forming material comprises greater than 15 weight percent aerosol-former, for example greater than 20 weight percent, or greater than 25 weight percent, or greater than 30 weight percent, or greater than 40 weight percent, or greater than 50 weight percent aerosol-former.

Ex113. An aerosol-forming substrate according to any preceding example comprising at least one aerosol-forming material, the aerosol-forming material comprising nicotine.

Ex113A. An aerosol-forming substrate according to example Ex113 in which the aerosol-forming material comprises at least 0.5 percent by weight of nicotine, for example at least 1 percent by weight of nicotine, or at least 1.5 percent by weight of nicotine, or at least 2 percent by weight of nicotine..

Ex114. An aerosol-forming substrate according to any preceding example comprising at least one aerosol-forming material, the aerosol-forming material comprising one or more cannabinoid compounds such as one or more of: tetrahydrocannabinol (THC), tetrahydrocannabinolic acid (THCA), cannabidiol (CBD), cannabidiolic acid (CBDA), cannabinol (CBN), cannabigerol (CBG), cannabigerol monomethyl ether (CBGM), cannabivarin (CBV), cannabidivarin (CBDV), tetrahydrocannabivarin (THCV), cannabichromene (CBC), cannabicyclol (CBL), cannabichromevarin (CBCV), cannabigerovarin (CBGV), cannabielsoin (CBE), cannabicitran (CBT). It may be preferable that the cannabinoid compound is CBD or THC, preferably in which the cannabinoid compound is CBD.

Ex115. An aerosol-forming substrate according to any preceding example comprising at least one aerosol-forming material, the aerosol-forming material comprising one or more flavourants, for example in which the one or more flavourants comprise: one or more essential oils such as eugenol, peppermint oil and spearmint oil; one or both of menthol and eugenol; one or both of anethole and linalool; and a herbaceous material, for example herb leaf or other herbaceous material from herbaceous plants including for example, mints, such as peppermint and spearmint, lemon balm, basil, cinnamon, lemon basil, chive, coriander, lavender, sage, tea, thyme, and caraway.

Ex116. An aerosol-forming substrate according to any preceding example comprising at least one aerosol-forming material, the aerosol-forming material comprising particles of a functional material, for example particles of carbon, graphite, activated carbon, or expanded graphite.

Ex117. An aerosol-forming substrate according to any preceding example comprising at least one aerosol-forming material, the aerosol-forming material comprising non-tobacco fibres, for example non-tobacco cellulose fibres.

Ex118. An aerosol-forming substrate according to any preceding example comprising at least one aerosol-forming material, the aerosol-forming material comprising a binder, for example guar gum.

Ex119. An aerosol-forming substrate according to any preceding example comprising at least one aerosol-forming material, the aerosol-forming material comprising conductive particle, for example conductive carbon or graphite particles or conductive metallic particles, for example particles of aluminium, or stainless steel, or nickel.

Ex120. An aerosol-forming substrate according to any preceding example comprising one or more susceptor materials.

Ex121. An aerosol-forming substrate according to example Ex120 in which one or more susceptor materials are incorporated within an aerosol-forming material of the aerosol-forming substrate, for example as particles of susceptor material distributed within the aerosol-forming material.

Ex122. An aerosol-forming substrate according to example Ex120 or Ex121 in which one or more susceptor materials are incorporated within the aerosol-forming substrate as one or more strips, threads, or wires of susceptor material, for example one or more strips, threads, or wires of susceptor material located within an airflow path of the aerosol-forming substrate.

Ex123. An aerosol-forming substrate according to any of examples Ex120 to Ex122 in which one or more susceptor materials are incorporated within the aerosol-forming substrate as one or more sheets or layers of susceptor material, for example one or more sheets or layers of susceptor material covering an external portion of the aerosol-forming substrate, or forming a Ex124. An aerosol-forming substrate according to any of examples Ex120 to Ex123 in which the aerosol-forming substrate comprises a first planar layer, and a corrugated layer arranged on a surface of the first planar layer, at least one of the first planar layer and the corrugated layer comprising or consisting of a sheet of susceptor material.

Ex125. An aerosol-forming substrate according to any of examples Ex120 to Ex124 comprising a first planar layer, a second planar layer, and a corrugated layer arranged between the first planar layer and the second planar layer, at least one of the first planar layer, the second planar layer and the corrugated layer comprising or consisting of a sheet of susceptor material.

Ex126. An aerosol-forming substrate according to any of examples Ex123 to Ex125 in which the one of more sheet of susceptor material is in the form of a mesh of susceptor material.

Ex127. An aerosol-forming substrate according to any of examples Ex120 to Ex126 in which the susceptor material comprises one or more materials selected from the list consisting of: aluminium, iron and iron alloys, nickel and nickel alloys, cobalt alloys, stainless steel alloys, copper alloys, carbon, expanded carbon, and graphite.

Ex128. An aerosol-generating article for use with an aerosol-generating device to generate an inhalable aerosol, the aerosol-generating article consisting of an aerosol-forming substrate according to any of examples Ex1 to Ex127.

Ex129. An aerosol-generating article for use with an aerosol-generating device to generate an inhalable aerosol, the aerosol-generating article comprising an aerosol-forming substrate according to any of examples Ex1 to Ex127.

Ex130. An aerosol-generating article according to example Ex129 in which the aerosol-forming substrate is located within an outer wrapper or outer casing.

Ex131. An aerosol-generating article according to example Ex130 in which the outer wrapping or outer casing is a cigarette wrapper.

Ex132. An aerosol-generating article according to example Ex130 in which the outer wrapping or outer casing is a polymeric sheet.

Ex133. An aerosol-generating article according to any of examples Ex130 to Ex132 in which the outer wrapping or outer casing comprises a susceptor material, for example a portion of aluminium or stainless steel foil.

Ex134. An aerosol-generating article according to any of examples Ex130 to Ex133 in which one or more perforations are defined through the outer wrapping or outer casing.

Ex135. An aerosol-generating article according to any of examples Ex130 to Ex133 in which a plurality of components, including the aerosol-forming substrate, are assembled within the outer wrapping or outer casing.

Ex136. An aerosol-generating article according to any of examples Ex129 to Ex133 comprising two or more aerosol-forming substrates according to any of examples Ex1 to Ex128.

Ex137. An aerosol-generating article according to any of examples Ex128 to Ex136, the aerosol-generating article having a length extending in an x direction, a width extending in a y direction, and a height extending in a z direction, a longitudinal airflow path being defined through the aerosol-generating article between a distal end of the article and a proximal end of the article.

Ex138. An aerosol-generating article according to any of examples Ex128 to Ex137, the aerosol-generating article having a length extending in an x direction between a distal end and a proximal end, a width extending in a y direction between a first edge and a second edge, and a height extending in a z direction between an upper surface and a lower surface, preferably a distal portion of the aerosol-generating article being defined between the distal end of the aerosol-generating article and a longitudinal mid-point of the aerosol-generating article, and a proximal portion of the aerosol-generating article being defined between the proximal end of the aerosol-generating article and the longitudinal mid-point of the aerosol-generating article.

Ex139. An aerosol-generating article according to example Ex137 or Ex138 comprising a single aerosol-forming substrate according to any of examples Ex1 to Ex128 that extends between the proximal end and the distal end within the article.

Ex140. An aerosol-generating article according to example Ex138 or Ex139 comprising an aerosol-forming substrate according to any of examples Ex1 to Ex128 located within the distal portion of the aerosol-generating article.

Ex141. An aerosol-generating article according to example Ex138 or Ex139 comprising an aerosol-forming substrate according to any of examples Ex1 to Ex128 located entirely within the distal portion of the aerosol-generating article.

Ex142. An aerosol-generating article according to example Ex140 or Ex141 further comprising a structural element located proximally relative to the aerosol-forming substrate, the structural element having longitudinal channels or porosity allowing an airflow path through the structural element.

Ex143. An aerosol-generating article according to example Ex142 in which the aerosol-forming substrate has a transverse cross-section, and the structural element has a similar or identical transverse cross-section, for example a similar rectangular transverse cross-section.

Ex144. An aerosol-generating article according to example Ex142 or Ex143 in which the structural element is a rectangular tube.

Ex145. An aerosol-generating article according to example Ex142 or Ex143 in which the structural element comprises a corrugated element, longitudinal channels within the aerosol-generating article being defined by the corrugated element.

Ex146. An aerosol-generating article according to example Ex145 in which the structural element comprises a corrugated element, longitudinal channels within the aerosol-generating article being defined by corrugations of the corrugated element.

Ex147. An aerosol-generating article according to example Ex138 or Ex139 comprising a first aerosol-forming substrate according to any of examples Ex1 to Ex128 located at least partially within the distal portion of the aerosol-generating article and a second aerosol-forming substrate according to any of examples Ex1 to Ex128 located proximally relative to the first aerosol-forming substrate, for example at least partially within the proximal portion of the aerosol-generating article.

Ex148. An aerosol-generating article according to any of examples Ex130 to Ex147 comprising a plurality of components, including at least one aerosol-forming substrate according to any of examples Ex1 to Ex128, a substantially hollow structural element, for example a hollow tube, and a mouthpiece element, for example a mouthpiece filter, coaxially aligned and assembled within a wrapper or casing.

Ex149. An aerosol-generating article according to any of examples Ex128 to Ex148, the aerosol-generating article having a length, a width, and a height, in which the length is greater in magnitude than the width, and in which the width is greater in magnitude than the height.

Ex150. An aerosol-generating article according to example Ex149 in which the length is about 1.5 times the magnitude of the width, or about 2 times the magnitude of the width, or about 2.5 times the magnitude of the width, or about 3 times the magnitude width.

Ex151. An aerosol-generating article according to example Ex149 or Ex150, in which the length is greater than 3 the magnitude of the width, for example greater than 4 times the magnitude of the width, for example greater than 5 times the magnitude of the width.

Ex152. An aerosol-generating article according to any of examples Ex149 to Ex151, in which the article comprises a substantially planar base, for example in which the base defines a substantially planar lower surface of the aerosol-forming substrate.

Ex153. An aerosol-generating article according to any of examples Ex149 to Ex152, in which the aerosol-generating article is in the form of a 3-dimensional shape that may be described as cuboid, or rectangular prismatic.

Ex154. An aerosol-generating article according to any of examples Ex149 to Ex153, in which the length has a magnitude equal to or greater than 2 times the magnitude of the height, for example 3 times, or 4 times, or 5 times the height, optionally equal to or greater than 6 times the height, for example 10 times the height, or 15 times the height, or 20 times the height.

Ex155. An aerosol-generating article according to any of examples Ex128 to Ex154, in which length of the article is between 10 mm and 50 mm, for example between 12 mm and 30 mm, for example between 14 mm and 26 mm, for example between 16 mm and 24 mm, for example between 18 mm and 22 mm, for example about 18 mm, or about 19 mm, or about 20 mm, or about 21 mm, or about 22 mm.

Ex156. An aerosol-generating article according to any of examples Ex128 to Ex155, in which width of the article is between 5 mm and 20 mm, for example between 8 mm and 18 mm, for example between 10 mm and 16 mm, for example between 11 mm and 15 mm, for example between 12 mm and 14 mm, for example about 13 mm.

Ex157. An aerosol-generating article according to any of examples Ex128 to Ex156, in which height of the article is between 1 mm and 10 mm, for example between 1.2 mm and 8 mm, for example between 1.4 mm and 7 mm, for example between 1.6 mm and 6 mm, for example between 1.7 mm and 5 mm, for example about 1.7 mm, or about 4.5 mm, or about 2 mm, or about 3 mm, or about 4 mm.

Ex157A. An aerosol-generating article according to any of examples Ex128 to Ex157, in which the article comprises a first section and a second section removably couplable to the first section, in which the first section comprises an aerosol-forming substrate according to any of examples Ex1 to Ex127, and in which the second section is a mouthpiece.

Ex157B. An aerosol-generating article according to example Ex157A in which the second section is a reusable mouthpiece designed for use with multiple first sections.

Ex158. An aerosol-generating article for use with an aerosol-generating device to generate an inhalable aerosol, the aerosol-generating article comprising an article upstream end and an article downstream end, wherein an article air flow path and an article length extend from the article upstream end to the article downstream end.

Ex159. An aerosol-generating article according to any of examples Ex128 to Ex157B, wherein the article is for use with an aerosol-generating device to generate an inhalable aerosol, the aerosol-generating article comprising an article upstream end and an article downstream end, wherein an article air flow path and an article length extend from the article upstream end to the article downstream end.

Ex160. An aerosol-generating article according to any of examples Ex158 to Ex159, the aerosol-generating article comprising or consisting of an aerosol-forming substrate according to any of examples Ex1 to Ex127.

Ex 161. An aerosol-generating article according to any of examples Ex 158 to Ex 160, wherein the article comprises one or more corrugated elements, preferably wherein the one or more corrugated elements together extend at least 50% of the article length.

Ex162. An aerosol-generating article according to example Ex161, wherein the one or more corrugated elements together extend at least 50, 60, 70, 80, 90, 95, 98, or 99% or substantially all of the article length.

Ex163. An aerosol-generating article according to example Ex161 or Ex162, wherein at least one, for example each, of the one or more corrugated elements is or comprises a corrugated sheet of material bent or folded to form corrugations.

Ex164. An aerosol-generating article according to any of examples Ex161 to Ex163, wherein the aerosol-generating article comprises an aerosol-forming substrate and wherein: the aerosol-forming substrate comprises a first planar layer; and the one or more corrugated elements are arranged on the first planar layer, for example on a first or upper surface of the first planar layer.

Ex165. An aerosol-generating article according to example Ex164, wherein the aerosol-forming substrate comprises a second planar layer; and the one or more corrugated elements are arranged between the first planar layer and the second planar layer.

Ex166. An aerosol-generating article according to example Ex165, wherein peaks of corrugations of the one or more corrugated elements are adjacent to or in contact with the first planar layer.

Ex167. An aerosol-generating article according to example Ex165 or Ex166, wherein troughs of corrugations of the one or more corrugated elements are adjacent to or in contact with the second planar layer.

Ex168. An aerosol-generating article according to any of examples Ex164 to Ex167, wherein the first planar layer comprises or consists of aerosol-forming material.

Ex169. An aerosol-generating article according to any of examples Ex161 to Ex168, wherein at least one, for example each, of the one or more corrugated elements comprises or consists of aerosol-forming material.

Ex 170. An aerosol-generating article according to example Ex 161 to 169, wherein the one or more corrugated elements comprises one or more perforations or holes for air to flow through the one or more corrugated elements.

Ex 171. An aerosol-generating article according to example Ex 161 to 170, wherein the one or more corrugated elements comprises at least two corrugated elements.

Ex172. An aerosol-generating article according to example Ex171, wherein at least one of the at least two corrugated elements is arranged partially or entirely downstream of another of the at least two corrugated elements.

Ex173. An aerosol-generating article according to example Ex171 or Ex172, wherein at least one of the at least two corrugated elements is arranged neither upstream nor downstream of another of the at least two corrugated elements.

Ex174. An aerosol-generating article according to any of examples Ex158 to Ex173, wherein the article comprises one or more sheets of aerosol-forming material, wherein at least one, for example each, of the one or more sheets of aerosol-forming material has a thickness of less than 1 mm, wherein the one or more sheets of aerosol-forming material together extend along at least 50% of the article length.

Ex175. An aerosol-generating article according to example Ex174, wherein the one or more sheets of aerosol-forming material together extend at least 60, 70, 80, 90, 95, 98, or 99% or substantially all of the article length.

Ex176. An aerosol-generating article according to example Ex174 or Ex175, when dependent on any of examples Ex161 to Ex172, wherein the one or more sheets of aerosol-forming material form at least one, for example each, of the one or more corrugated elements.

Ex177. An aerosol-generating article according to any of examples Ex158 to Ex176, wherein the article comprises an article air flow path extending from the article upstream end to the article downstream end, and the article comprises a first corrugated element, wherein a cross direction of at least a first portion of the first corrugated element is non-parallel, preferably perpendicular, to one or both of the article length and at least a first portion of the article air flow path.

Ex178. An aerosol-generating article according to example Ex177, wherein the cross direction of at least the first portion of the first corrugated element is perpendicular to one or both of the article length and at least the first portion of the article air flow path Ex179. An aerosol-generating article according to any of examples Ex177 to Ex178, wherein the first portion of the article air flow path is defined, at least in part, by the first portion of the first corrugated element.

Ex180. An aerosol-generating article according to any of examples Ex177 to Ex179, wherein the aerosol-generating article has a substantially planar upper surface defined by a length, for example the article length, extending in an x direction and a width extending in a y direction Ex181. An aerosol-generating article according to Ex180, wherein the aerosol-generating article has a substantially planar lower surface defined by a length, for example the article length, extending in an x direction and a width extending in a y direction.

Ex182. An aerosol-generating article according to Ex181, wherein the substantially planar upper surface and the substantially planar lower surface are vertically spaced from each other by a height defined in a z direction.

Ex183. An aerosol-generating article according to Ex181, wherein the cross direction of at least the first portion of the first corrugated element extends in the y direction or the z direction.

Ex184. An aerosol-generating article according to any of examples Ex177 to Ex183, wherein the first corrugated element comprises one or more perforations or holes for air to flow through the first corrugated element.

Ex185. An aerosol-generating article according to Ex184, wherein the article air flow path extends through the one or more perforations or holes.

Ex186. An aerosol-generating article according to any of examples Ex177 to Ex185, wherein the aerosol-generating article comprises a second corrugated element.

Ex187. An aerosol-generating article according to example Ex186, wherein the second corrugated element is upstream nor downstream of the first corrugated element.

Ex188. An aerosol-generating article according to example Ex186, wherein the second corrugated element is neither upstream nor downstream of the first corrugated element.

Ex189. An aerosol-generating article according to example Ex187, wherein the second corrugated element is upstream of the first corrugated element, and the aerosol-generating article comprises a third corrugated element downstream of the first corrugated element.

Ex190. An aerosol-generating article according to any of examples Ex186 to Ex189, wherein a cross direction of at least a portion of the second corrugated element is non-parallel to the cross direction of at least a portion of the first corrugated element.

Ex191. An aerosol-generating article according to any of examples Ex177 to Ex190, when directly or indirectly dependent example Ex161, wherein the first corrugated element is one of the one or more corrugated elements, or wherein the first corrugated element is distinct from the one or more corrugated elements.

Ex192. An aerosol-generating article according to any of examples Ex158 to Ex191, wherein the aerosol-generating article is a planar aerosol-generating article having an article width and an article thickness both perpendicular to the article length, and wherein one or both of: the article length and the article width are at least 2.5, 3 or 5 times the article thickness; and the article thickness is less than 7, 6, or 5 millimetres.

Ex193. An aerosol-generating device for receiving an aerosol-forming article according to any of examples Ex128 to Ex192 to form an inhalable aerosol, the aerosol-generating device comprising a cavity dimensioned to receive at least a portion of the aerosol-generating article, a heater or heating means, a power source for supplying power to the heater or heating means, and a controller to control supply of power to the heater or heating means.

Ex194. An aerosol-generating device according to example Ex193 in which the cavity comprises an opening into which a distal end of the aerosol-generating article can be inserted.

Ex195. An aerosol-generating device according to any of examples Ex193 to Ex194 in which the cavity has a rectangular transverse cross-section, for example a rectangular cross-section having top and bottom sides that are longer than left and right sides.

Ex196. An aerosol-generating device according to any of examples Ex193 to Ex195 in which at least one internal surface of the cavity is a heating surface configured to heat an aerosol-generating article, for example a surface comprising a heater, or a surface comprising an inductor.

Ex197. An aerosol-generating device according to example Ex196 in which at least a lower surface of the cavity is a heating surface configured to heat an aerosol-generating article.

Ex198. An aerosol-generating device according to example Ex197 in which both the lower and an upper surface of the cavity are heating surfaces configured to heat an aerosol-generating article.

Ex199. An aerosol-generating device according to any of examples Ex193 to Ex198 in which at least a lower internal surface of the cavity is a substantially planar surface, preferably in which both lower and upper internal surfaces of the cavity are substantially planar.

Ex200. An aerosol-generating device according to example Ex199 in which upper and lower internal surfaces of the cavity are arranged in parallel relationship to one another.

Ex201. An aerosol-generating device according to example Ex199 in which upper and lower internal surfaces converge along a length of the cavity such that they are slightly closer spaced at a distal end of the cavity than at a proximal end of the cavity.

Ex202. An aerosol-generating device according to example Ex201 in which the upper and lower internal surfaces of the cavity converge by between 1 degree and 10 degrees between the proximal end of the cavity and the distal end of the cavity, for example between 2 and 8 degrees, for example between 3 and 6 degree, for example between 4 and 5 degrees.

Ex203. An aerosol-generating device according to any of examples Ex199 to Ex202 in which the lower internal surface and the upper internal surface are movable relative to each other, for example in which the lower internal surface and the upper internal surface are configured to pivot relative to one another or to move upward and downward relative to one another.

Ex204. An aerosol-generating device according to any of examples Ex193 to Ex202 in which the cavity has a longitudinal dimension or length, a transverse dimension or width, and a depth dimension or height, and in which the length and width are greater in magnitude than the height, for example at least twice the magnitude of the height.

Ex205. An aerosol-generating device according to any of examples Ex193 to Ex203 in which the device comprises a heating surface comprising a plurality of separately operable heating zones, for example 2 separately operable heating zones, or 3 separately operable heating zones, or 4 separately operable heating zones, or 5 separately operable heating zones, or 6 separately operable heating zones.

Ex206. An aerosol-generating device according to example Ex1205 in which the plurality of separably operable heating zones are configured to be operated individually or in any combination of two or more zones at once.

Ex207. An aerosol-generating device according to example Ex205 or Ex206 in which the plurality of separably operable heating zones are longitudinally spaced within the cavity.

Ex208. An aerosol-generating device according to example Ex205 or Ex206 in which the plurality of separably operable heating zones are transversely spaced within the cavity.

Ex209. An aerosol-generating device according to any of examples Ex193 to Ex208 in which the device comprises one or more resistance heaters, for example one or more resistance heaters integrated into walls of the cavity.

Ex210. An aerosol-generating device according to any of examples Ex193 to Ex209 in which the device comprises one or more inductors, for example one or more inductors integrated into walls of the cavity, or arranged to generate a fluctuating electromagnetic field in walls of the cavity, or within the cavity.

Ex211. An aerosol-generating device according to example Ex210 in which walls of the cavity comprise or consist of susceptor material.

Ex212. An aerosol-generating device according to any of examples Ex193 to Ex211 in which the device comprises one or more insertable heating elements arrange to project into the cavity for insertion into an aerosol-generating article, for example into a corrugated structure of an aerosol-generating article.

Ex213. An aerosol-generating device according to example Ex212 in which the insertable heating elements are resistance heaters, or in which the heating elements are susceptors.

Ex214. An aerosol-generating system comprising an aerosol-generating device according to any of examples Ex193 to Ex213 and an aerosol-generating article according to any of examples Ex128 to Ex192.

Ex215. A method of making a planar corrugated aerosol-forming substrate comprising steps of:
providing a second continuous sheet, at least one of the first sheet and the second sheet being a sheet comprising or consisting of aerosol-forming material,
texturing the second continuous sheet using a fluting roller to form a continuous corrugated sheet,
applying adhesive to at least one of the continuous corrugated sheet or the first continuous sheet,
applying the continuous corrugated sheet to a surface of the first continuous sheet to form a continuous aerosol-forming substrate, and
cutting the continuous aerosol-forming substrate to form the planar corrugated aerosol-forming substrate.

Ex216. A method of making a planar corrugated aerosol-forming substrate comprising steps of:
providing a first continuous sheet,
providing a second continuous sheet, and providing a third continuous sheet,
at least one of the first sheet, the second continuous sheet, and the second sheet being a sheet comprising or consisting of aerosol-forming material,
texturing the second continuous sheet using a fluting roller to form a continuous corrugated sheet,
applying adhesive to at least one of the continuous corrugated sheet or the first continuous sheet,
applying a first side of the continuous corrugated sheet to a surface of the first continuous sheet,
applying adhesive to at least one of the continuous corrugated sheet and the third continuous sheet, and applying a second side of the continuous corrugated sheet to a surface of the third continuous sheet, thereby forming a continuous aerosol-forming substrate, and
cutting the continuous aerosol-forming substrate to form the planar corrugated aerosol-forming substrate.

Ex217. A method according to example Ex215 or Ex216 in which at least one of the first second and third continuous sheets is a sheet of homogenised tobacco.

Ex218. A method according to any of examples Ex215 to Ex217 in which the adhesive comprises guar gum.

Ex219. A method according to any of examples Ex215 to Ex218 in which the adhesive comprises an aerosol-forming substrate, for example a homogenised tobacco slurry.

Examples will now be further described with reference to the figures in which:

FIG. 1 is a schematic end view of an aerosol-forming substrate according to an embodiment of the invention;

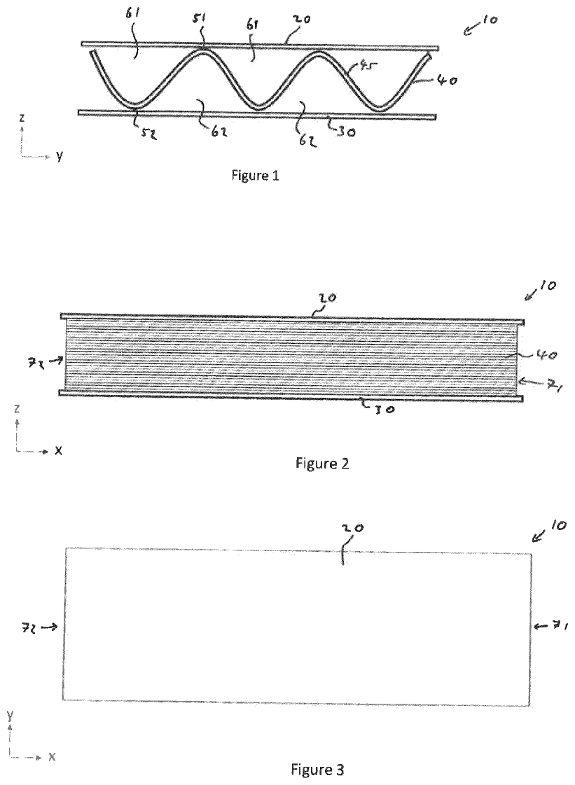

FIG. 2 is a schematic side view of the aerosol-forming substrate of FIG. 1;

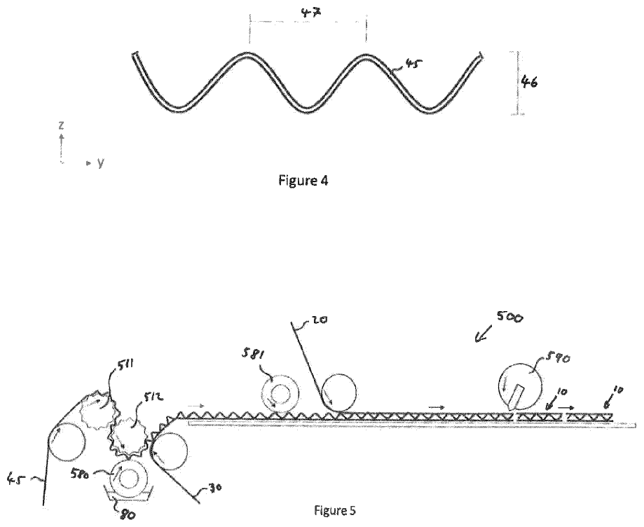

FIG. 3 is a schematic plan view of the aerosol-forming substrate of FIG. 1;

FIG. 4 shows a schematic illustration of a corrugated element as used in the aerosol-forming substrate of FIG. 1;

FIG. 5 shows a schematic illustration of an apparatus used in the manufacture of the aerosol-forming substrate of FIG. 1;

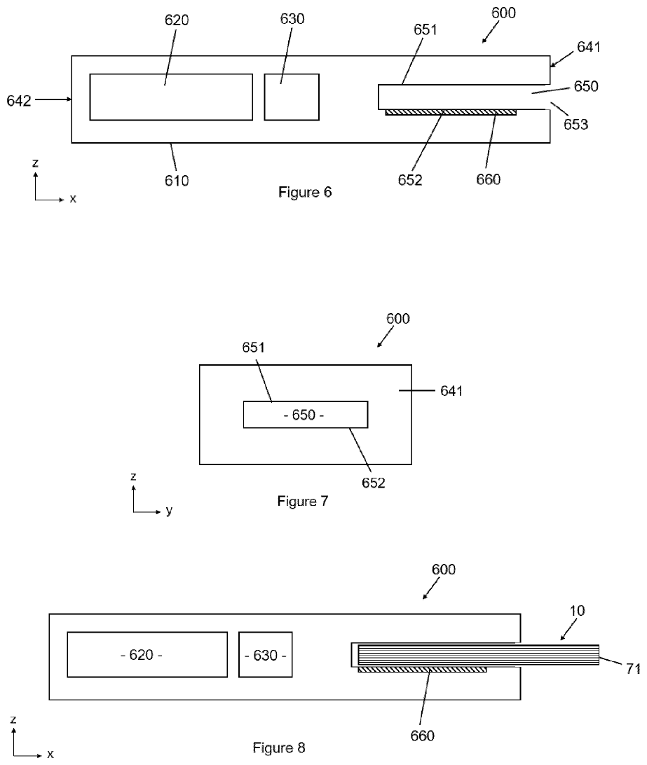

FIG. 6 illustrates an aerosol-generating device according to an embodiment of the invention, the device configured to engage with the aerosol-forming substrate of FIG. 1;

FIG. 7 shows an end view of the aerosol-generating device of FIG. 6;

FIG. 8 is a schematic illustration showing the aerosol-forming substrate of FIG. 1 in engagement with the aerosol-generating device of FIG. 6;

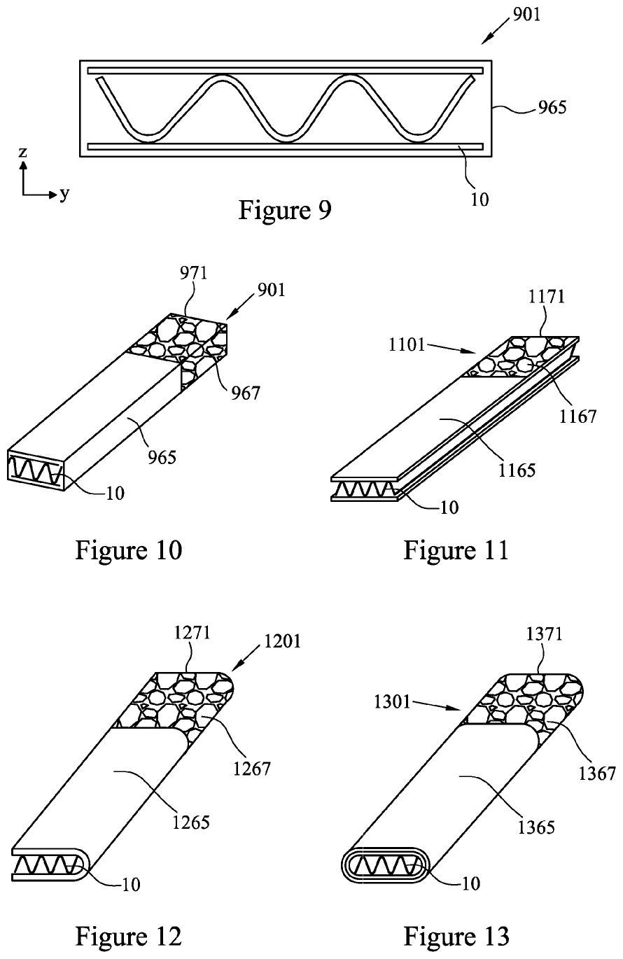

FIG. 9 is a schematic end view of an aerosol-forming article according to an embodiment of the invention, comprising the aerosol-forming substrate of FIG. 1;

FIG. 10 is a perspective view of the aerosol-generating article of FIG. 9;

FIG. 11 is a perspective view of an aerosol-generating article according to an embodiment of the invention;

FIG. 12 is a perspective view of an aerosol-generating article according to an embodiment of the invention;

FIG. 13 is a perspective view of an aerosol-generating article according to an embodiment of the invention;

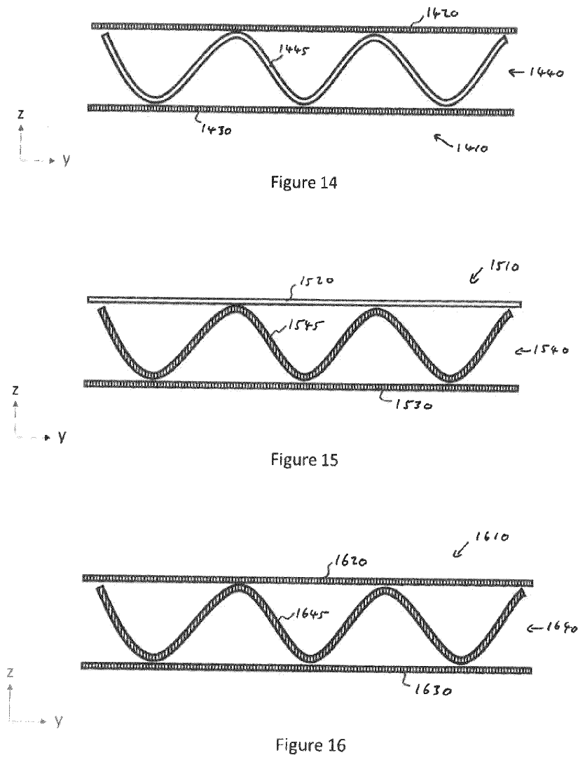

FIG. 14 is a schematic end view of an aerosol-forming substrate according to an embodiment of the invention;

FIG. 15 is a schematic end view of an aerosol-forming substrate according to an embodiment of the invention;

FIG. 16 is a schematic end view of an aerosol-forming substrate according to an embodiment of the invention;

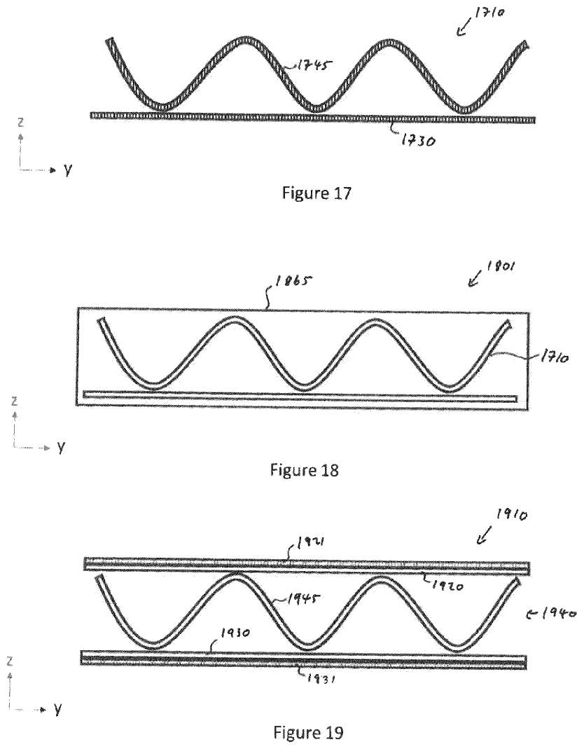

FIG. 17 is a schematic end view of an aerosol-forming substrate according to an embodiment of the invention;

FIG. 18 is a schematic end view of an aerosol-forming article according to an embodiment of the invention, comprising the aerosol-forming substrate of FIG. 17;

FIG. 19 is a schematic end view of an aerosol-forming substrate according to an embodiment of the invention;

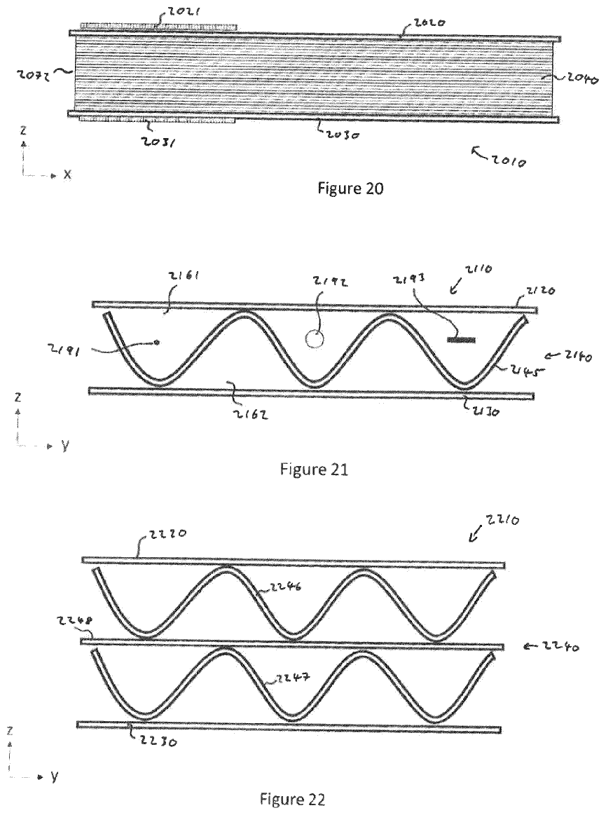

FIG. 20 is a schematic side view of an aerosol-forming substrate according to an embodiment of the invention;

FIG. 21 is a schematic end view of an aerosol-forming substrate according to an embodiment of the invention;

FIG. 22 is a schematic end view of an aerosol-forming substrate according to an embodiment of the invention;

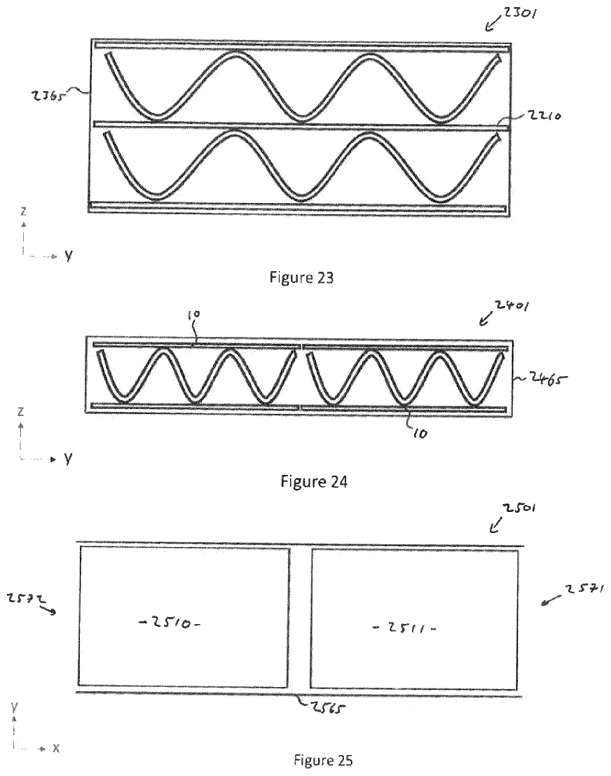

FIG. 23 is a schematic end view of an aerosol-forming article according to an embodiment of the invention, comprising the aerosol-forming substrate of FIG. 22;

FIG. 24 is a schematic end view of an aerosol-forming article according to an embodiment of the invention;

FIG. 25 is a schematic plan section of an aerosol-forming article according to an embodiment of the invention;

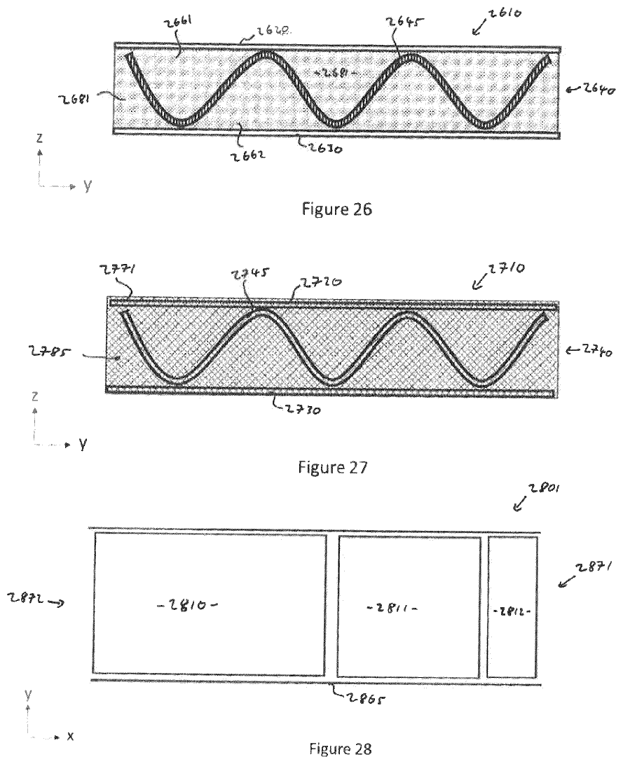

FIG. 26 is a schematic end view of an aerosol-forming substrate according to an embodiment of the invention;

FIG. 27 is a schematic end view of an aerosol-forming substrate according to an embodiment of the invention;

FIG. 28 is a schematic plan section of an aerosol-forming article according to an embodiment of the invention;

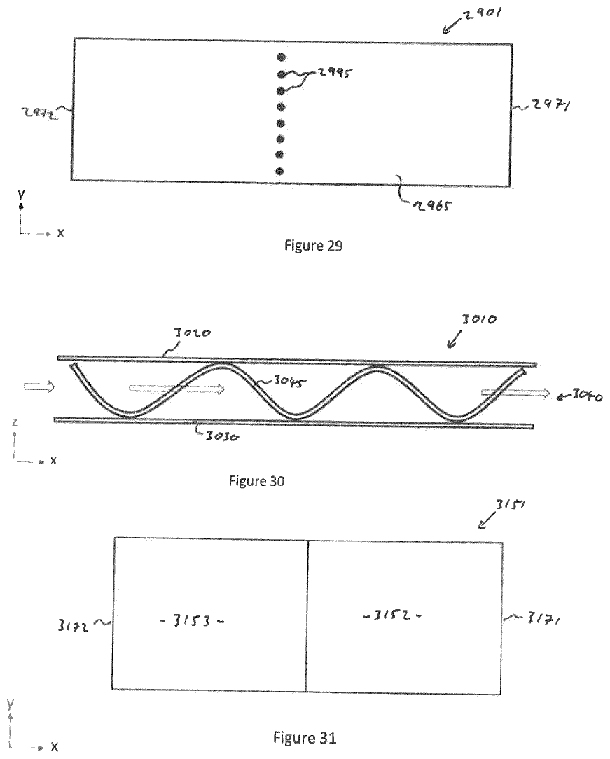

FIG. 29 is a schematic plan view of an aerosol-forming article according to an embodiment of the invention;

FIG. 30 is a schematic side view of an aerosol-forming substrate according to an embodiment of the invention;

FIG. 31 is a schematic plan view of a planar heater of an aerosol-generating device according to an embodiment of the invention;

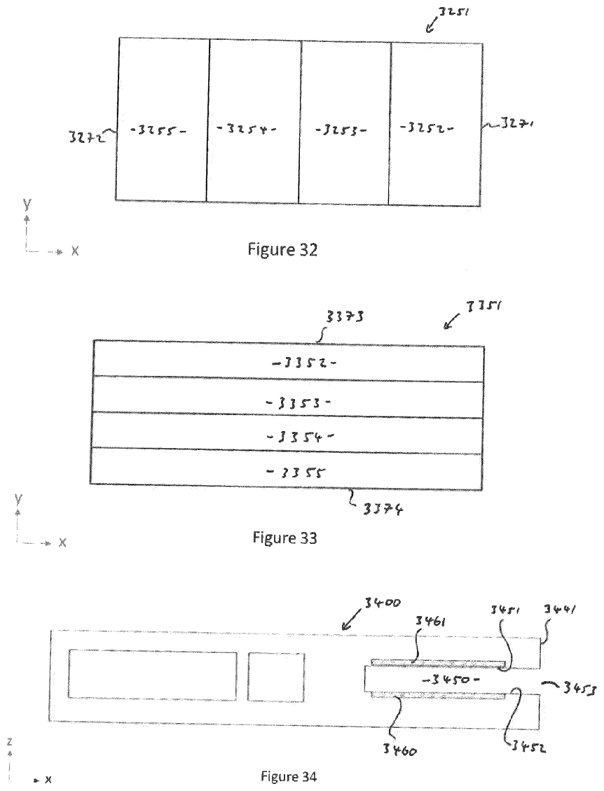

FIG. 32 is a schematic plan view of a planar heater of an aerosol-generating device according to an embodiment of the invention;

FIG. 33 is a schematic plan view of a planar heater of an aerosol-generating device according to an embodiment of the invention;

FIG. 34 illustrates an aerosol-generating device according to an embodiment of the invention;

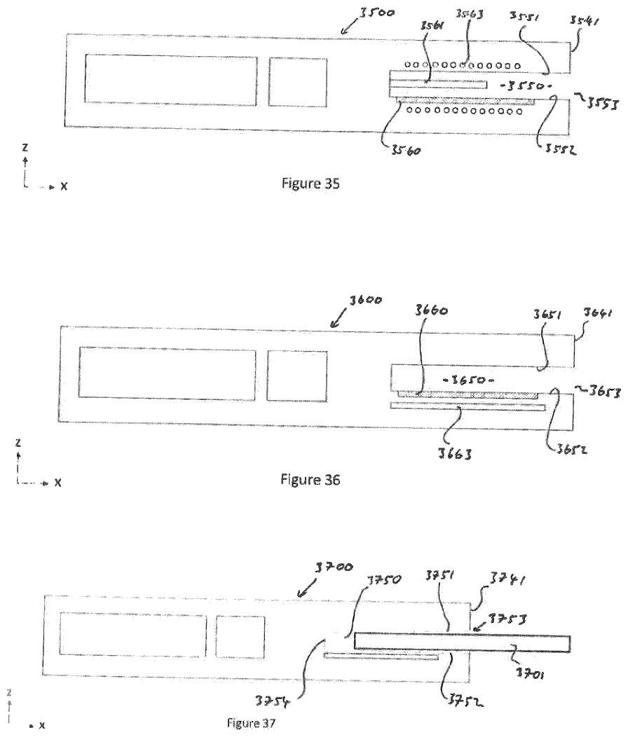

FIG. 35 illustrates an aerosol-generating device according to an embodiment of the invention;

FIG. 36 illustrates an aerosol-generating device according to an embodiment of the invention;

FIG. 37 illustrates an aerosol-generating device according to an embodiment of the invention;

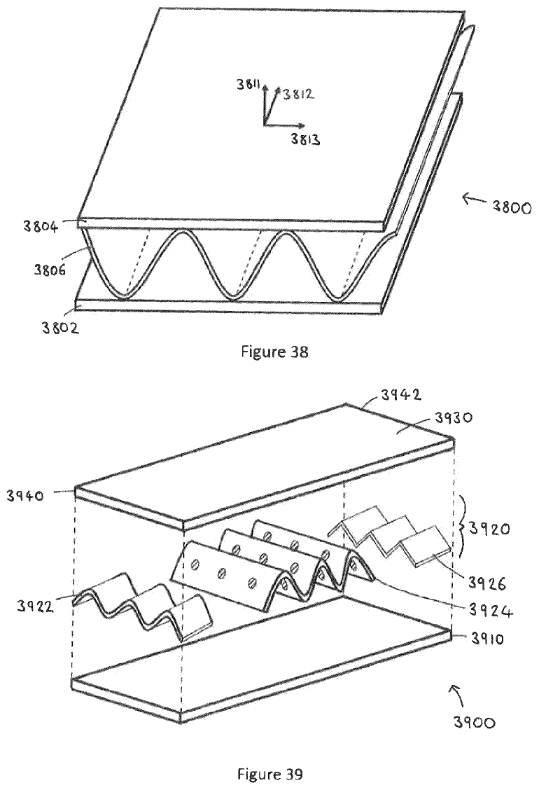

FIG. 38 illustrates an aerosol-generating article according to an embodiment of the invention;

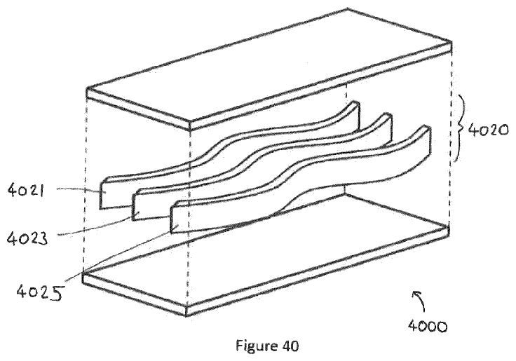

FIG. 39 illustrates an exploded view of an aerosol-generating article according to an embodiment of the invention;

FIG. 40 illustrates an exploded view of an aerosol-generating article according to an embodiment of the invention;

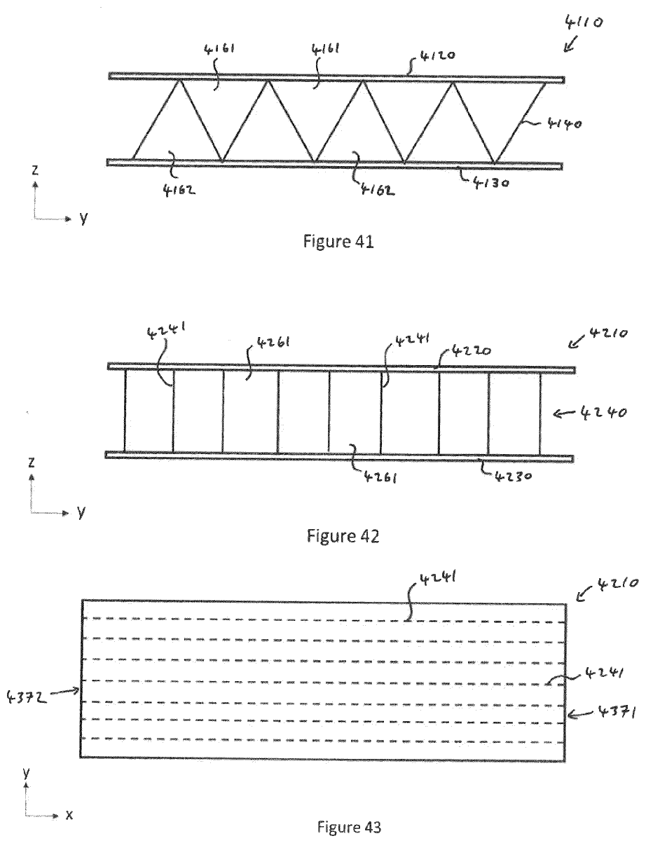

FIG. 41 is a schematic end view of an aerosol-forming substrate according to an embodiment of the invention;

FIG. 42 is a schematic end view of an aerosol-forming substrate according to an FIG. 43 is a schematic plan view of the aerosol-forming substrate of FIG. 42;

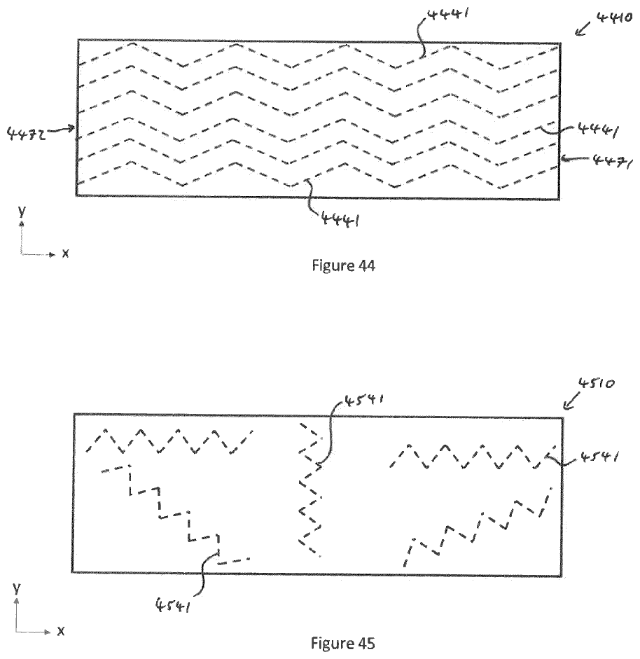

FIG. 44 is a schematic plan view of the aerosol-forming substrate according to an embodiment of the invention;

FIG. 45 is a schematic plan view of the aerosol-forming substrate according to an embodiment of the invention;

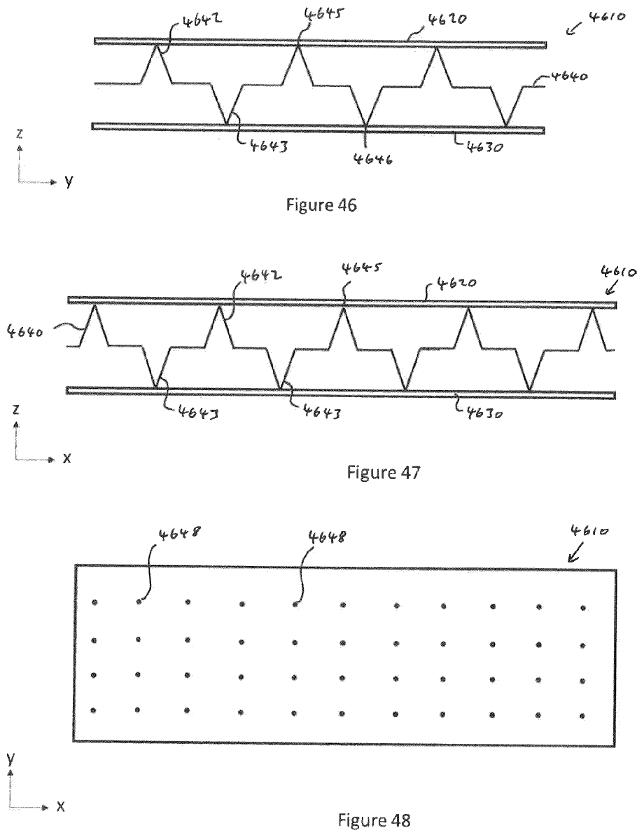

FIG. 46 is a schematic end view of an aerosol-forming substrate according to an embodiment of the invention;

FIG. 47 is a schematic side view of the aerosol-forming substrate of FIG. 46;

FIG. 48 is a schematic plan view of the aerosol-forming substrate of FIG. 46;

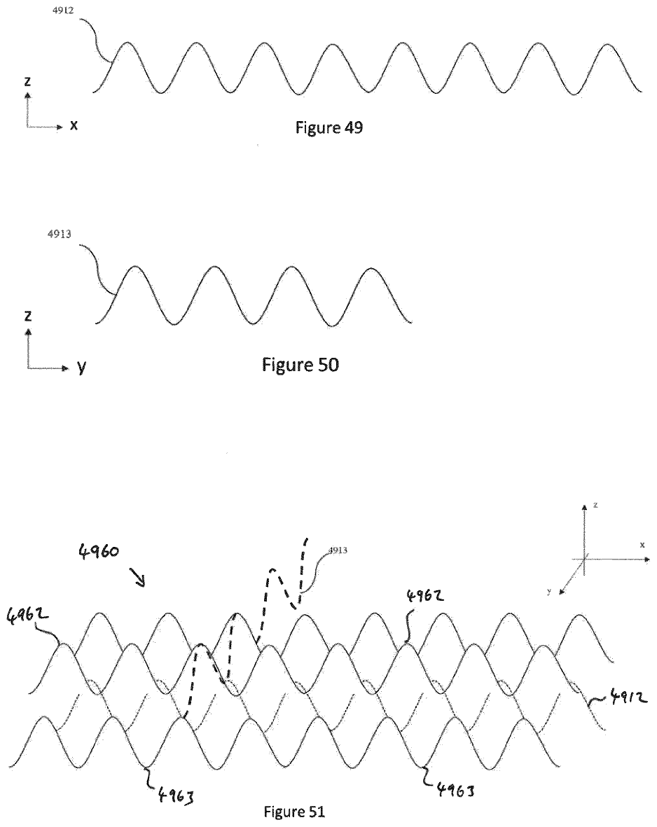

FIG. 49 is a continuous sinusoidal curve extending in the x direction;

FIG. 50 is a continuous sinusoidal curve extending in the y direction;

FIG. 51 is a schematic illustration of an intermediate or separation layer in the form of a surface created by translating perpendicularly the sinusoidal curve of FIG. 49 by the sinusoidal curve of FIG. 50;

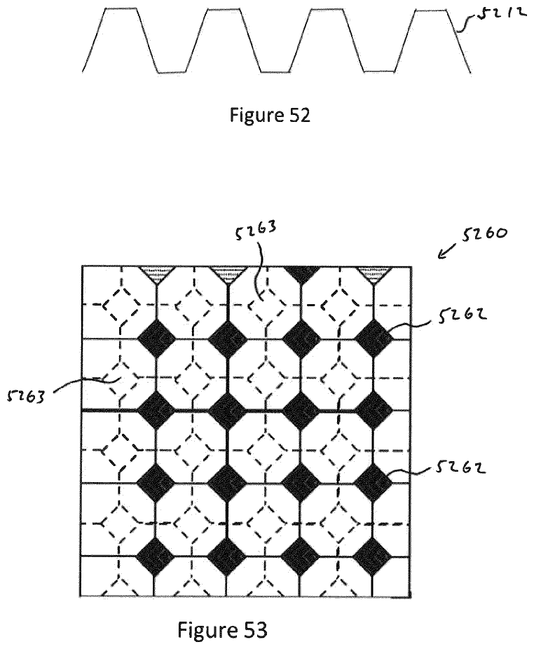

FIG. 52 is a representation of a continuous trapezoidal curve;

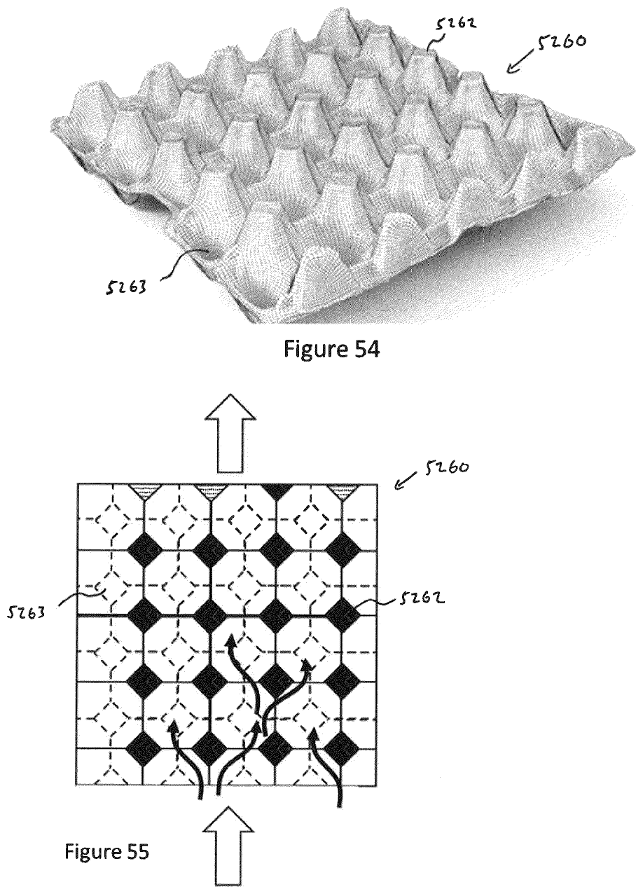

FIG. 53 is a schematic plan view of a surface formed by translating perpendicularly two trapezoidal curves to form a surface having rectangular peaks and troughs;

FIG. 54 is a perspective illustration of a surface formed by translating perpendicularly two trapezoidal curves to form a surface having rectangular peaks and troughs;

FIG. 55 is the schematic plan view of FIG. 53 illustrating potential air flow paths through peaks and troughs of the surface;

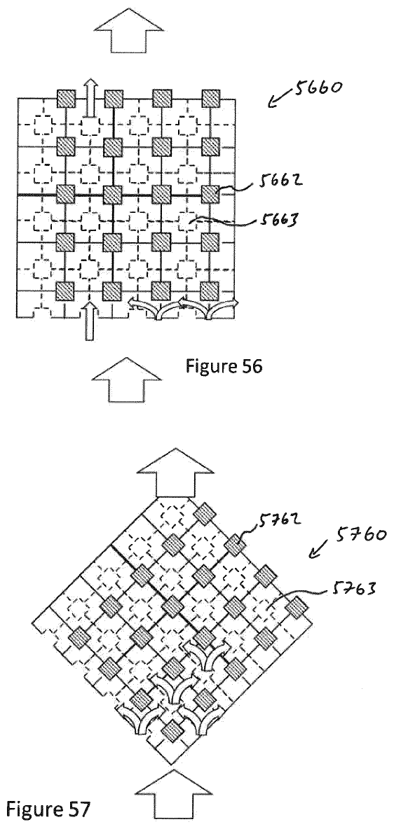

FIG. 56 is a further schematic plan view of a surface formed by translating perpendicularly two trapezoidal curves to form a surface having rectangular peaks and troughs; and

FIG. 57 illustrates a different air flow path formed by rotating the plan view illustrated in FIG. 56.

FIGS. 1, 2, and 3 illustrate respectively an end view, a side view, and a plan view of an aerosol-forming substrate 10 according to an embodiment of the invention. The aerosol-forming substrate 10 comprises a planar upper layer 20, a planar lower layer 30, and an intermediate or separation layer 40 arranged between the upper layer 20 and lower layer 30.

The planar upper layer 20 is formed from a sheet of paper having a thickness of 300 microns. The planar lower layer 30 is formed from a sheet of paper having a thickness of 300 microns. The intermediate layer 40 is a corrugated element formed from a corrugated sheet of aerosol-forming material 45. A suitable aerosol-forming material may be homogenised tobacco. Thus, the intermediate layer 40 may be formed from a corrugated sheet of homogenised tobacco material.

FIG. 4 illustrates the corrugated sheet of aerosol-forming material 45. The corrugations have a peak-to-trough amplitude 46 of 3 mm and a wavelength 47 of 3 mm. The sheet of aerosol-forming material 45 forming the intermediate layer 40 has a thickness of 150 microns.

Points of intersection 51, 52 between the upper layer and the intermediate layer and between the lower layer and the intermediate layer comprise an adhesive that joins the respective layers.

The aerosol-forming substrate has a length, extending in an x dimension, of 80 mm, a width, extending in a y dimension, of 15 mm, and a thickness, extending in a z dimension, of 3.6 mm. Corrugations of the intermediate layer 40 form a first set of longitudinal channels 61 that are bounded by the upper layer 20 and the intermediate layer 40, and a second set of longitudinally extending channels 62 bounded by the lower layer 30 and the intermediate layer 40. The first and second set of longitudinally extending channels 61, 62 extend through the length of the aerosol-forming substrate between a proximal end 71 of the substrate 10 and a distal end 72 of the substrate. The longitudinally extending channels 61, 62 define an air-flow path through the substrate 10. The air-flow path, therefore, passes over both sides of the sheet of aerosol-forming material 45. The porosity of the aerosol-forming substrate along the air-flow path is in the region of 90%. This provides a very low resistance to draw of less than 5 mm H₂O. In fact, RTD is close to zero.

The aerosol-forming material 45 may be a sheet of any suitable aerosol-forming material. For exemplary purposes, a composition of a suitable aerosol-forming material may be as follows. Percentages are given in weight percent with respect to the product in its final state. The aerosol-forming material may have a moisture of about 5 to 25%, preferably of about 7 to 15%, at final product state. The aerosol-forming material may further comprise the following:
1. Tobacco leaf; for example about 15 to 45%, preferably of about 20 to 35% of a blend of tobacco leaf, incorporating at least one of the following tobacco types: bright tobacco; dark tobacco; aromatic tobacco. Tobacco material is ground and graded to a particle size of about 100 to 380 mesh, preferably of about 170 to 320 mesh.
2. Cellulose fibres; for example about 1 to 15%, preferably of about 3 to 7%, of cellulose fibres, of a length of about 10 to 250 μm, preferably of about 10 to 120 μm.
3. Tobacco fibres; for example about 5 to 20%, preferably of about 7 to 15% of tobacco fibres, as filler, of any tobacco type or a blend of tobacco types. Tobacco fibres are preferably derived from stems and/or or stalks, graded to fibres of a length of about 10 to 350 μm, preferably of about 10 to 180 μm.
4. Binder; for example about 1 to 10%, preferably of about 1 to 5%, of a binder such as any of common gums or pectins used in food and beverage (F&B) industries. Preferred binders may be natural pectins, such as fruit, for example citrus, or tobacco pectins; guar gums, land locust bean gums, such as hydroxyethyl and/or hydroxypropyl of those; starches, such as modified or derivatized starches; alginate; methyl, ethyl, ethylhydroxymethyl and carboxymethyl, celluloses; dextran; and xanthan gum. The preferable binder is guar.
5. Aerosol-former; for example about 5 to 35%, preferably of about 10 to 25%, of an aerosol former. Suitable aerosol-formers known in the art include: glycerine; monohydric alcohols like menthol, polyhydric alcohols, such as triethylene glycol; esters of polyhydric alcohols, such as glycerol mono-, di-or triacetate; and aliphatic esters of mono-, di- or polycarboxylic acids, such as dimethyls of those.

“Tobacco type” means one of the different varieties of tobacco, for example based on the distinct curing process that the tobacco undergoes before it is further processed in a tobacco product.

To form the aerosol-forming material 45, the various components may be mixed together and cast into a sheet having the desired thickness, for example 150 microns. The sheet may then be dried to be suitable for processing to form the aerosol-forming substrate 10.

For exemplary purposes, a composition of a further aerosol-forming material, which may be suitable as the sheet of aerosol-forming material 45 in the specific embodiment described above, may be as follows. Percentages are given in weight percent with respect to the product in its final state. The aerosol-forming material may comprise:
1. An aerosol-former such as Glycerin; for example about 10 to 40%, preferably of about 20 to 30%.
2. Organic fibres; for example about 10 to 30%, preferably of about 15 to 25%, of any botanical variety suitable and with purity to comply with applicable FDA F&B grade requirements, as commonly available in the market. For example, organic fibres may derive from cellulose, cotton, wood, tea botanical varieties as sub-products, and sub-processed waste, of F&B tea industry. Organic fibres are preferably of a length of about 10 to 400 μm, preferably of about 10 to 200 μm.
3. Organic botanical glycerite; for example about 15 to 55%, preferably of about 20 to 35%, of botanicals such as Clove, Echinacea sp., Fennel, Ginger, Hawthorn berry, Elderberry, Monarda, Mullein leaves, Nettle, Plantain, Turmeric, Yarrow, and compounds of those.
4. Organic botanical extracts; for example about 1 to 15%, preferably of about 2 to 7%, of any of the previously referred botanicals, as well as menthol (dl-Menthol, C10H20O, 2-Isopropyl-5-methylcyclohexanol) such as obtained from Chaerophyllum macrospermum, Mesosphaerum sidifolium, or other related botanic varieties, as well as P-menthan-3-ol, as any secondary alcohol as diastereoisomers of 5-methyl-2-(propan-2-yl)cyclohexan-1-ol.

Alternatively, such aerosol-forming material may also contain botanical essential oils of about 0.5 to 5%, preferably of about 1 to 3%, such as of palm, coconut, and wooden-based essential oils.

FIG. 5 illustrates an apparatus 500 that may be used for the manufacture of the aerosol-forming substrate 10. Continuous sheets are provided of the three main components of the aerosol-forming substrate, those being a continuous sheet of paper for forming the lower surface 30, a continuous sheet of paper for forming the upper surface 20, and a continuous sheet of aerosol-forming material 45 for forming the corrugated intermediate layer 40.

The following steps may occur in the manufacture of the aerosol-forming substrate:

The continuous sheet of aerosol-forming material 45 is conveyed under tension to a pair of corrugation rollers or fluting rollers 511, 512. The corrugation rollers 511, 512 texture the sheet of aerosol-forming material 45 to introduce corrugations of the desired wavelength and amplitude. Adhesive 80 is applied to peaks of the corrugations by a first adhesive applicator 580. The corrugated sheet is then brought into contact with the continuous paper sheet forming the lower layer 30. The lower layer 30 is affixed to the corrugated sheet 45 and the combined layers pass to a conveyor belt.

Further adhesive is now applied to the corrugated layer by a second adhesive applicator 581 and the continuous sheet forming the upper layer 20 is introduced and adhered to the corrugated structure. The structure formed is now a sandwich of the corrugated aerosol-forming material 45 between the upper layer 20 and the lower layer 30. The structure is sliced both laterally and transversely by slicing means 590 to form individual aerosol-forming substrates 10.

The aerosol-forming substrate may be used as an aerosol-generating article on its own, or may be used as a component part of an aerosol-generating article, for example as described further below.

FIGS. 6 and 7 illustrate an aerosol-generating device 600 configured for use with an aerosol-generating article comprising or consisting of the aerosol-forming substrate 10. The device 600 is an elongate aerosol-generating device extending between a proximal end 641 and a distal end 642. The device 600 comprises a battery 620, a controller 630 and a heater 600 located within a housing 610. The controller 630 controls supply of power from the battery 620 to the heater 660. A cavity 650 is defined in the device 600, the cavity 650 having an opening 653 defined in the proximal end 641 of the device. The opening 653 is rectangular in shape and is dimensioned to accommodate the transverse cross-section of the aerosol-forming substrate 10. The cavity comprises an upper planar surface 651 and a lower planar surface 652. The heater 660 is located in the lower planar surface 652 to heat a lower surface of an aerosol-forming substrate or article inserted into the cavity 650. An air-flow path is configured to allow air to flow into the cavity 650 from outside the device.

FIG. 8 illustrates the device 600 of FIG. 6 in engagement with the aerosol-forming substrate 10 of FIG. 1. There is little tolerance between outer surfaces of the aerosol-forming substrate and the internal surfaces of the cavity 650. Thus, there is a snug fit between the substrate 10 and the device 600. As the RTD of the substrate is negligible, the RTD of the system is controlled by the air-flow path defined within the device. When a user has inserted the substrate 10 into the cavity 650, the device can be operated. The heater 660 heats a lower surface of the substrate 10, and as a result the aerosol-forming material 45 is heated. Volatile components of the aerosol-forming substrate are evaporated and condense in the air-flow channels 61, 62 to form an aerosol. The user inhales the aerosol by drawing on the proximal end 71 of the aerosol-forming substrate 10. Once the aerosol-forming material 45 has been depleted of volatile components, the substrate is removed from the cavity and disposed of.

FIG. 9 illustrates an end view of an aerosol-generating article 901 comprising the aerosol-forming substrate 10 of FIG. 1 wrapped with a cigarette paper 965. A perspective view of the article 901 is illustrated in FIG. 10, which shows the substrate 10, the cigarette paper wrapping 965, and a further section of tipping paper 967 wrapped around the article at a proximal end 971 of the article. The proximal end 967 may also be termed a mouth end and it is intended that a user draws on the mouth end during use of the article.

FIG. 11 illustrates a perspective view of a further configuration of an aerosol-generating article 1101. The article 1101 is similar to the article 901 described above and comprises the same aerosol-forming substrate 10. The article 1101 of FIG. 11 has cigarette paper 1165 covering top and bottom planar surfaces of the substrate 10, without covering the sides. Further, a covering of tipping paper 1167 is applied to upper and lower surfaces adjacent to the proximal end 1171 of the article 1101.

FIG. 12 illustrates a perspective view of a further configuration of an aerosol-generating article 1201. The article 1201 is similar to the article 901 described above and comprises the same aerosol-forming substrate 10. The article 1201 of FIG. 12 has cigarette paper 1265 covering top and bottom planar surfaces of the substrate 10, and one side surface of the substrate. Further, a half covering of tipping paper 1267 is applied adjacent to the proximal end 1271 of the article 1201.

FIG. 13 illustrates a perspective view of a further configuration of an aerosol-generating article 1301. The article 1301 is similar to the article 901 described above and comprises the same aerosol-forming substrate 10. The article 1301 of FIG. 13 has cigarette paper 1365 covering top and bottom planar surfaces of the substrate 10, without covering the sides. Further, a covering of tipping paper 1367 is applied to upper and lower surfaces adjacent to the proximal end 1371 of the article 1301. The article 1301 is wrapped such that corners of the article are rounded rather than square. This may provide a more pleasant mouth feel for a user.

FIG. 14 illustrates an end view of an aerosol-forming substrate 1410 according to an embodiment of the invention. The aerosol-forming substrate 1410 comprises a planar upper layer 1420, a planar lower layer 1430, and an intermediate or separation layer 1440 arranged between the upper layer 1420 and lower layer 1430. The intermediate layer is formed from a corrugated sheet of material 1445. The aerosol-forming substrate 1410 of FIG. 14 is similar to the aerosol-forming substrate 10 described in relation to FIG. 1 above, with the difference that the planar upper layer 1420 and the planar lower layer 1430 are formed from sheets of aerosol-forming material, for example homogenised tobacco, and the corrugated sheet of material 1445 does not comprise an aerosol-forming material and is present for structural purposes only.

FIG. 15 illustrates an end view of an aerosol-forming substrate 1510 according to an embodiment of the invention. The aerosol-forming substrate 1510 comprises a planar upper layer 1520, a planar lower layer 1530, and an intermediate or separation layer 1540 arranged between the upper layer 1520 and lower layer 1530. The intermediate layer is formed from a corrugated sheet of material 1545. The aerosol-forming substrate 1510 of FIG. 15 is similar to the aerosol-forming substrate 10 described in relation to FIG. 1 above, with the difference that the planar lower layer 1530 and the corrugated sheet of material 1545 are formed from sheets of aerosol-forming material, for example homogenised tobacco, and the planar upper layer 1520 does not comprise an aerosol-forming material.

FIG. 16 illustrates an end view of an aerosol-forming substrate 1610 according to an embodiment of the invention. The aerosol-forming substrate 1610 comprises a planar upper layer 1620, a planar lower layer 1630, and an intermediate or separation layer 1640 arranged between the upper layer 1620 and lower layer 1630. The intermediate layer is formed from a corrugated sheet of material 1645. The aerosol-forming substrate 1610 of FIG. 16 is similar to the aerosol-forming substrate 10 described in relation to FIG. 1 above, with the difference that all of the planar upper layer 1620, the planar lower layer 1630, and the corrugated sheet of material 1645 are formed from sheets of aerosol-forming material, for example homogenised tobacco.

FIG. 17 illustrates an end view of an aerosol-forming substrate 1710 according to an embodiment of the invention. The aerosol-forming substrate 1710 comprises a planar lower layer 1430 and a corrugated upper layer 1745. The substrate of FIG. 17 is similar to the substrate of FIG. 1, but without the presence of the planar upper layer. Either or both of the lower layer 1730 and the corrugated upper layer 1745 may be aerosol-forming materials. FIG. 18 illustrates an end view of an aerosol-generating article 1801 comprising the aerosol-forming substrate 1710 of FIG. 17 wrapped with a cigarette paper 1865.

FIG. 19 illustrates an end view of an aerosol-forming substrate 1910 according to an embodiment of the invention. The aerosol-forming substrate 1910 comprises a planar upper layer 1920, a planar lower layer 1930, and an intermediate or separation layer 1940 arranged between the upper layer 1920 and lower layer 1930. The intermediate layer is formed from a corrugated sheet of material 1945. The aerosol-forming substrate 1910 of FIG. 19 is similar to the aerosol-forming substrate 10 described in relation to FIG. 1 above, with the further addition of a top layer 1921, disposed above the upper layer 1920, and a bottom layer 1931 disposed below the lower layer 1930. Either or both of the top layer 1921 and bottom layer 1931 may be formed from a sheet of material. For example, the sheet of material may be a thermally conducting material, such as aluminium foil, or a paper material, or a polymeric material, or a porous material, for example tea-bag material.

FIG. 20 illustrates a side view of an aerosol-forming substrate 2010 according to an embodiment of the invention. The aerosol-forming substrate 2010 comprises a planar upper layer 2020, a planar lower layer 2030, and an intermediate or separation layer 2040 arranged between the upper layer 2020 and lower layer 2030. The aerosol-forming substrate 2010 of FIG. 20 is similar to the aerosol-forming substrate 10 described in relation to FIG. 1 above, with the with the further addition of a top layer 2021, disposed towards a distal end 2072 of the upper layer 2020, and a bottom layer 2031 disposed towards the distal end 2072 of the lower layer 2030. The distal portion 2072 may be a portion of the substrate 2010 that is inserted into an aerosol-generating device. Either or both of the top layer 2021 and bottom layer 2031 may be formed from a sheet or patch of material. For example, the sheet of material may be a thermally conducting material, such as aluminium foil, or a paper material, or a polymeric material, or a porous material, for example tea-bag material.

FIG. 21 illustrates an end view of an aerosol-forming substrate 2110 according to an embodiment of the invention. The aerosol-forming substrate 2110 comprises a planar upper layer 2120, a planar lower layer 2130, and an intermediate or separation layer 2140 arranged between the upper layer 2120 and lower layer 2130. The intermediate layer is formed from a corrugated sheet of material 2145. The aerosol-forming substrate 2110 of FIG. 21 is similar to the aerosol-forming substrate 10 described in relation to FIG. 1 above, with the further inclusion of one or more functional elements 2191, 2192, 2193 located within longitudinally extending channels 2161, 2162 defined by the corrugated sheet 2145. The one or more functional elements may be longitudinal elements, for example a flavour thread 2191, that is a thread or strip of material impregnated with a flavourant, or a longitudinal susceptor element 2193, for example a strip of stainless steel or aluminium foil. The one or more functional element may be a discrete element such as a flavour capsule 2192, for example a frangible capsule containing an aerosol-forming material or a flavourant that may be broken by a user before consumption of the substrate.

FIG. 22 illustrates an end view of an aerosol-forming substrate 2210 according to an embodiment of the invention. The aerosol-forming substrate 2210 comprises a planar upper layer 2220, a planar lower layer 2230, and an intermediate or separation layer 2240 arranged between the upper layer 2220 and lower layer 230. The intermediate layer is formed from an upper corrugated sheet of material 2246, and a lower corrugated sheet of material 2247 separated by an intermediate planar layer 2248. Any one or more of the upper layer 2220, lower layer 2230, upper corrugated sheet 2246, lower corrugated sheet 2247, and intermediate planar sheet 2248 may be formed from aerosol-forming material. FIG. 23 illustrates an end view of an aerosol-generating article 2301 comprising the aerosol-forming substrate 2210 of FIG. 22 wrapped with a cigarette paper 2365.

FIG. 24 illustrates an end view of an aerosol-generating article 2401 comprising two aerosol-forming substrates 10 as described in relation to FIG. 1, wrapped with a cigarette paper 2365. The aerosol-forming substrates 10 are arranged laterally within the cigarette paper 2465. The substrates may have different compositions, thereby allowing for different flavour combinations to be readily produced.

FIG. 25 illustrates a plan section of an aerosol-generating article 2501 comprising an aerosol-forming substrate 2510 and a structural component 2511 having approximately the same cross-sectional dimensions as the aerosol-forming substrate 2510, assembled within a wrapper 2565. The aerosol-forming substrate 2510 is located towards a distal end 2572 of the article and the structural component 2511 is located towards a proximal end 2571 of the article. An air-flow path extends through the article 2501 between the distal end 2572 and the proximal end 2571. The aerosol-forming substrate is a substrate as described herein, for example the substrate described in relation to FIG. 1. The structural component 2511 may be a further aerosol-generating substrate, for example a substrate as described herein. The structural component may not comprise aerosol-forming material. The structural component may be a tube, for example a rectangular section tube. The structural component may be a corrugated cardboard component. FIG. 26 illustrates an end view of an aerosol-forming substrate 2610 according to an embodiment of the invention. The aerosol-forming substrate 2610 comprises a planar upper layer 2620, a planar lower layer 2630, and an intermediate or separation layer 2640 arranged between the upper layer 2620 and lower layer 2630. The intermediate layer is formed from a corrugated sheet of material 2645. The aerosol-forming substrate 2610 of FIG. 26 is similar to the aerosol-forming substrate 10 described in relation to FIG. 1 above, with the further inclusion of porous material 2681 located within longitudinally extending channels 2661, 2662 defined by the corrugated sheet 2645. The porous material 2681 may control RTD of the substrate. The porous material 2681 may comprise aerosol-forming material, for example may be soaked with a liquid aerosol-forming material.

FIG. 27 illustrates an end view of an aerosol-forming substrate 2710 according to an embodiment of the invention. The aerosol-forming substrate 2710 comprises a planar upper layer 2720, a planar lower layer 2730, and an intermediate or separation layer 2740 arranged between the upper layer 2720 and lower layer 2730. The intermediate layer is formed from a corrugated sheet of material 2745. The aerosol-forming substrate 2710 of FIG. 27 is similar to the aerosol-forming substrate 10 described in relation to FIG. 1 above, with the further inclusion of a mesh 2785 spanning a proximal end 2771 of the substrate 2710. The mesh may help prevent particles of the substrate from being inhaled by a user.

FIG. 28 illustrates a plan section of an aerosol-generating article 2801 comprising an aerosol-forming substrate 2810, a structural component 2811 having approximately the same cross-sectional dimensions as the aerosol-forming substrate 2810, and a mouthpiece filter 2812, all aligned coaxially and assembled within a wrapper 2865. The aerosol-forming substrate 2810 is located towards a distal end 2872 of the article, the structural component 2811 is located proximally relative to the aerosol-forming substrate, and the mouthpiece filter 2812 is located at a proximal end 2871 of the article. An air-flow path extends through the article 2801 between the distal end 2872 and the proximal end 2871. The aerosol-forming substrate is a substrate as described herein, for example the substrate described in relation to FIG. 1. The structural component 2811 may be a further aerosol-generating substrate, for example a substrate as described herein. The structural component may not comprise aerosol-forming material. The structural component may be a tube, for example a rectangular section tube. The structural component may be a corrugated cardboard component. The mouthpiece filter 2812 may be formed from cellulose acetate tow.

FIG. 29 illustrates a plan view of an aerosol-generating article 2901 comprising an aerosol-forming substrate (not visible) contained within a cigarette paper wrapper 2965. The wrapper 2965 comprises air inlet holes 2995 to allow air to pass into the article 2910 through the wrapper 2965. In preferred embodiments, the air inlet holes may be aligned in a central position on one or both of the top and bottom of the article. The article may comprise two aerosol-forming substrates, one located towards a distal end 2972 of the article and one located towards a proximal end 2971 of the article. The article may be a dual use article, designed such that both aerosol-forming substrates are consumed independently. For example, the distal end may be inserted into an aerosol-generating device and the distally located aerosol-forming substrate consumed, the user drawing on the proximal end of the article. Then the article may be reversed such that the proximal end is inserted into the aerosol-generating device and the proximally located aerosol-forming substrate consumed, the user drawing on the distal end of the article. In both cases the air inlet holes may allow air-flow into the article during consumption.

FIG. 30 illustrates a side view of an aerosol-forming substrate 3010 according to an embodiment of the invention. The aerosol-forming substrate 3010 comprises a planar upper layer 3020, a planar lower layer 3030, and an intermediate or separation layer 3040 arranged between the upper layer 3020 and lower layer 3030. The intermediate layer is formed from a corrugated sheet of material 3045. The corrugated sheet of material 3045 is a highly perforated sheet of material or a mesh, thereby allowing airflow through the substrate in a direction perpendicular to the direction of the corrugations (airflow indicated by arrows in FIG. 30).

FIG. 31 is a schematic plan view of a planar heater 3151 suitable for use in an aerosol-generating device according to an embodiment of the invention, for example the aerosol-generating device 600 described in relation to FIG. 6. The planar heater 3151 may form a lower surface of a cavity of an aerosol-generating device, and is configured to heat an aerosol-forming substrate as described herein. In the specific example of FIG. 31, the planar heater 3151 comprises a first heating zone 3152 located at a proximal end 3171 of the heater and a second heating zone 3153 located at a distal end 3172 of the heater. The first heating zone 3152 and the second heating zone 3153 may be formed from separate resistance heater tracks. Alternatively, the heater may be an inductive heater and the first heating zone and the second heating zone may be effected by separate induction coils acting on susceptor material in the first or second zones. The first and second heating zones may be operated independently or together and may allow for sequential heating of portions of an aerosol-forming substrate.

FIG. 32 is a schematic plan view of a planar heater 3251 suitable for use in an aerosol-generating device according to an embodiment of the invention, for example the aerosol-generating device 600 described in relation to FIG. 6. The planar heater 3251 may form a lower surface of a cavity of an aerosol-generating device, and is configured to heat an aerosol-forming substrate as described herein. In the specific example of FIG. 32, the planar heater 3251 comprises a first heating zone 3252, a second heating zone 3253, a third heating zone 3254, and a fourth heating zone 3255 spaced successively between a proximal end 3271 of the heater and a distal end 3272 of the heater. The different heating zones may be formed from separate resistance heater tracks. Alternatively, the heater may be an inductive heater and the heating zones may be effected by separate induction coils acting on susceptor material in the first or second zones. The heating zones may be operated independently or together and may allow for sequential heating of portions of an aerosol-forming substrate.

FIG. 33 is a schematic plan view of a planar heater 3351 suitable for use in an aerosol-generating device according to an embodiment of the invention, for example the aerosol-generating device 600 described in relation to FIG. 6. The planar heater 3351 may form a lower surface of a cavity of an aerosol-generating device, and is configured to heat an aerosol-forming substrate as described herein. In the specific example of FIG. 33, the planar heater 3351 comprises a first heating zone 3352, a second heating zone 3353, a third heating zone 3354, and a fourth heating zone 3355 spaced successively between a first lateral edge 3373 of the heater and a second lateral edge 3374 of the heater. The different heating zones may be formed from separate resistance heater tracks. Alternatively, the heater may be an inductive heater and the heating zones may be effected by separate induction coils acting on susceptor material in the first or second zones. The heating zones may be operated independently or together and may allow for sequential heating of portions of an aerosol-forming substrate.

FIG. 34 illustrates an aerosol-generating device 3400 configured for use with an aerosol-generating article comprising or consisting of an aerosol-forming substrate as described herein. The device 3400 is similar to the device 600 described above in relation to FIG. 6. A cavity 3450 is defined in the device 3400, the cavity 3450 having an opening 3453 defined in a proximal end 3441 of the device. The opening 3453 is dimensioned to accommodate the transverse cross-section of an aerosol-forming substrate. The cavity comprises an upper planar surface 3451 and a lower planar surface 3452. Heaters 3460 and 3461 are located in both the lower planar surface 3452 and the upper planar surface, to heat both upper and lower surfaces of an aerosol-forming substrate or article inserted into the cavity 3450.

FIG. 35 illustrates an aerosol-generating device 3500 configured for use with an aerosol-generating article comprising or consisting of an aerosol-forming substrate as described herein. The device 3500 is similar to the device 600 described above in relation to FIG. 6. A cavity 3550 is defined in the device 3500, the cavity 3550 having an opening 3553 defined in a proximal end 3541 of the device. The opening 3553 is dimensioned to accommodate the transverse cross-section of an aerosol-forming substrate. The cavity comprises an upper planar surface 3551 and a lower planar surface 3552. Susceptors 3560 and 3561 are located in both the lower planar surface 3552, and projecting into the cavity. The projecting susceptor 3561 is in the form of a pin or rod configured to penetrate a portion of an aerosol-generating article and heat the article from within. An induction coil 3463 encircles the cavity and is configured to generate a fluctuating magnetic field to heat the susceptors 3560 and 3561.

FIG. 36 illustrates an aerosol-generating device 3600 configured for use with an aerosol-generating article comprising or consisting of an aerosol-forming substrate as described herein. The device 3600 is similar to the device 600 described above in relation to FIG. 6. A cavity 3650 is defined in the device 3600, the cavity 3650 having an opening 3653 defined in a proximal end 3641 of the device. The opening 3653 is dimensioned to accommodate the transverse cross-section of an aerosol-forming substrate. The cavity comprises an upper planar surface 3651 and a lower planar surface 3652. A susceptors 3660 is located in the lower planar surface 3652. A planar induction coil 3663 is located beneath the cavity and is configured to generate a fluctuating magnetic field to heat the susceptor 3660.

FIG. 37 illustrates an aerosol-generating device 3700 configured for use with an aerosol-generating article 3701 comprising or consisting of an aerosol-forming substrate as described herein. The device 3700 is similar to the device 600 described above in relation to FIG. 6. A cavity 3750 is defined in the device 3700, the cavity 3750 having an opening 3753 defined in a proximal end 3741 of the device. The opening 3753 is dimensioned to accommodate the transverse cross-section of an aerosol-forming substrate. The cavity comprises an upper planar surface 3751 and a lower planar surface 3752. The upper planar surface 3751 and the lower planar surface 3752 are not parallel and converge slightly between the opening and a distal end 3754 of the cavity. This convergence allows the planar surfaces of the cavity to grip the aerosol-generating article 3701 when inserted into the cavity for consumption.

FIG. 38 illustrates an aerosol-forming substrate 3800 comprising a first planar layer 3802, a second planar layer 3804, and a corrugated layer consisting of a standard corrugated element 3806 between the first planar layer 3802 and the a second planar layer 3804. FIG. 38 also illustrates the thickness direction 3811, the cross direction 3812, and the machine direction 3813 of the standard corrugated element 3806.

FIG. 39 is an exploded view of an aerosol-generating article 3900. The article 3900 comprises a first planar layer 3910, a corrugated layer 3920, and a second planar layer 3930. The corrugated layer 3920 is arranged between the first planar layer 3910 and the second planar layer 3930. The corrugated layer 3920 comprises a first corrugated element 3922, a second corrugated element 3924, a third corrugated element 3926.

The article 3900 comprises an upstream end 3940 and a downstream end 3942. The first planar layer 3910, the corrugated layer 3920, and the second planar layer 3930 all extend from the upstream end 3940 to the downstream end 3942. The article 3900 also has an article length 3944, and defines an article air flow path, extending from the upstream end 3940 to the downstream end 3942. The downstream end 3942 may also be termed a mouth end and it is intended that a user draws on the mouth end during use of the article 3900.

The first planar layer 3910 is formed from a sheet of paper having a thickness of 300 microns. The second planar layer 3930 is formed from a sheet of paper having a thickness of 300 microns. The first corrugated element 3922, second corrugated element 3924, and third corrugated element 3926 are each formed from a sheet of aerosol-forming material such as homogenised tobacco. The three sheets of aerosol-forming material each have a thickness of 150 microns. The three sheets are bent or folded to form the corrugations of the corrugated elements 3922, 3924, 3926. The corrugations have a wavelength of 3 millimetres and an amplitude of 1.5 millimetres. The corrugations of the first and second corrugated elements 3922, 3924 are sinusoidal, and the corrugations of the third corrugated element 3926 have a symmetrical, triangular (or zig-zag) waveform. Thus, the peak-to-trough amplitude, and corrugated layer thickness, is 3 millimetres-twice the amplitude.

Peaks of each of the corrugated elements 3922, 3924, 3926 contact a lower surface of the second planar layer 3230. Troughs of each of the corrugated elements 3922, 3924, 3926 contact an upper surface of the first planar layer 3210. An adhesive is present at these points of contact to join the respective layers.

The article 3900 has an article length, extending in an x dimension, of 80 mm, an article width, extending in a y dimension, of 15 mm, and an article thickness, extending in a z dimension, of 3.6 mm.

The upstream end of the first corrugated element 3922 aligns with the upstream ends of the first and second planar layers 3910, 3930 and the upstream end of the article 3900. The first corrugated element 3922 extends about 10 millimetres in the x direction from its upstream end to its downstream end. There is then a 5 millimetre space in the x direction between the downstream end of the first corrugated element 3922 and the upstream end of the second corrugated element 3924. The second corrugated element 3924 then extends around 50 millimetres in the x direction from its upstream end to its downstream end. There is then a 5 millimetre space in the x direction between the downstream end of the second corrugated element 3924 and the upstream end of the third corrugated element 3926. The third corrugated element 3926 then extends around 10 millimetres in the x direction from its upstream end to its downstream end. The downstream end of the third corrugated element 3926 aligns with the downstream ends of the first and second planar layers 3910, 3930 and the downstream end of the article 3900.

As such, the three corrugated elements 3922, 3924, 3926 together extend along 70 millimetres of the 80 millimetre article length, or around 87.5% of the article length. And the only sheet of aerosol-forming material in this embodiment, which forms the second corrugated element 3924, extends along 50 millimetres of the 80 millimetre article length, or around 62.5% of the article length. In other embodiments, there could be no spaces between the three corrugated elements 3922, 3924, 3926 such that the corrugated elements together extend along all of the article length. In other embodiments, one or both of the first and second planar layers 3910, 3930 could be formed from sheets of aerosol-forming material such that the sheets of aerosol-forming material of the article together extend along all of the article length.

The cross direction of the first and third corrugated elements 3922, 3926 is parallel to the x direction, the article length, and the article air flow path direction. In use, air thus flows through the channels defined by the corrugations of the first and third corrugated elements 3922, 3926, in the cross direction of the first and third corrugated elements 3922, 3926.

The cross direction of the second corrugated element 3924 is parallel to the y direction, so is perpendicular to the x direction, the article length and the article air flow path direction. In use, air thus flows through holes in the second corrugated element 3924, and across channels defined by the corrugations of the second corrugated element 3924, in the machine, or wavelength, direction of the second corrugated element 3924.

The article 3900 may be used with an aerosol-generating device, like one of the devices described earlier, to generate an inhalable aerosol. For example, the article 3900 could replace the substrate 10 shown in FIG. 8. The article 3900 could effectively replace the aerosol-forming substrate 10 of any of FIGS. 10-13.

FIG. 40 is an exploded view of an aerosol-generating article 4000 identical to the article 3900 of FIG. 39, except that the corrugated layer 3920 has been replaced by a different corrugated layer 4020.

The corrugated layer 4020 comprises three corrugated elements 4021, 4023, 4025. The three corrugated elements 4021, 4023, 4025 extend from the upstream end to the downstream end of the article 4000 and are each formed from a sheet of aerosol-forming material, such as homogenised tobacco material combined with glycerine, having a sheet thickness of 150 microns. Thus, in this embodiment, corrugated elements and sheets of aerosol-forming material extend along the entire article length.

The cross direction of each of the three corrugated elements 4021, 4023, 4025 is parallel to the z direction, so is perpendicular to the x direction, the article length and the article air flow path direction. In use, air flows through passages defined between adjacent corrugated elements, in the machine, or wavelength, direction of the corrugated elements 4021, 4023, 4025.

FIG. 41 illustrates an end view of an aerosol-forming substrate 4110 according to an embodiment of the invention. The aerosol-forming substrate 4110 comprises a planar upper layer 4120, a planar lower layer 4130, and an intermediate or separation layer 4140 arranged between the upper layer 4120 and lower layer 4130.

The planar upper layer 4120 and the planar lower layer 4130 are both formed from a sheet of aerosol-forming material (for example a sheet of homogenised tobacco) having a thickness of about 200 microns. The aerosol-forming material may be any suitable aerosol-forming material, for example any aerosol-forming material as described above. The intermediate layer 4140 is a corrugated element formed from a corrugated sheet of non-aerosol-forming material. A suitable non-aerosol-forming material may be paper, or card, or a polymeric sheet. Thus, the intermediate layer 4140 may be formed from a corrugated sheet of paper. Points of intersection between the upper layer and the intermediate layer and between the lower layer and the intermediate layer comprise an adhesive that joins the respective layers.

The corrugations have a peak-to-trough amplitude of 3 mm and a wavelength of 3 mm. The sheet forming the intermediate layer 4140 has a thickness of about 300 microns. The corrugations forming the intermediate layer are triangular in shape. The triangular shape of the corrugations is provided by use of a stiff intermediate layer material (i.e. the sheet of paper) and by scoring the paper during corrugation formation. The resulting triangular corrugation provides a stiffer substrate than a sinusoidal profile corrugation and allows for a smaller contact area between the intermediate layer and the upper layer and the lower layer. When the upper layer and the lower layer are heated, this low contact area means that heat loss from the upper or lower layer to the intermediate layer is minimised. This reduces the effect of cold spots in the upper and lower layers, which may cause reduced efficiency of aerosol-generation. This is particularly advantageous when the aerosol-forming substrate 4110 is heated by a heater arranged externally to the upper and lower surfaces (for example one or more planar heater arranged above the upper surface and/or below the lower surface).

The aerosol-forming substrate 4110 has a length, extending in an x dimension, of 80 mm, a width, extending in a y dimension, of 15 mm, and a thickness, extending in a z dimension, of 3.6 mm.

The triangular corrugations of the intermediate layer 4140 form a first set of longitudinally extending channels 4161 that are bounded by the upper layer 4120 and the intermediate layer 4140, and a second set of longitudinally extending channels 4162 bounded by the lower layer 4130 and the intermediate layer 4140. The first and second set of longitudinally extending channels 4161, 4162 extend through the length dimension of the aerosol-forming substrate. The longitudinally extending channels 4161, 4162 define an air-flow path through the substrate 4110. The porosity of the aerosol-forming substrate along the air-flow path is in the region of 90%. This provides a very low resistance to draw of less than 5 mm H₂O.

FIG. 42 illustrates an end view of an aerosol-forming substrate 4210 according to an embodiment of the invention. The aerosol-forming substrate 4210 comprises a planar upper layer 4220, a planar lower layer 4230, and an intermediate or separation layer 4240 arranged between the upper layer 4220 and lower layer 4230.

The planar upper layer 4220 and the planar lower layer 4230 are both formed from a sheet of aerosol-forming material (for example a sheet of homogenised tobacco) having a thickness of about 200 microns. The aerosol-forming material may be any suitable aerosol-forming material, for example any aerosol-forming material as described above. The intermediate layer 4240 comprises a plurality of ribs 4241 of non-aerosol-forming material. The ribs 4241 may be termed separation members. A suitable non-aerosol-forming material may be paper, or card, or a polymeric sheet. Thus, the intermediate layer 4240 may be formed from a plurality of paper ribs, each rib 4241 extending between the upper layer 4220 and the lower layer 4230. Points of intersection between the upper layer and ribs 4241 of the intermediate layer 4240 and between the lower layer and ribs of the intermediate layer comprise an adhesive that joins the respective layers.

Each rib 4241 is formed from a strip of non-aerosol-forming material having a length, a width, and a thickness. As an example, each rib 4241 may have a length of about 100 mm, a width of about 3 mm, and a thickness of about 300 microns. The width dimension of each strip is aligned to provide separation between the upper layer and the lower layer. Thus, the plurality of ribs provides a 3 mm separation between the upper layer and the lower layer. When the upper layer and the lower layer are heated, the low contact area between the upper and lower layers and the ribs means that heat loss from the upper or lower layer to the intermediate layer is minimised. This reduces the effect of cold spots in the upper and lower layers, which may cause reduced efficiency of aerosol-generation. This is particularly advantageous when the aerosol-forming substrate 4210 is heated by a heater arranged externally to the upper and lower surfaces, for example one or more planar heater arranged above the upper surface and/or below the lower surface.

When forming the substrate, separate ribs 4241 may be linked together, for example to form an array. As an example, adjacent ribs may be linked by one or more laterally extending linking means. The linking of ribs in this way may make the structure of the intermediate layer easier to handle during formation of the substrate.

The aerosol-forming substrate 4210 has a length, extending in an x dimension, of about 100 mm, a width, extending in a y dimension, of about 12 mm, and a thickness, extending in a z dimension, of about 3.4 mm.

Spaces between ribs 4241 of the intermediate layer 4240 form longitudinally extending channels 4261 that are bounded by the upper layer 4220, the lower layer 4230, and ribs 4241 of the intermediate layer 4140. The longitudinally extending channels 4261 extend through the length dimension of the aerosol-forming substrate. The longitudinally extending channels 4261 define an air-flow path through the substrate 4210. The porosity of the aerosol-forming substrate along the air-flow path is in the region of 90%. This provides a very low resistance to draw of less than 5 mm H₂O.

FIG. 43 is an upper plan view of an aerosol-forming substrate 4210 as described with reference to FIG. 42. The position of individual ribs 4241 is illustrated by dashed lines in FIG. 43. The air flow path extends through channels defined by the ribs from a distal end 4372 of the substrate to a proximal end 4371 of the substrate.

FIG. 44 is an upper plan view of a further aerosol-forming substrate 4410 as described with reference to FIG. 42. The position of individual ribs 4441 is illustrated by dashed lines in FIG. 44. In contrast to the substrate of FIG. 44, the ribs are laterally kinked or convoluted. Thus, each rib may be able to stand freely on its edge, which may assist assembly. The air flow path extends through kinked channels defined by the ribs from a distal end 4472 of the substrate to a proximal end 4471 of the substrate.

Ribs do not need to be aligned longitudinally within the substrate. FIG. 45 is an upper plan view of an aerosol-forming substrate having an intermediate layer comprising one or more ribs 4541. Individual ribs are laterally kinked and arranged between the upper layer and the lower layer of the substrate. As illustrated schematically in FIG. 45, individual ribs 4541 may act as longitudinal pillars, separating the upper and lower layers. Ribs may be arranged longitudinally, or laterally, or diagonally within the substrate. A great deal of freedom may be offered in placement of the ribs, allowing different air flow channels and chambers to be created within the substrate while minimising thermal losses caused by conductivity between the upper and lower layers and the separation layer.

FIGS. 46, 47, and 48 illustrate respectively an end view, a side view, and a plan view of an aerosol-forming substrate 4610 according to an embodiment of the invention. The aerosol-forming substrate 4610 comprises a planar upper layer 4620, a planar lower layer 4630, and an intermediate or separation layer 4640 arranged between the upper layer 4620 and lower layer 4630.

The planar upper layer 4620 and the planar lower layer 4630 are both formed from a sheet of aerosol-forming material (for example a sheet of homogenised tobacco) having a thickness of about 200 microns. The aerosol-forming material may be any suitable aerosol-forming material, for example any aerosol-forming material as described above. The intermediate layer 4640 is a 3 dimensional element formed from a profiled or textured sheet of non-aerosol-forming material. A suitable non-aerosol-forming material may be paper, or card, or a polymeric sheet. Thus, the intermediate layer 4640 may be formed from a profiled or textured sheet of paper.

The sheet forming the intermediate layer is profiled to create a plurality of upwardly extending pillars 4642 and a plurality of downwardly depending pillars 4643. Terminating points 4645 of the upwardly extending pillars 4642 contact a lower surface of the upper layer and terminating points 4646 of the downwardly depending pillars 4643 contact an upper surface of the lower layer. A thickness of the intermediate layer, the distance in the z-dimension between terminating points of the downwardly depending layer and the upwardly depending layer, is 2.5 Points of intersection between the upper layer and the intermediate layer and between the lower layer and the intermediate layer comprise an adhesive that joins the respective layers.

As the intermediate layer only contacts the upper layer and lower layer at discrete points 4648, there is minimal thermal transfer between the layers, reducing cold spots in the aerosol-forming material when it is heated. While individual pillars may be used to separate the upper and lower layers in some embodiments of the invention, the use of pillars that extend upwardly and downwardly from a sheet of material may provide handling advantages during manufacture of the substrate. The upwardly and downwardly depending pillars 4642, 4643 may be formed by an embossing process on a sheet of material, or may be formed in the sheet of material during fabrication of the sheet of material. The upwardly and downwardly depending pillars may have any suitable profile. The pillars may be, for example, pyramidical, or conical. The intermediate layer may resemble an egg box in form.

The aerosol-forming substrate has a length, extending in an x dimension, of about 90 mm, a width, extending in a y dimension, of about 18 mm, and a thickness, extending in a z dimension, of about 3.1 mm.

An air flow path is defined through the substrate both above and below the intermediate layer. The porosity of the aerosol-forming substrate along the air-flow path is in the region of 90 to 98%. This provides a very low resistance to draw of less than 5 mm H₂O. In fact, RTD is close to zero.

FIGS. 49, 50, and 51 illustrate a sinusoidal “egg box” surface 4960 that may be used as an intermediate or separation layer of an aerosol-forming substrate as disclosed herein. FIG. 49 illustrates a first continuous sinusoidal curve 4912 extending in the x direction, and FIG. 50 illustrates a second continuous sinusoidal curve 4913 extending in the y direction. Translation of the first continuous sinusoidal curve with the second continuous sinusoidal curve results in a sinusoidal surface 4960. The sinusoidal surface comprises a plurality of upwardly extending sinusoidal pillars 4962 and a plurality of downwardly depending sinusoidal pillars 4963.

FIG. 52 illustrates a continuous trapezoidal curve 5212. This trapezoidal curve may be translated perpendicularly with itself to create a surface 5260 comprising a plurality of upwardly extending truncated pyramidical pillars 5262 and a plurality of downwardly depending truncated pyramidical pillars 5263. FIG. 54 illustrates a perspective view of the surface 5260. The surface 5260 may be used as an intermediate or separation layer of an aerosol-forming substrate as disclosed herein, and FIG. 55 illustrates potential air flow paths that may be formed within a substrate comprising an intermediate layer having the form of the surface 5260.

FIG. 56 is a further schematic plan view of a surface 5660 formed by translating perpendicularly two trapezoidal curves to form a surface having rectangular peaks 5662 and troughs 5663. FIG. 56 also illustrates potential air flow paths that may be formed within a substrate comprising an intermediate layer having the form of the surface 5660.

FIG. 57 illustrates a further schematic plan view of a surface 5760 formed by translating perpendicularly two trapezoidal curves to form a surface having rectangular peaks 5762 and troughs 5763. FIG. 56 also illustrates potential air flow paths that may be formed within a substrate comprising an intermediate layer having the form of the surface 5760. It is noted that the surface 5760 of FIG. 57 has the same structure as the surface 5660 of FIG. 56, but the orientation of the surface has been altered by a 90 degree rotation to create a more tortuous air flow path within the substrate, potentially improving mixing and development of aerosol.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A ±10% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. A substantially planar aerosol-forming substrate, comprising:
an upper layer and a lower layer,
the upper layer and the lower layer being arranged as substantially parallel planes spaced apart by a separation layer located between the upper layer and the lower layer,
the separation layer comprising one or more separation members extending between an upper surface of the lower layer and a lower surface of the upper layer,
wherein the lower layer comprises a first aerosol-forming material and the upper layer comprises a second aerosol-forming material, and
wherein the first and the second aerosol-forming material comprises at least 5 weight percent aerosol-former.

17. The substantially planar aerosol-forming substrate according to claim 16, wherein the separation members are ribs or struts separating the upper layer from the lower layer.

18. The substantially planar aerosol-forming substrate according to claim 16, wherein the separation members are longitudinally extending separation members.

19. The substantially planar aerosol-forming substrate according to claim 16, wherein an air-flow path is defined through the substantially planar aerosol-forming substrate between the upper layer and the lower layer.

20. The substantially planar aerosol-forming substrate according to claim 19, wherein a resistance to draw (RTD) of the substantially planar aerosol-forming substrate, along the air-flow path, is less than 20 millimetre H₂O.

21. The substantially planar aerosol-forming substrate according to claim 19, wherein the substantially planar aerosol-forming aerosol-forming substrate has a porosity of greater than 60% in a direction of the airflow path.

22. The substantially planar aerosol-forming substrate according to claim 16, wherein the separation layer does not comprise an aerosol-forming material.

23. The substantially planar aerosol-forming substrate according to claim 16, wherein the separation layer further comprises a third aerosol-forming material.

24. The substantially planar aerosol-forming substrate according to claim 16, wherein the first aerosol-forming material and the second aerosol-forming material are a same type of aerosol-forming material.

25. The substantially planar aerosol-forming substrate according to claim 16, wherein the first aerosol-forming material and the second aerosol-forming material have a same composition.

26. The substantially planar aerosol-forming substrate according to claim 16, wherein the first aerosol-forming material and the second aerosol-forming material are different types of aerosol-forming material.

27. The substantially planar aerosol-forming substrate according to claim 16, wherein the first aerosol-forming material and the second aerosol-forming material have different compositions.

28. The substantially planar aerosol-forming substrate according to claim 16, wherein the first and the second aerosol-forming material comprises at least 10 weight percent aerosol-former.

29. The substantially planar aerosol-forming substrate according to claim 16, wherein the aerosol-former is glycerine or propylene glycol.

30. An aerosol-generating article for an aerosol-generating device to generate an inhalable aerosol, the aerosol-generating article comprising the aerosol-forming substrate according to claim 16.

31. The aerosol-generating article according to claim 30, wherein the aerosol-forming substrate is located within an outer wrapper or outer casing.

32. The aerosol-generating article according to claim 30, further comprising a first section and a second section removably couplable to the first section, wherein the first section comprises the aerosol-forming substrate, and wherein the second section is a mouthpiece.

33. The aerosol-generating article according to claim 32, wherein the second section is a reusable mouthpiece designed for use with multiple first sections.
